(19) United States
(12) Patent Application Publication
(10) Pub. No.: US 2004/0260470 A1
(43) Pub. Date: Dec. 23, 2004

(54) Conveyance scheduling and logistics system

(76) Inventor: Rodger H. Rast, Gold River, CA (US)

Correspondence Address: Rastar Corporation, Suite 310 MS 337, 11230 Gold Express Drive, Gold River, CA, 95670, US

(21) Appl. No.: 10/867,615

(22) Filed: Jun. 14, 2004

Related U.S. Application Data
(60) Provisional application No. 60/478,900, filed on Jun. 14, 2003.

(51) Int. Cl. G06F 17/60

(52) U.S. Cl. 701/300; 705/7

(57) ABSTRACT

An apparatus and method of reserving conveyance, such as taxis and limousines, in which the pickup locations, times, and contract are established and logged electronically. The system is configured to increase the assurance that the conveyance will arrive properly on time and on location, and that the patron will also keep their end of the agreement. The system preferably configured for disincentives for either party to not follow in accord with the contract.

### CROSS-REFERENCE TO RELATED APPLICATIONS

This application claims priority from U.S. provisional application Ser. No. 60/478,900 filed on Jun. 14, 2003, provisional application Ser. No. 60/394,160 filed Jul. 1, 2002. Priority is claimed to each of the foregoing applications.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to transportation and more particularly to a system and method of scheduling for conveyance.

2. Description of the Background Art

Currently scheduling to be transported by vehicular conveyance, such taxi cabs, limousines, and so forth relied upon voice communication to dispatchers and lots of hope and trust from both parties. The customer hoped that the transport would arrive where they expected at the time expected. They also hoped they would be transported by the most direct route and thereby not be overcharged for services. The transport service on the other hand hoped that the fare would show up at the proper location, at the proper time, and that the party had not otherwise found alternative conveyance or had no money to pay the fare. Furthermore, the transport service had to hope their own drivers were being punctual and accurate as to their arrival at the pickup point.

The problems which arise are particularly onerous with regard to taxi and limousine services. Typically, prospective users have had to call the taxi service, wherein they must attempt to describe where they want to be picked up and when. The taxi service on the other hand must interpret the directions to locate the user.

A number of problems arise in these situations. The user does not know when the Taxi will arrive, or where. Even a user that is regularly picked up from a given location and transported to the same destination, is subject to these mistakes as the dispatching is not personalized to that individual, and furthermore a number of different drivers can be covering the route wherein each may interpret the location information in different ways. It is easy to understand how these errors arise, as the information from the user call must be converted from spoken instructions to log the call and set up the dispatch. While the taxi company doesn't know if the user will actually show up for the ride. If they are a no show, the taxi company has lost money by dispatching a cab and not picking up a fare. Furthermore, scheduling optimum routing for each taxi is a problem, wherein the dispatcher must attempt to optimize routing on the fly.

As can be seen, therefore, the development of a system and method of scheduling vehicular conveyance is needed which reduces the uncertainty for customer, transport driver and transport company. The system and method of scheduling conveyance in accordance with the present invention satisfies those needs, as well as others, and overcomes deficiencies in previously known vehicular transport solutions.

### BRIEF SUMMARY OF THE INVENTION

The present invention is a system and method of simplifying the making of scheduling arrangements for a taxi or limousine and to a lesser extent charter aircraft or other form of user-driven custom transport. The invention reduces the worry and cost to both parties.

As used herein, the term Taxi Service will be used to mean any form of conveyance that is arranged between a user and a company offering the service. The present invention streamlines the process of a patron scheduling a taxi and of the service scheduling routes. The assurance of service increases customer satisfaction and can increase patron loyalty. The system also increases fare revenue by capturing costs on no shows and reduces costs by improving routing and vehicle use. The system can also charge the fare in some instances before the passenger has been picked up, by using credit card information, thereby assuring that payment is available.

Since the system captures digital information about the customer and route it can facilitate maintaining a database of customers wherein special service and considerations can be directed toward good customers.

The system and method is particularly well suited for use by passengers having GPS equipped telephones, PDAs, or similar communication devices. And may be utilized by connecting with a fare dispatcher by voice or internet connection (email or interactive web site). The dispatcher is preferably automated unless a problem arises or the user requests a human dispatcher. The patron preferably indicates the pickup and drop-off points by coordinates passed from their GPS equipped cellphone, PDA, or other electronic device. Exact coordinates of locations the user has visited can be stored by the user. In addition, the user can even upload images, or video clips, to the system such as within their preferences, or when reserving transport, so that the driver is provided unambiguous visual information about where the patron is to be picked up. The database of the system itself also preferably stores information on pickup and drop off points for different buildings, establishments and so forth. For example, there are certain fixed locations wherein a person may be picked up at Wrigley Field in Chicago, although a person, especially on a first trip, may not know the location. The system therefore can communicate a set of information to the party, and if a choice of pickup location exists for the location, then the user can select it. This provides maximum flexibility while assuring that the proper connection is made between taxi and patron.

The invention provides a number of benefical aspects including but not limited to the following.

An aspect of the invention is to allow establishing a prepaid contract between the conveyance service and the patron, in which the location and time are well defined based on GPS based information.

Another aspect of the invention is to log on-station performance of transport vehicles wherein this can be compared with the reservations (contracts) wherein the company or patron can be compensated accordingly.

Another aspect of the invention is to provide a location-based service in which the patrons with GPS enable cellphones, PDA, and so forth can establish accurate pick up and drop off information.

Another aspect of the invention is to allow patrons to establish use profiles, including a list of designated locations, wherein the time required to contract for transport is quickly overcome.

Another aspect of the invention is to provide a means wherein a GPS enabled user can make a reservation for transport from their present location, or a location whose coordinates were saved at an earlier time.

Another aspect of the invention is to provide a means in which the user can store pictures or video of their pickup or drop-off location, therein helping the driver locate the position.

Another aspect of the invention provides a means by which the patron is automatically notified of the progress of arrival of the conveyance, as well as any changes, such as arrival earlier or later than scheduled.

Another aspect of the invention is to provide various forms of communication with the patron based on their desired form of communication, and capabilities of their communication device (cellphone).

Another aspect of the invention is to allow for communicating with the patron using local communications means such as BlueTooth, WiFi, or other in accord with the capabilities of the user.

Another aspect of the invention provides for automated annunciation to the patron such as by way of a custom display and/or audio annunciation.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of a conveyance scheduling system according to an aspect of the present invention.

FIG. 2-3 are flowcharts of the process of conveyance scheduling according to an aspect of the present invention.

FIG. 4 is a block diagram of an Environmentally Responsive RFID according to an aspect of the present invention.

FIG. 5-6 is a block diagram of a system for qualifying fueling and other connections according to an aspect of the present invention.

FIG. 7 is a block diagram of a RFID usage control system according to an aspect of the present invention.

FIG. 8-14 are schematics of transitions lighting embodiments according to aspect of the present invention.

FIG. 15-17 is a flowchart of PayMail system for limiting spam w/o limiting correspondence from friends and family according to an aspect of the present invention.

FIG. 18-19 are views of an ionization unit and sterilization which may be utilized according to an aspect of the present invention.

FIG. 20 is a cutaway view of an apparatus for providing non-attended product samples according to an aspect of the present invention.

FIG. 21 is a cross-section of a motorcycle garment anti-abrasions bead with bead inserts according to an aspect of the present invention.

FIG. 22-23 are top and side views of conformal bead attachment for motorcycle garmetns according to an aspect of the present invention.

FIG. 24 is a facing view of a flap for controlling airflow in a motorcycle garment according to an aspect of the present invention.

FIG. 25-26 is a top and side view of a motored nutating drive for a tip tracker lighting device according to an aspect of the present invention.

FIG. 27 is a schematic of a mechanism for converting planar motion to a nutating pattern for a tip lighting system according to an aspect of the present invention.

FIG. 28 is a facing view of a garment whose surface can be played as an instrument by a user (wearer or otherwise), according to an aspect of the present invention.

FIG. 29-30 are block diagrams of a personality module that allows “enhancing” the interfacing available for a variety of electronic devices according to an aspect of the present invention.

FIG. 31 is a flowchart of using the personality module system of FIG. 29-30, according to an aspect of the present invention.

FIG. 32-33 are block diagrams of remote landing assist systems according to aspects of the present invention.

FIG. 34 is a block diagram of a system for augmenting wireless services according to an aspect of the present invention.

FIG. 35-37 are block diagrams of light model aircraft controls according to aspects of the present invention.

FIG. 38 is a perspective view of a self powered remote sensor according to an aspect of the present invention.

FIG. 39-40 are block diagrams of a system for stabilizing aircraft flight pattern according to an aspect of the present invention.

FIG. 41 is a bock diagram of a flight stabilizing system which reduces pilot overhead during manual operations according to an aspect of the present invention.

FIG. 42 is a schematic of a programmable patterned LED according to an aspect of the present invention.

FIG. 43 is a facing view of a twin-tip spark plug for dual ignition systems according to an aspect of the present invention.

FIG. 44-45 are a cutaway view and block diagram of a stabilized serving tray according to an aspect of the present invention.

FIG. 46-47 are views of a chameleon liquid soap material according to an aspect of the present invention, shown for changing color in response to sufficient friction during handwashing for children.

FIG. 48 is a partial cutaway view of a high heat capacity water heater according to an aspect of the present invention.

FIG. 49-50 are facing and cross-section views of a nanotech on-demand heating and filtering system according to an aspect of the present invention.

FIG. 51-52 are facing and side view of a simplified serial lighting system according to an aspect of the present invention.

FIG. 53-54 are top and side cutaway views of a quick release water control valve and/or solenoid according to an aspect of the present invention.

FIG. 55-58 are view of skimboards providing enhanced slider action according to aspects of the present invention.

FIG. 59 is a perspective view of a sheathed polymeric muscle fiber for controlling motion stage according to an aspect of the present invention, shown sliding through an eyelet.

### DETAILED DESCRIPTION OF EMBODIMENT(S)

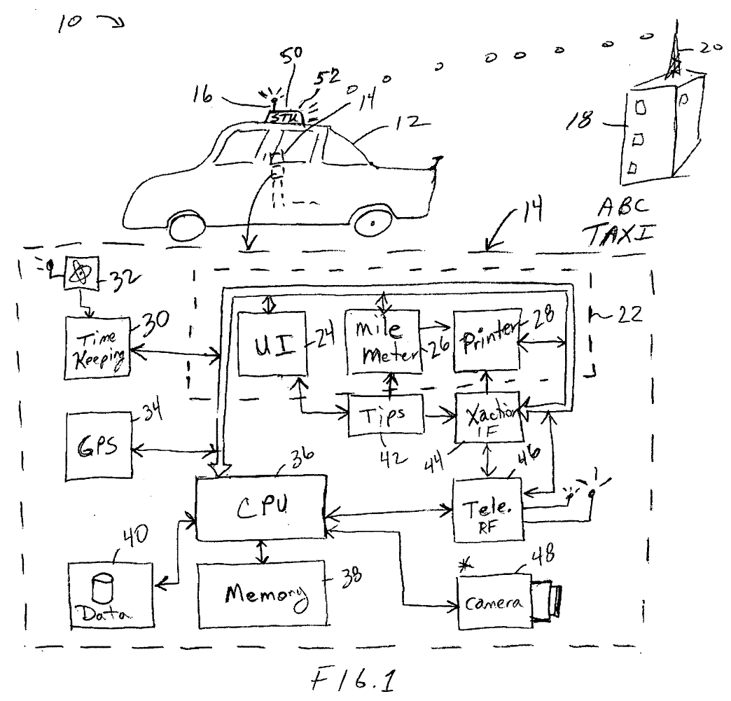

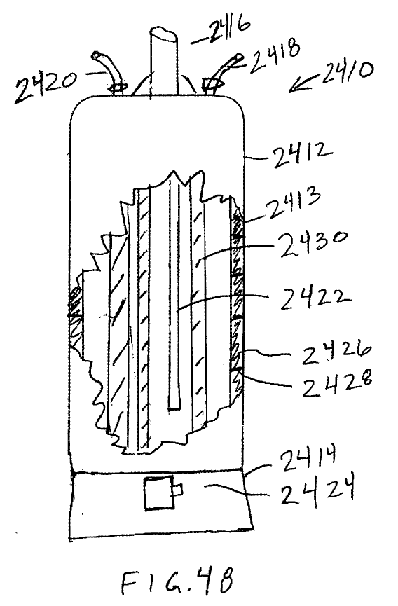

Referring more specifically to the drawings for illustrative purposes, the present invention is embodied in the method generally described in FIG. 1 to FIG. 59. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

The description of embodiments includes a number of inventive aspects, which are organized into the following sections:

1. Conveyance scheduling system and method

2. RFID-ER RFID—Environmentally Responsive RFID

3. RFID-Qualifying Fueling and other connections

4. Transitions Lighting

5. PayMail—Limiting Spam w/o limiting correspondence from friends and family

6. EVRHeadsets—communicate via RF

7. FanFilter—Ionization units & sterilization

8. Method and Apparatus for Providing Non-attended Product Samples

9. AutoCSLimit—Methods of use

10. Optical Meat Thermometer—Enhancements

11. HBLite—preventing unwanted alerts

12. HBLite—AutoAccBrake—Automatic Braking based on Accel. Sensing

13. iDose—Enhancements and Detailed Aspects

14. MotoG—Bead inserts

15. TipTracker—Embodiment Variations

16. PlayMe—Embodiment variation of SteerATune and SkateTunes

17. USB Personality Module

18. Methods of Local Advertising

19. Premium Subscription Delivery Services

20. Back-issue Medley Subscription Services

21. Remote Landing assist system

22. Physical Monitoring Interface for LANs

23. Augmenting Wireless Services

24. Auxiliary Personal Computer Controls

25. Bands on the Net

26. Method and System of Simulating Handwriting in Documents

27. Light Model Aircraft Controls

28. Self powered remote sensors

29. System for Stabilizing Aircraft Flight Pattern

30. Flight Stabilizing System (redux overhead in manual ops)

31. Peripheral Vision Optical System

32. Programmable Patterned LED

33. Smart Power Modules

34. Twin-Tip Spark Plug for dual ignition systems

35. StableServe—Stabilized serving trays

36. Chameleon Liquid Soap

37. High Heat Capacity Water Heater

38. Nanotech On demand heating and filtering

39. UV sterilized lighted shoe trees

40. Simplified Serial Lighting

41. Jam Proof Paper Shredder

42. WarmFinger Keyboard

43. Personal Navigation System and Method (PNavs)

44. Autoform Wizard—create form templates in word processing SW

45. ScanToSList—scanning UPCs to generate shopping lists

46. Quick Release Water Control Valve and/or Solenoid

47. SkimBoard—Enhanced slider action

48. Sheathed Polymeric Muscle Fiber for Controlling Motion stage

49. Packaging Preventing Material Use

50. Suspension Visor—additions

Conveyance Scheduling System and Method

The system is configured for establishing electronic reservations which include pickup and drop-off points, such as from personal electronic devices containing GPS location elements (i.e. cellular phones, PDA, etc.) The system is configured to electronically check all incoming location information received as coordinates to assure that they can be unambiguously located near an accessible street location. The system can determine the best pickup point near the location provided by the user, and communicate that adjusted location to the user so that no confusion results. Imagine the situation wherein a pickup location within the center of a building is communicated, wherein the driver would need to decide which side of the building to be picked up on. The location from the user is thereby checked prior to a reservation being established for the transport service.

Once a location is passed to the dispatcher via coordinates, or by way of street addressing and/or cross streets, the dispatching unit communicates a graphic (map) or verbal description of the agreed-upon pick up location and time, which once verified can be in the form of a contract to which the user submits payment. If the taxi does not show up at the appointed time the user can be given some compensation, such as credited back the fare amount plus an a discount on future services, and so forth. In one embodiment of the invention, if the client does not arrive for the fare within a given time period then at least a portion of the fee amount is still charged on their account for the taxi overhead cost (a fixed fee, percentage, or fee calculated by other formulas). As such the system provides incentives for both parties to follow through upon that which has been agreed.

One aspect of the system is a device for registering “on-station” condition of a transport vehicle. The device may be a separate unit or have functionality incorporated into the tracking system, fare billing system, communication system, or other electronic system within the vehicle.

The on-station unit is configured to register the time of arrival and time of leaving designated pickup points. A GPS unit, or similar locating tracking system (i.e. inertial), or combination of location system coupled with a means for recording events. It should be appreciated that real time clock data is available from the received GPS signals as this time data is utilized by (i.e. set in reference to a remote clock fixed to an atomic clock time). The on-station performance can not be modified by the driver, wherein a true record of the actual arrival and departure times from station are recorded.

The system is configured to automatically check the present location against the intended pickup location, for notifying the driver. The driver can log conditions at the pickup point, such as if they can not park near the pickup point due to traffic, an accident, and so forth.

Another option of the system allows for better control of the conditions under which additional parties are picked up. For example, the patron making the reservation can elect NOT to share a cab, wherein they pay the full fare. If they elect to pick up other patrons, then conditions about how much delay, how many persons, and so forth can be specified. The user would be preferably billed less according to how many other parties shared the ride, or parts of the ride. The computer with the taxi automatically computing the cost for each route segment, and dividing the cost equitably between the patrons, preferably automatically billing their charge cards accordingly or providing credits if prepaid fares are collected.

Optionally, visual conditions can be registered by still or video cameras coupled to the system, when the conveyance is on-station such as providing on-station location image information and traffic conditions for validation purposes.

Another option is an active display on the taxi, which can display the name, or names of the persons or groups being picked up, in this way the patron can readily pick out their taxi when multiple taxis exist. Another option allows the system to generate a custom audio sequence from the taxi when on-station thereby alerting the patron. The audio sequence being one that the patron has selected, or previously been alerted to. These sounds can be configured in a similar manner to cellular phone ring tones, comprising a short, typically recognizable string of notes.

Another option allows for automatically signaling the patron when the taxi is arriving at station, and optionally at times (i.e. 3 minutes) prior to arrival on station. In this way the patron need not wait at the exact spot until the call is received, this allows them for example to enjoy a cup of coffee in the coffee shop without fear of missing their ride. The communication can include the taxi and driver information (i.e. taxi number, driver name, images of taxi and/or driver, etc.). The signaling can be performed from the dispatch center, such as over a cellular network or email to the patron. It will be appreciated, however, that email is not very reliably in this instance as it can be delayed for periods of time. Alternatively, the communication can be generated from the taxi, such as by way of cellular link or using a local RF communication, such as BlueTooth or WiFi, if the patron is so equipped.

This automated connectivity makes it so the driver need not be looking up numbers, or even using the phone under normal circumstances. However, the system can allow hands free communication from the driver. The communication system is also preferably configured for generating coordinates of the taxi to the patron, wherein the patron can see the progress of the taxi if they desire.

In one embodiment the system is configured to allow patrons to establish a user profile so that they can be consistently handled in a manner according to their needs. For example the profile would include, cellular telephone number, local communication information (i.e. BlueTooth™ or WiFi), name as they want it on display sign (i.e. may want an alias such as Lone Ranger, Big T, J. Johnson III, etc.), information about any specific GPS mapping standards in use, home address, home phone, billing information, as well as waypoint locations which can be given specific names, such as “work”, “home’, “daycare”, “Aunt Esther's”, “Starbucks”, and so forth, wherein the user can more readily arrange for service in the future based on these preconfigured addresses. At the user's discretion they can input a photo into the system to allow the taxi driver to more readily recognize the patron and thus perhaps speed the connection when a pickup is being made at a busy location, and can also prevent the driver from picking up the wrong fare.

Software back at the dispatch center uploads the on-station data against the fares to determine performance of the driver, and to assure that any problems with picking up any of the fares is properly dealt with.

The driver can activate an “on-station” condition when they stop at the location, or alternatively/additionally the on-station performance can be logged automatically when within a given distance from the target location. This allows for the condition in which the taxi can't immediately reach exactly the pick-up location, but can continue edging closer while waiting for the fare to show up. In a similar manner leaving the station can be recorded. It is preferred that the system perform automated “on-station” logging while the driver, manually input when they are on station and leaving the station. In this way the drivers make a better visceral connection with their on-station performance and any discrepancies between what the computer determines to be on-station compared to what the driver has considered on-station, can be readily discerned maintaining honesty between all parties.

Another optional aspect of the system provides software, plug-ins, or data files from the transport service which operate on the mapping device of the user (i.e. GPS cellphone, PDA, etc.). Therein allowing the user to specify pickup and drop off locations on their device, or even travel routes, and having the software from transport service provide information on billing, or expected billing, based on distance, expected travel time (taking into account traffic), and other parameters of the ride or fare. In this way a user could more readily plan the fare.

A system providing some of the aspects described herein can also be implemented for conveyances that are not “on-demand” such as subways, light rail, ferries, buses, shuttle planes, and so forth. In these cases since the pickup and drop off points are predetermined the system aids the user in selecting which route, finding the proper pickup and drop off points, determining the cost, determining the availability of seating, reserving seating, and purchasing tickets in advance. These aspects and other pertinent aspects being taught herein. The “on-station” performance not generally a factor in this application.

The system itself can be implemented as an application by a given transport provider, or as a service which integrates a number of different transport providers, therein giving the user a wide latitude of transport options as well as specified interconnections to simplify both the arrangement and billing for services. For example, the service can link on-demand and scheduled forms of transportation, as well as related services, such as excursions, museums, factory tours, points of interest, restaurants, lodgings, and so forth. In this way the user can plan a trip, makes reservations, and even prepay for the elements of that trip from a single website. This not only aids the consumer but provides substantial benefits to the businesses in terms of planning, reduced overhead in accommodating the travel needs of patrons, as well as simplified reservations and prepaid service.

FIG. 1 depicts an “on-station” system 10 shown with a vehicle 12 with a metering unit 14 according to the present invention connected to antenna 16 which communicates with dispatchers at a site 18 received through antenna 20.

The mobile portion of the on-station system is preferably implemented within a metering unit, although it may be incorporated within other devices, or provided as a stand-alone unit. A conventional electronic metering system 22 is shown with a user interface 24, mileage meter 26, and printer 28.

The mobile portion of the present invention comprises: a time clock 30, which can be based on a receiver 32 or use the clock information from the GPS signals; a means for generation of location information 34, such as a GPS (Global Positioning System). A central processor 36 coupled with memory 38 for program storage and basic data files, and optionally one or more mass storage units 40, such as map databases, historical data, coordinate information, and so forth. The time clock and positioning system provide a means for determining when the taxi arrives at or leaves the pickup point, which forms a basis for charging customers for a no show, as it can be documented.

User interface 24 is preferably enhanced to provide additional functionality for the present system such as fare processing, monitored details of the fare, and the like. For example a tip module 42 controlled through user interface 24 allows the client to enter tip values into the system and execute a payment transaction with a transaction interface 44 connected to a communication system 46, such as a wireless phone device. Communication system 46 preferably contains both a means for communicating through cellular services, but also a proprietary dispatch communications channel and a means of communicating with cell phones and other personal devices using local RF linkage (i.e. BlueTooth™, WiFi or other local communication standards). Information from a camera 48 (i.e. still, multi-frame or video with or without audio) may also be collected for use within the local system, or uploaded to the central database for tracking and other purposes.

An active display 50 is shown with optional audio 52, thus providing an automated means of visually alerting a specific patron that this is their taxi cab, or other conveyance. The display may comprise any conventional display such as LCD, electronic ink, electroluminescent, and so forth. The display is coupled to computer 36 and it receives information from about the patron from the main system, such as an alphanumeric name or alias supplied by the patron, which is then displayed as the taxi comes on station or near station. Similarly audio can also be provided, such as different musical selections, sounds, and so forth, preferably selected by the patron to aid their ability of detecting the transport which has arrived for them. This audio annunciation can be utilized for even prescheduled transport, such as buses, which can use different audio alerts to indicate to passengers which transport to take, wherein the patron need not even see the sign to discern that a specific transport they are waiting for has arrived.

For example a cartoon “roadrunner” sound could be played at the time of reservation, wherein upon looking for the transport at the time of pickup the patron is provided with the additional cue of the “roadrunner” sound being emitted by the vehicle.

These fare incrementing controls are accessible to the passenger and allow the passenger to set an increased value to the fare corresponding to the amount of the fare plus tip, or to separately enter a fare value. The fare meter can provide input keys such as increment and an enter key or similar to finalize the fare. This has the advantage of allowing the patron to pay with a credit card while the company benefits in that the tips are properly recorded for tax purposes. Furthermore, the fare meter generates a receipt to the customer that reflects the fare plus any tip that was added to the fare, thereby simplifying tracking expenses for all travelers and reimbursement of expenses for business travelers.

The fare may be collected with a credit card (or other form of transaction token i.e. smart card, etc.) or by mean of cash. For cash transactions it is preferable that a bill taking machine be incorporated into the metering system which collects the fares and makes change as necessary. This has the advantage of storing the money so that the driver is not susceptible to being robbed, while it assures that all fare monies are properly logged because the monetary fares are registered by the bill reading system. It will be noted that companies are being charged for back-taxes by the IRA based on IRS estimates of what tips they believe the drivers received which were not reported. By encouraging all transactions to pass through the fare collection center such problems can be eliminated.

The interface allows the customer to enter the aspects of the transaction prior to the conclusion of the trip, at which time they need only verify the fare amounts listed to execute the transaction. For example, the tip may be entered based on a percentage, fixed, amount or combination, while the enhanced metering system optionally maintains current estimates of the costing to the destination, as based on mapping information available on a mass storage device, such as an optical disk drive, and location information provided by a GPS system or similar.

An optional camera is included 48 which is configured to take digital pictures (preferably automatically) from at least one vantage point during the time the taxi is on station awaiting the client to arrive, or for other purposes. The images are collected with a digital stamp with date, time, and coordinates as a further indication that the taxi was on station at the designated time coordinates.

The central dispatching station communicates with the vehicles by radio (audio and/or data) and can communication with customers over automated interfaces (phone-voice, phone-data, internet-data, etc.). The dispatching system maintains a status of all vehicles and assignments of each, and preferably actual location based on GPS coordinates that are periodically radioed in, or radioed in at each station change, such as based on motion sensing. The system communicates with customers to establish pickup places and times that fit vehicle scheduling, and for billing the client, preferably a portion of which is billed even before they are picked up for the fare, assuring that it is a valid fare and that at least some money will be collected even in a no show situation.

The dispatching system collects data from the vehicles which are stored in a central database along with optional images of no-show fares and other details to aid in billing. The system also tracks information about all fares that can be utilized for isolating prank calls, frequent no show customers, good customers, and preferred pickup points for the customer database. The dispatching system is configured for running billing operations based on metering from the vehicles. Although the vehicles are preferably equipped with a transaction processing system, it preferably connects through the central dispatching system which performs the actual transaction, thereby reducing fraud and allowing for a true logging of transactions.

The present invention moves the “at will contract” back to an earlier point in time; for instance back before the time when the customer leaves with the taxi, to the time at which the fare is booked by the customer.

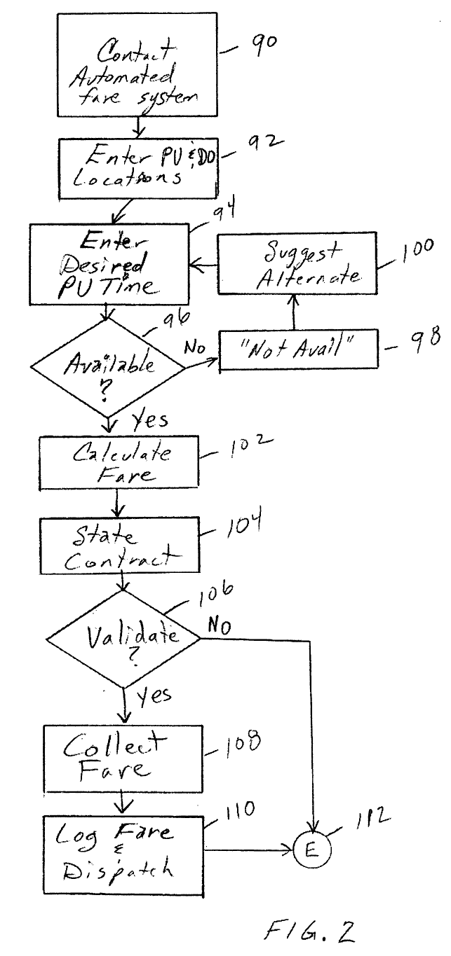

FIG. 2 illustrates an example process of a customer establishing a pickup contract. The customer contacts the dispatch system at block 90. A pickup (PU) and drop off (DO) location are entered at block 92, by way of voice location information (street address and/or cross street information), keyboard or keypad entry, location on a map display such as displayed on the Internet, coordinates such as from a GPS unit, or any convenient means. A desired pickup time is then entered by the customer at block 94.

The dispatch system checks at block 96 the time and location against the present vehicle schedules to determine if the fare can be picked up at the given time. If the time is not available then the customer is alerted at block 98 and an alternate time may be suggested at block 100, prior to allowing the user to select another pickup time.

If the customer attempts to schedule on short notice, then the fare may not be able to be matched to the available vehicles, wherein it is preferred that the present system automatically pass the information on place and desired times to another company, after first getting customer permission. In this way the customer is passed to a transportation service that can handle their needs without the need for them to call all over town. This is beneficial to the originator in that they can become a central point for customers which know that their needs will be taken care of. Furthermore, a referral fee can be optionally remitted back to the originator if desired for directing the business to the other party, which may have a similar reverse arrangement. This passing between services of course being generally circumvented if the system is implemented in connection with a number of conveyance services, wherein the interface provides access and bookings for a number of different services.

Once the place and time are determined, an estimated fare is calculated at block 102. Optionally the customer can now elect how much time the taxi should wait for them should they be late. A “no show” fee is then preferably determined, which takes into account the desired wait interval, and a contract is states including the times, locations, and costs. The user is asked to validate their agreement at block 106. Once agreed upon a reservation code (token and optionally a password) is preferably issued to the user, allowing the user to verify the reservation and to identify themselves in relation to a particular fare. If the reservation is made a sufficient period in advance then the user may be given the choice of being reminded of the reservation, such as generated by an automated voice response system to the users phone, cellular phone, pager, or email.

It should be appreciated the spoken contract and the associated response from the customer are preferably stored in memory at the dispatcher, should any later problems arise regarding a customer dispute of the contract. If the user elects not to agree to the contract then the process ends at block 112. Otherwise the entire fare or at least the no-show portion of the fare is collected at block 108, such as by executing a credit card transaction. Once the transaction is executed, then the fare is logged and fully reserved in the system at block 110, prior to ending the process.

FIG. 3 depicts a flowchart for registering the time on station by the taxi to prevent “no show” disputes and the associated charges. The time of arrival “on station” (at the preagreed destination) is recorded as represented by block 130, if the customer shows up then the meter is activated and they drive off to the destination, the customer being charged according to the full or partial prepayment.

If however the customer does not arrive then the system preferably documents at least a portion of the surrounding by taking digital images which are time, date, and coordinate marked. If the fare does not arrive in the designated time and the driver has another fare to pickup, then the system registers their time leaving the station at block 136. The information about the no-show is then passed from the taxi to the dispatcher thus passing the verification of the no-show. At block 140 the no-show of the fare is preferably logged, and billing for the fare is corrected for the no-show, and the client is preferably notified of their no show along with a printout of verification data, such as a time line and photos, whereafter the process is completed.

Another preferably aspect of the system is providing information and/or notification to patrons of transport status.

(1) Notify the patron of delays in the transport arriving at the location for which the reservation was made. Preferably, the vehicle communicates its location to a dispatch location that determines if a notification should be posted. If the vehicle is going to be sufficiently late, such as more than about three minutes, then a communication is posted to the user (i.e. phone call using computer voice, phone call with electronic information, email, pager information, or other means of communicating with the user as established at the time of placing the reservation). Preferably the user device that the made the reservation with (a cell phone, PDA, or similar) can receive the communication.

(2) Patron notifying transport that they are late—they can request that the transport hold and wait a given time for them to show up.

(3) Patron may want to alter the pickup time. Wherein they can communicate their new desires. The company will determine how it can respond to the change and will notify the user appropriately. For example, they may not be able to arrive 30 minutes earlier than scheduled as requested by the user, but perhaps can arrive about 15 minutes earlier than previously scheduled. A reservation number, or similar token being saved at the time of reservation that can be used to access information about the scheduled transport.

(4) Patron may want information after the reservation. The system allows the user to check the: (a) charges posted to their account; (b) time on and off station by the vehicle that responded to their reservations, such as when the missed their reservation; (c) the time enroute and paths followed during their completed transport according to the reservation.

Similarly, another aspect of the system provides information for the transport company on location of the vehicle and determining optimal routing and usage of vehicles to cover the transport reservations. The vehicles can at least periodically communicate location information to a central dispatch location, such as from GPS data being collected enroute.

Business methods may be associated with the above functionality. The following are provided by way of example and may be implemented separately or in combinations thereof:

(1) Arrival guarantee—the service agrees to deduct a given amount from the resulting fare for each minute (or other time interval) that they are late arriving at the location. The guarantee being contingent upon a certain conditions, such as the reservation being made sufficiently in advance.

(2) Billing the user for no shows—the user can be billed a certain minimum billing if the user does not show up. Although preferably a fixed time on station would be a default value (i.e. 10 minutes after reserved time) the user could arrange for extended waiting if they are unsure about their time of arrival.

(3) Verification of vehicle being on-station—the location and time of arrival on station and leaving the station are logged in a manner so that neither the patron (user) or driver can modify the information. Preferably the dispatcher and other company parties are also unable to change the information, such as to save face when a pickup is missed.

### RFID-ER RFID—Environmentally Responsive RFID

Incorporated herein by reference, regular patent application docket “Transponder” application Ser. No. 10/279,480 as filed Oct. 23, 2002; and associated provisional application No. 60/346,753 as filed Oct. 23, 2001;

Regular utility application describing RFID Controlled Lighting within docket “KeyboardRAST070103” application Ser. No. 10/612,777 as filed Jul. 1, 2003; and associated provisional application No. 60/394,160 as filed Jul. 1, 2002;

Regular utility application describing “Tool Tracking with RFIDs” within docket “TransportRAST070103” application Ser. No. 10/612,225 as filed Jul. 1, 2003; and associated provisional application No. 60/394,160 as filed Jul. 1, 2002.

2.1 Background

Current RFID tags are generally configured to respond directly to pings (challenges) wherein their response communicates a read-only unit number.

2.2 Summary of Invention

In the present invention the RFID units are configured to autonomously respond to environmental conditions, and activity information.

2.3 Description

An RFID tag is configured with environmentally responsive sensors. By way of example the RFID may be configured to transmit in response to sensed motion, package manipulation/bending/tearing, light impinging on the tag or area of package, touches on the package, thermal conditions and so forth.

Two basic types of embodiments are described, a non-autonomous and an autonomous embodiment, as well as a combination of the two embodiments. In the first type the unit operates non-autonomously wherein the unit responds to challenges based on the registered data, and can respond also to conventional challenges or challenges directed to its specific unit number. In this first type the unit can response back to every challenge or to a specific type of challenge, such as threshold sensing challenge, based on the sensed data. In a first embodiment of this type the enhanced RFID tags record the sensed conditions and report these when responding to any challenge, in a second type the units generate responses only when certain threshold conditions of the sensed condition has been exceeded, such as sensing which could be indicative of product tampering.

The units which convey the information in response to a challenge draw the power necessary for responding to the challenge from the challenge itself, although they store sufficient power to allow the sensing circuitry to operate for periods of time, or alternatively utilize other forms of energy as a power source, such as solar, battery, radioactive, inductive, and so forth. In a preferred embodiment these units can respond differently to different challenges. A conventional challenge, such as located at a point of sale, is responded to by supplying the unit identification number, and optionally all or a selected portion of the collected data. A threshold sensing challenge can also be issued to which the unit responds only if one or more of its thresholds have been exceeded. The response including the unit number and preferably (but not necessarily) other information such as data about what threshold was exceeded, actual sensed data, and perhaps some historical information to put the data into perspective.

To operate these devices, a transceiver for generating a threshold sensing challenge would typically be located near units containing the environmentally responsive RFID tags, wherein the activity of these units can be monitored automatically for any activity that is out of the ordinary. Since only units which have sensed conditions exceeding the threshold generate a response the number of units responding is kept low.

Furthermore, once a unit responds to a threshold sensing challenge it then preferably marks the information as having been responded to, wherein it does not continue to respond unless new instances of threshold crossing conditions are detected for the given variable or other sensed variables. The data collection system at the store, warehouse, or other facility, detects these sensed conditions so that problems can be immediately addressed. For example, a camera may be directed automatically to a location where items are being handled, possibly inappropriately, a clerk dispatched to check into the situation or following some other means of response. For example a clerk with a hand-held transcievers can be dispatched to check on the unit which generated the over-threshold response. The hand-held transceiver having received at least the ID of the device which generated the response, can find the specific unit by sending a challenge directed only at that unit, wherein the unit is located to ascertain the problem.

In the second type of unit a response is generated autonomously by the unit, no necessity of receiving a challenge, based on one or more threshold conditions being exceeded. The unit in this instance having sufficient power stored up, such as from prior challenges, solar cells, batteries, or power received inductively, by RF, or by other forms of power. For this second type of unit a receiver must be located nearby for registering the output from the units. It is preferred in this mode that the unit generate only minimal information to alert the receiver, wherein the receiver responds with a challenge to collect specifics of the information. This mode assures that the receiver is within range and is operational for receiving the outputs from the RFID unit. This confirmation is especially important if the RFID unit will clear information about the sensed conditions after communicating the data to the receiver. The RFID unit can collect power from the challenge sent out by the receiver.

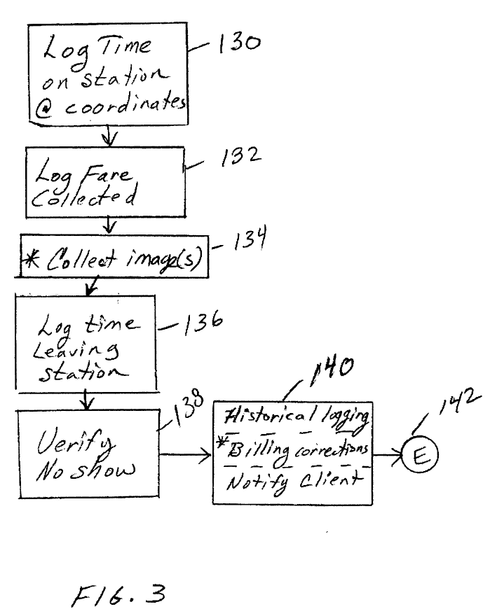

FIG. 4 depicts an ER RFID sensor 200 according to the invention. A transceiver section 202 with antenna 204 provide for the receipt of challenges and the transmission of responses. It should be appreciated that challenge receipt and response need not be via the same frequency, or even the same mode of communication. For example, the challenge can be received by receiver section 208 by means of an inductively received signal, from which power is readily stored by power supply section 210, while the transmitter 206 may generate an RF output at any desired frequency, range of frequencies or spread spectrum method. Power for operating the device is stored on a capacitor 212 which can store power received from the challenges and/or from other power sources such as an external power 214 or an internal power source 216, such as batteries, solar cells, chemical reaction devices, radioactive sources, as well as other power coupled to the device inductively, by RF, by electric fields, or otherwise.

The identification (ID) for the tag is retained 218, such as in a ROM or NVRAM memory area 218 which can also store additional information, such as a date code 220, package information, type data for checking use mismatches, and so forth. A control or logic section 222 is configured with optional memory 224 and storage for other parameters such as challenges codes and response codes 226. Control or logic can be provided by integrated logic circuit, small microcontrollers and the like.

At least one sensor 230 is shown with a threshold detection circuit 232 which can be coupled to the transmitter to establish the conditions under which the transmitter should respond or autonomously generate its own output in response to threshold crossing. The control section alternatively, or additionally, receives information about the threshold crossing and can be configured for measuring data from sensor 230, such as via an A-D converter, V-F converter, or similar means of registering a measured quantity. It should be appreciated that a number of sensor types can be supported by the device and that the threshold conditions may encompass a single sensor or require that conditions be met across a combination of sensors prior to generating responsive outputs. The unit is configured in one embodiment to transmit information for a present measurement, and/or previously stored measurements, within responses to any challenge or to specific challenges.

By way of example and not limitation, the sensing means may include any one or more of the following sensing types: code matching (i.e. read data from another source to compare with tag), motion (i.e. acceleration sensor, tilt sensor, etc.), flexure (i.e. piezoelectric strip sensor, etc.), breakage (i.e. contacts, frangible conductors, etc.), handling (i.e. electric field sensing, capacitive sensing, inductive sensing, combination with other sensors, etc.), proximity (i.e. capacitive sensors, inductive sensors, heat sensors, etc.), opening (i.e. pressure change sensor, frangible conductors, switches, etc.), moisture (i.e. moisture sensor, MEMS humidity sensors, liquid sensor, etc.), heat (i.e. thermister, etc.), pressure (i.e. pressure transducer, MEMS sensor, etc.), age (i.e. real-time clock, clock receiver, sending of a data stamp for external sensing of elapsed time, etc.), chemical sensing (i.e. CO₂ sensors, gas sensing, DNA sensors, etc.) chemical reaction sensing (i.e. exothermic, endothermic, outgassing reactions, etc.), spoilage sensing (i.e. gas sensors, bacteria and mold sensing, etc.), gas sensing (i.e. use of MEMS based gas sensors or material assay sensing, etc.), bacteria sensing (i.e. waste product sensors, gas sensors, ultraviolet sensing, etc.), mad cow (i.e. assay for detecting rogue proteins, etc.). It should be readily appreciated that numerous techniques are available in the arts for sensing each of these factors, wherein the present invention need not describe specific mechanisms or give details on their operation.

One preferred mechanism for manufacturing the devices at low cost is the integration of all these functions within a polymeric circuit, as the level of circuit complexity and power dissipation while there is very little that constrain the size of the device. Device up to a few square inches could be practically utilized, which reduces the problems with interconnecting the various elements.

The following considers an example of the device utilized for motion sensing, however it will be appreciated that alternative environmental variables may be sensed and combinations of environmental variables so that any desired conditions may be registered utilizing these ER RFID tags. In one embodiment an RFID unit (MSense RFID) is equipped with a motion sensor (acceleration, tilt, pressure, contact (sensing when touched by a user (i.e. capacitive, inductive, RF)) or similar sensor indicative of attitude changes or contact being made by a patron or other party.

The MSense RFID is configured to store power from a previous challenge and to transmit an autonomous response when a sufficient level of motion or contact is detected. The signal can alert a transceiver that the unit is being handled and that it may be leaving the area, such as leaving the shelf. In one aspect of the invention, the unit can generate an autonomous response if it does not receive a threshold sensing challenge within a given period of time (i.e. three seconds). This provide a means of generating an alert that a package is being moved from its stored location, wherein this can be logged to assure that all items are properly accounted for. This can be coupled with a system, such as a store or warehouse automation computer, that utilizes the sensed motion of the packages for directing other sensors, such as cameras, and for logging information about the different units on the shelf.

For example, an item on the shelf is picked up by a patron, causing the MSense RFID to communicate the motion to a shelf-based transceiver. The location is noted and party identified, such as by camera, or by location. At checkout the items identified by motion should show up during the scans, otherwise the item may have been subject to shoplifting (unless subsequently replaced on the shelf. If the item left the area and was no longer subject to the local shelf threshold sensing challenges, then this would be substantial further evidence that the device had perhaps been purloined.

The unit also can indicate if a unit may be defective, such as it being handled and replaced on the shelf when the user selects another of the same item. Also the unit can be used to detect buying patterns, such as which units of a rack of same units are most handled by the customers, the level of buy-through (what percentage buys item after picking it up from the shelf and other similar patterns of customer behavior. The use of MSense RFID can also aid in determining stocking status, wherein units being stocked, moved, or otherwise handled by personnel can be detected by the units.

Additional Aspects of Invention:

(1) “My Stuff” RFID-A transmitter is incorporated within a piece of equipment (integrated or as an added plug-in module), such as a phone, PDA, calculator, GPS unit, or other electronics, which periodically checks for the presence of tools, or other items having an RFID that have been registered with the unit. The system is configured to generate an alert upon any of the registered items leaving the presence of the individual. This can be useful, such as for marking tools used at a work site. The individual can keep their tools nearby and be alerted when tools leave the vicinity, or only switch on the tool identification at the end of a work session, wherein they are alerted to any missing tools. The unit preferably provides a directional antenna (as a primary or auxiliary antenna) wherein the direction of a lost item can be readily traced.

(2) Audio annunciator RFIDs-An RFID unit incorporates an annunciator that can be triggered to generate audio alerts under certain circumstances. For example, (a) generate a tone sequence when it has not been “pinged” (challenged) in a given interval;

(b) generate tones in response to a challenge or a challenge with a specific code sequence. For instance the RFID unit may be configured to generate tones or other sound patterns that are responsive to the particular challenge issued.

(3) Polymeric annunciator RFID-the RFID unit may be configured with an annunciator that is fabricated from a polymeric material. The polymeric annunciator may be fabricated and attached to the RFID but is preferably fabricated as a single unit on the same polymeric “substrate” that the RFID unit is fabricated.

### RFID-Qualifying Fueling Connections

Incorporated herein by reference:

Transponder/RFID and other related aspects described herein;

Regular patent application docket “Transponder” application Ser. No. 10/279,480 as filed Oct. 23, 2002; and associated provisional application No. 60/346,753 as filed Oct. 23, 2001;

Regular utility application describing RFID Controlled Lighting within docket “KeyboardRAST070103” application Ser. No. 10/612,777 as filed Jul. 1, 2003; and associated provisional application No. 60/394,160 as filed Jul. 1, 2002;

Regular utility application describing “Tool Tracking with RFIDs” within docket “TransportRAST070103” application Ser. No. 10/612,225 as filed Jul. 1, 2003; and associated provisional application No. 60/394,160 as filed Jul. 1, 2002.

3.1 Summary and Abstract

To prevent vehicles (aircraft, boats, cars, motorcycles, recreation vehicles) from being filled with the incorrect fuel, (i.e. Jet A instead of 130 octane aviation gasoline, gasoline instead of diesel, low octane instead of high octane, etc.). The invention may be utilized for qualifying other forms of connections as well, such as incorrect power sources, and so forth.

One aspect of the invention can be described as a fuel compatibility detection system. Preferably the system provides a passive tag for attachment near a fuel receptacle of a vehicle (i.e. aircraft, car, truck, boat, motorcycle, etc.). The tag is configured to transmit a fuel grade signal to a receiver located near the pump or on the pump handle or spout, which checks for compatibility with the grade being dispensed and can generate appropriate warnings, or even prevent dispensing fuels into inappropriate vehicles. The present invention includes an identifier within the tag which is communicated through the pump for incorporation within the collected fuel pump transaction information.

(1) Incorporate RFID tags to qualify connections. For example within gas receptacles—a sensor in the hose nozzle senses if the appropriate fuel is heading for the correct vehicle. It sends out a signal if a mismatch is about to occur. Aircraft fuel systems, vehicles, heating fuels, liquid fuels, vapor fuels (hydrogen, natural gas, etc.), even with electrical items sensing the operating voltage, current, and other conditions of the intended unit.

3.2 Detailed Description

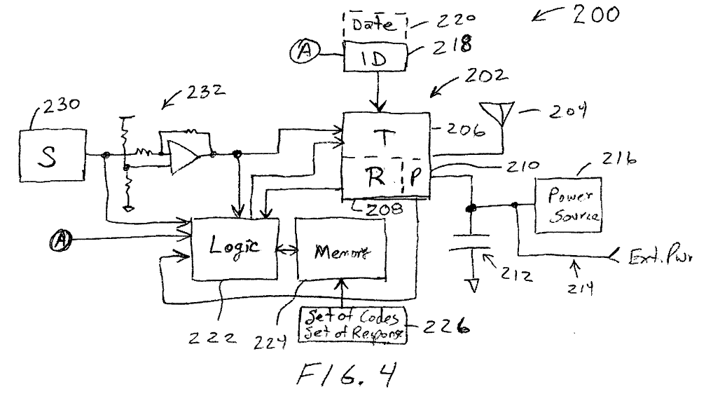

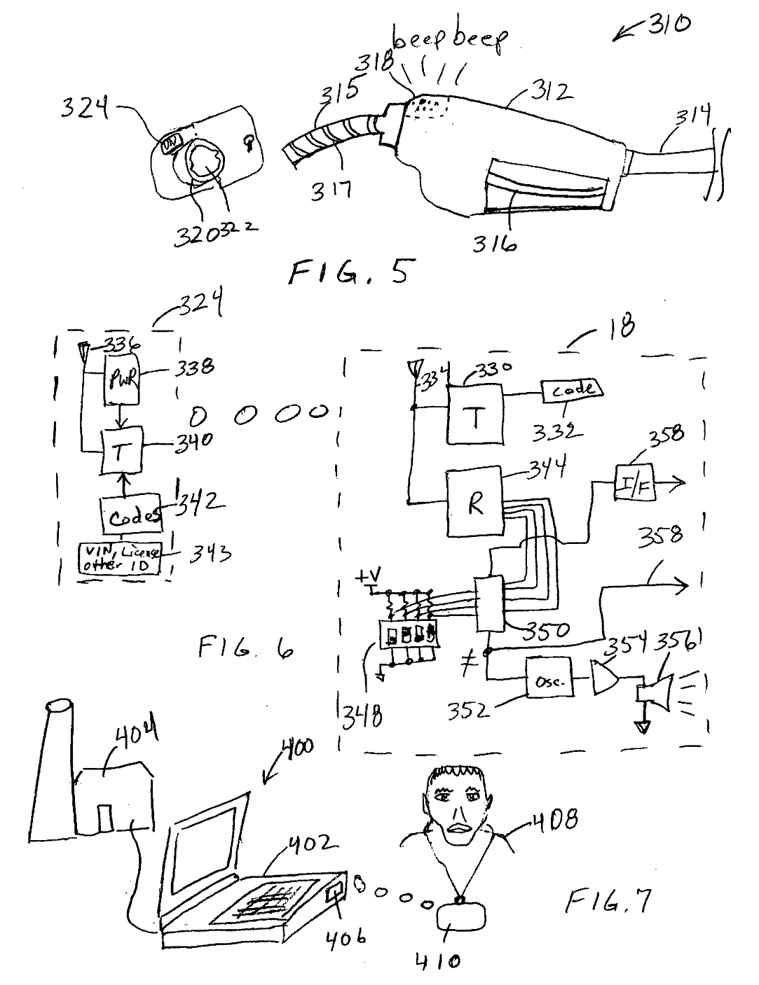

FIG. 5 depicts a system 310 for detecting attempted fuel dispensing mismatches. The handle for a gas pump 312 is connected through hose 314 to a source of fuel which is to be dispensed through nozzle 315 controlled by activating handle 316. A fuel level sensor 317 is shown attached about the exterior of nozzle 315 to determine when the tank is full so that fuel is not drawn away by the vacuum system.

A detector and annunciator 318 is joined to pump handle 312, herein shown integrated within the body of the handle, although it may be attached to the nozzle or other portion of the fueling device that is drawn up near the vehicle.

A fueling port 320, such as the tank opening for a gasoline powered car is shown with opening 322 through which nozzle 315 is to be inserted.

A RFID tag 324 is coded with data indicating the allowable types of fuel that may be accepted within the vehicle. Preferably this tag includes a readable indicia that also indicates fuel type, such as coding which indicates Unleaded, Unleaded >89 Octane, Diesel, Jet A, and so forth. Upon removing the pump handle from the pump, the transmitter of the detector begins generating challenges for RFID devices. The challenge transmitter can be located somewhere on the gas pump handle, on the gas pump itself, or otherwise in the vicinity of the gas pump sufficiently close to the vehicle to be fueled. The transmitter is preferably configured so that only RFID units within under about 2-3 feet can respond to the challenge, thereby eliminating responses from all but the vehicle being fueled.

On receiving the challenge, the RFID unit responds with the data on the type of fuel that may be utilized. Power for the response may be received from the challenge or another power source, solar power capacitive, or any other desired source of power. The detector receives the response and checks it against a coded value for the type of fuel available from the given pump. If the fuel type of the pump does not match that indicated by the RFID unit, then a warning is issued, such as a beep tones, voiced audio indicating the mismatch problem (i.e. “vehicle requires Diesel fuel not gasoline”), or other forms of annunciation.

In another embodiment of the present invention, the pump is configured to set its default fuel selection to the most appropriate fuel for the given vehicle. Circuitry within the pump control system, such as programming executing on a microcontroller within the pump, checks compares the data on fuel types received from the RFID on the vehicle. This data can include preferred levels of octane, or other parameters, wherein the selection of a preferred type of fuel can be determined automatically and the pump set to dispense the most appropriate fuel without the need of user intervention. Preferably the user can over-ride the selection, insofar as the selection is still compatible with the vehicle (i.e. fueling a gas powered car with diesel would still be preferably disallowed).

FIG. 6 illustrates an example of the RFID circuit 324, although these may be implemented in a number of alternative ways, such as shown in FIG. 4 above. The detector and annunciator 318 has a transmitter section 330 which preferably generates a coded transmission based on code 342 through antenna 336. The code can beneficially make the unit selective so that it only responds to RFID tags configured for use in fuel sensing, otherwise tags on clothing or other sources could possible interfere with properly registering the fuel type. It will be appreciated that the unit may generate an inductive transmission, an RF signal, magnetic field signal, electric field signal, or other outputs capable of being sensed. A single antenna (shown), or multiple antennas may be utilized.

The transmission power and signal are received by antenna 336 of RFID tag 324 with power being extracted by circuit 338 which may be stored on a capacitor. The code received is preferably checked within a circuit, such as transmitter 340, to validate that it is from a fuel pump transmitter and not some other source.

Once the specific codes are validated, or codes associated with the allowed fuel types stored in memory 342, or based on contact pair settings (i.e. traces which are broken or unbroken), are transmitted by transmitter 340 back to detector and annunciator 318. Along with the fuel type, a header code is preferably sent that identifies that the response has been generated by a fuel type RFID tag and not another form of RFID. A receiver 344 within the detector-annunciator collects the coded response and after preferably first checking that the code is from a fuel type RFID tag, it checks the fuel type represented by a data comparator 350 which compares the value against a set code 348 which is set for the type of fuel being dispensed from the fuel pump. If a fuel type mismatch arises then oscillator 352 is triggered whose output is amplified 354 to drive an audio annunciator 356. Optionally, the mismatch signal 358 can be communicated back to the pump to register the problem and/or to shut of fueling to prevent the erroneous fueling operation.

It is preferred that the unit provide different levels of warnings. For example consider a vehicle that should be filled with unleaded hi-octane (>89 octane) fuel. If someone attempted to fuel it with diesel fuel then a high level of warning should be generated as the vehicle would not operate on diesel fuel and it could damage the engine. However, if someone attempted to fuel the vehicle with 87 octane fuel a lower level of warning is generated by the system, because the vehicle could operate on the lower octane fuel and their may be a reason the user chose it.

In an enhanced embodiment of the invention, the RFID transponder tag is configured with memory 343 for retaining identification information, preferably specifically about the vehicle. For example, the VIN, license plate number, or other identifier associated with the vehicle can be encoded in the RFID. Alternatively, any somewhat unique identifier can be encoded into the RFID to distinguish one vehicle from another. The transponder tag is configured to automatically transmit this vehicle identifier, preferably along with the fuel type data, at the time it is challenged.

The challenge transceiver system at the pump location is configured to receive this ID which is communicated back, such as via interface 358, to the fuel purchase transaction log, wherein the vehicle being fueled is included within the transaction log allowing this information to be printed with the receipt, printed on the bank statement and so forth. The user can tell which of the vehicles was filled with fuel when they view the receipt, charge card statement, bank statement, or other statement including transaction information and which is configured according to the present invention to include the vehicle identification information.

The memory within the RFID can be configured as a section of one time writable memory, therein allowing the user to set their own vehicle identifier if desired, such as names for each vehicle.

FIG. 7 depicts a different aspect of the invention wherein the secure RFID is used in an embodiment 400 for controlling who can operate equipment. In this embodiment the equipment generates periodic RFID checks (on power-up and every minute or so thereafter). User wears an RFID as sticker on ID tag, wallet card, pen, or so forth. Equipment only operates for personnel with correct level of clearance, or even for a specific individual.

A laptop computer 402 having special application programming for controlling a factory floor 404 (or otherwise providing information or control to which access is to be limited). A detector-annunciator 406 installed on the laptop computer generates challenges upon being powered up. If the challenges are properly responded to by an RFID unit, such as the one around the neck of individual 408 contained on the ID tag 410, then the computer can be operated conventionally. However, if the person walks out of range of the computer the screen blanks, or otherwise shows non-confidential information, and the inputs to the computer are locked out, such as the keyboard and pointing device. If a person without the proper clearance on their RFID tag powers on the computer, then it preferably locks the user out from any sensitive functions, and may simply come up with a warning message.

Optionally, when a proper RFID is not present the unit can display a screen for collecting a username and password, which could provide a backdoor should a person with proper clearance lose their tag or if the tag is otherwise inoperable. Additionally, for more highly sensitive items, it may require that at least two usernames and passwords be entered to bypass the RFID security.

### Transitions Lighting—(AfterGlow Light Switches)

### (Category: Lighting Subcategory: LightingAfterGlow)

Utility patent application describing “LED Lighting for Tubular Fluorescent Fixtures” within docket “Display_RAST092303” Ser. No. 10/670,432 filed Sep. 23, 2003;

Provisional patent application related to the above Ser. No. 60/413,199 as filed Sep. 23, 2002;

Provisional patent application describing “Transitions Lighting” within docket “PPA_RAST061403” Ser. No. 60/478,900 filed Jun. 14, 2003.

4.1 Background

Injuries often occur as a result of turning off the light in an area that needs to be traversed. It will be appreciated that our ability to see in the dark is limited, and can be compromised for a period of many seconds or even minutes after exposure to sufficiently bright lighting. The use of dual-pole (multi-way) switches allow a light to be controlled from either and entrance or exit, but it is very difficult to install such switching into existing infrastructure which does not provide additional light switches.

Accordingly a need exists for a system and method of eliminating the necessity to traverse an areas that is darkened by our turning off the light switch. The present invention fulfills that need and others and can be implemented within the existing infrastructure.

4.2 Summary and Abstract

A number of aspects of the invention are provided for increasing safety when transitioning a room whose light or light have been turned off by a switch. (1) A mechanism is described which affirms the off selection, and then transitions the lighting over a period of time to the off condition. (2) A mechanism is described for activating a separate transition light for a sufficient period of time to allow transitioning the room or area that will be darkened. (3) A mechanism is described for creating a virtual dual-pole switching (or multi-way switching) arrangement that can be utilized with existing light wiring. Each of these aspects can be implemented for removing the danger for moving through an area that is darkened in response to switching off a light or lights.

In addition a “light bulb” is described which contains one or more LED elements, and having a base configured for insertion within a light fixture, such as a conventional screw in base light fixture. The bulb is configured to fade the light output from the LED elements in response to powering off the AC to the fixture, instead of the conventional immediate loss of lighting. This improvement allows individuals to be able to see while traversing an area after turning off the light switch, but the light drops somewhat and/or another signal is generated in response to AC being turned off so user does not wonder if they have indeed turned off the light.

Other aspects of the invention also describe incorporating a means for retaining some level of light output from an AC powered light fixture after the AC power has been shut off. In these embodiments, the system is implemented within LED light bulbs, or fluorescent tubes, as described in the incorporated application, which can be inserted within an AC powered light fixture. For example as an LED light bulb as a screw in replacement for a conventional incandescent bulb.

The incorporation of the present transitional lighting device has a number of benefits to the user, and unlike other forms of lighting such as incandescent or fluorescent lighting it can be readily implemented. It should be appreciated that fluorescent lighting cannot be dimmed, while incandescent lighting is driven at high voltage, with high power requirements, directly from the AC line without a regulating circuit. Within an LED bulb however, the low power and the need for power regulation, allows for the inexpensive addition of this transition lighting circuit for generating sufficient light to allow egressing an area after the light switch has been flipped to OFF.

The teachings may be incorporated within any LED based lighting element which incorporates a power regulating device within the bulb unit, such as conventional looking bulbs, LED bulbs in a fluorescent lighting form factor, and other packaging configurations.

4.3 Description

### 4.3.1 Temporal Transitioning of Existing Lighting

In this embodiment when the user switches the lighting to an off position, the switch mechanism does not immediately switch to off, but instead transitions the light over a period of time from the on to the off position. This extra time allows the person to egress the soon to be darkened area. Lights controlled by the switch can operate in concert or separately. Often a light switch is positioned on a wall such that we must turn off the light and then walk across the room in the dark—until we reach the next light switch—not very safe or comforting. Invention keeps lights lit briefly to allow transitioning the room.

One embodiment is a time delay within a given light switch. Light is flicked off, then it blips back to a dimming mode keeping some light for a period of time. For incandescent lights the unit can fade the intensity over time, whereas fluorescent lighting may need to retain a standard intensity. Preferably a switch selection allows user to determine the type of lighting attached, mode of transition, and optionally even the time delay.

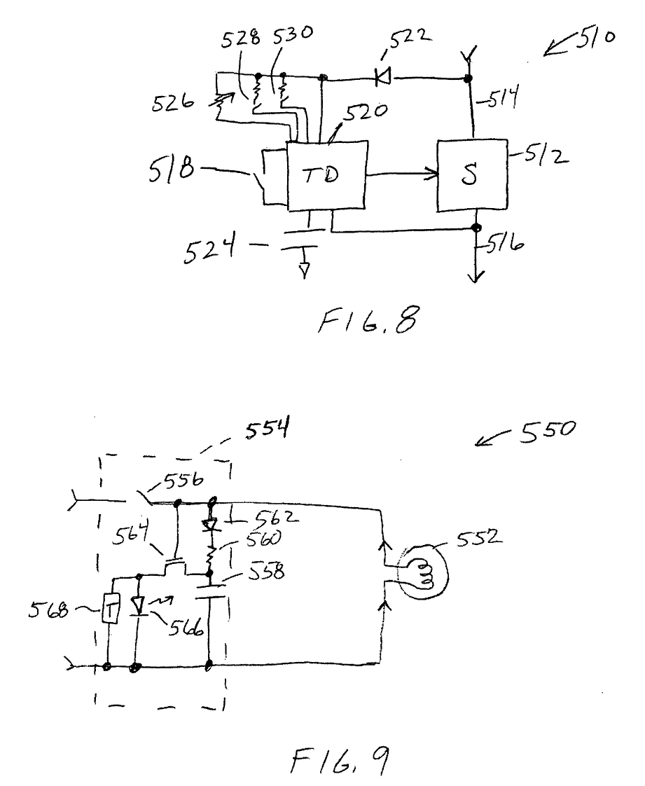

FIG. 8 exemplifies an embodiment of transition lighting 510. An AC control switch 512 (i.e. Triac, SCR, FET based) is connected to control the current passing through switch contacts 514, 516. A manual switch 518 receives user light control input to a timer element 520 that can store power via diode 522 and capacitor 524. Upon switch 518 being set in an off state the device is configured to generate an indication that the switch has been set to the off position. In this embodiment the timing device preferably temporarily shuts down switch 512 (i.e. for 0.2S to 2S) after which it sets switch 512 to a half active state, preferably by switching on and off at about a 50% duty cycle. The average current through switch 512 is then dropped over a sufficient period of time to allow the person turning on the light to leave the room while it is lit, for example approximately 15 seconds, and then completely switched off until switch 518 is again activated by the user. Other forms of annunciation can include initially dropping the intensity to a second intensity from which the lighting transitions over time to the off state. The dimming of the light is preferably accomplished by either changing the portion of the 60 Hz waveform at which the transition from off to on occurs, such as when using an SCR, TRIAC or similar AC control switch. Alternatively, pulse-width modulation (PWM) can be utilized for controlling the on and off duty cycle and thus the intensity of light provided. Controlling the power as above can allow for some level of dimming to occur for fluorescent light fixtures. It is preferable that the switch be configured with separate settings for incandescent and fluorescent lighting, or that a separate switching unit be sold for use with fluorescent lighting.

On lighting controlled by a dimmer, as the light is already dimmed when the off-state detent is activated, the light level will be increased to provide sufficient light to comfortably see when transitioning across the area. Annunciation may be provided by pulsing the light intensity to a medium-intensity state for a brief period (i.e. 0.2S to 1 S).

An alternate embodiment may be created by configuring light bulbs to provide the transitional effect. In a first implementation portions of the interior of an incandescent bulb is coated a phosphorescent material, that fluoresces after the light is switched off. Preferably the portion coated is that portion about the base of the bulb so direct lighting through the bulb is not blocked. This is particular well suited to flood light style bulbs portions of the interior of which are conventionally coated with reflective material. In a second implementation a power storage element is coupled to the lighting element (i.e. within or separate) which retains sufficient charge for keeping the light element lit for a number of seconds after the power has been turned off. This implementation can be used with any form of lighting but is particularly well suited for use with direct current lighting elements, such as LED lighting which is becoming increasingly affordable.

The unit is preferably configured with a means for allowing the user to select the parameters of device operation. By way of example, the time delay may be set, such as by control 526, and mode selections asserted on the annunciations, and intensity drop as depicted by controls 528, 530.

It should be appreciated that a number of different circuits can be utilized within the light switch for slowly transitioning the light output between the On state and the Off state; these can be utilized without departing from the teachings of the present invention.

### 4.3.2 Temporal Transitioning of Additional Lighting

In this embodiment when the user switches the lighting to an off position, which triggers another light to respond for a period of time. In one embodiment the light is generated from the switch itself, such as from one or more focused high intensity LEDs or a diffused laser light.

Embodiment 550 exemplifies this form of transition lighting wherein a lamp 552 (incandescent or any other form of lighting) is coupled through a switch 554 to the power mains, such as 110 VAC. A conventional AC power switch 556 can be utilized in this example for switching the power to lamp 552.

A means for storing electrical power charges during the time the light is in the On position and upon detecting that switch 556 has open circuited, it activates its own lighting thus providing some light to allow the user to safely egress.

Energy can be stored on a capacitor 558 upon which charge is stored as current passes through rectifier 562 and limiting resistor 560. When light switch 556 is switched to OFF then switch 564, exemplified as a MOSFET switch, activates this allowing the current from capacitor 558 to power LED 566. The intensity of LED 566 naturally drops as the charge on the capacitor is dissipated. It should be noted that no additional annunciation means is necessary with this embodiment as the lights being controlled by the switch actually turn off and appears conventional.

The light source 566 may comprise one or more lighting elements of any desired type. It is preferred, however, that the lights be retained within a housing that allows the user to set the direction of illumination, wherein it can be assured the light is being directed at a proper location.

In alternative embodiments, light source 566 and the circuit shown, or a similar operating circuit, can be located within the lighting fixture. By way of example the light and circuit can be integrated within an add-on module, such as within a screw-on base module into which light 552 is then threaded. In this way it is assured that the light is being generated at a suitable location for the area.

In another alternative embodiment, light source 566 is replaced, or augmented by, a transmitter 568 configured for directing a signal to a remote switch or lighting unit. A signal from the transmitter (i.e. AC line signal, RF, magnetic field, electric field, optical, ultrasonic and so forth) is configured for activating a separate light element to provide the transition lighting. The separate light element may comprise other conventional lighting, battery powered lighting, or other auxiliary lighting which is configured with a receiver for being at least partially activated in response to the receiving the signal. The signal can be received over the power lines, through the atmosphere and so forth.

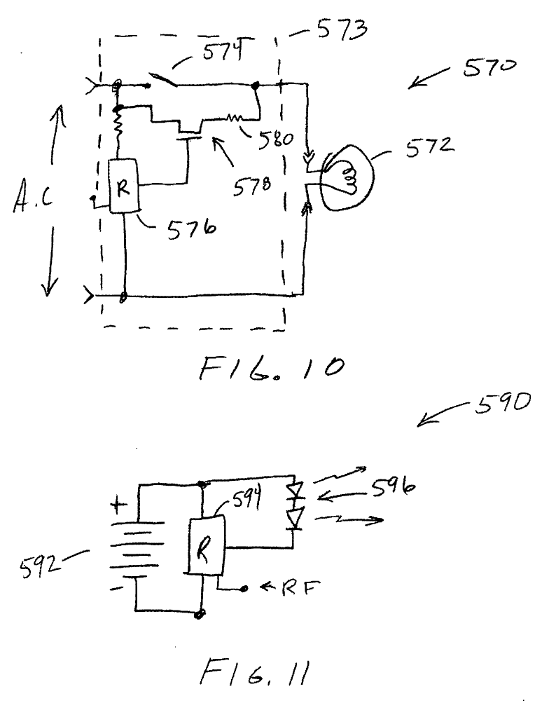

FIG. 10 depicts an embodiment 570 of an auxiliary lighting element whose output is controlled in response to transmissions received from transmitter 568. In this example the auxiliary lighting is provided by a conventional light controlled by a switch 573 having an integral receiver 576. The receiver 576 is configured to receive the transmission from transmitter 568 and to activate light 572 accordingly at a sufficient intensity level to assure safety (i.e. low to medium intensity). The signal can be received as a signal superimposed over the power lines, an RF signal, an optical signal, an acoustic signal, or other desired form. Upon receiving the signal, receiver 576 activates switching element 578 to allow a level of current to flow through lighting 572. The intensity of the lighting can be controlled, such as by PWM modes, or by controlling the current flow, such as in response to power resistor 580.

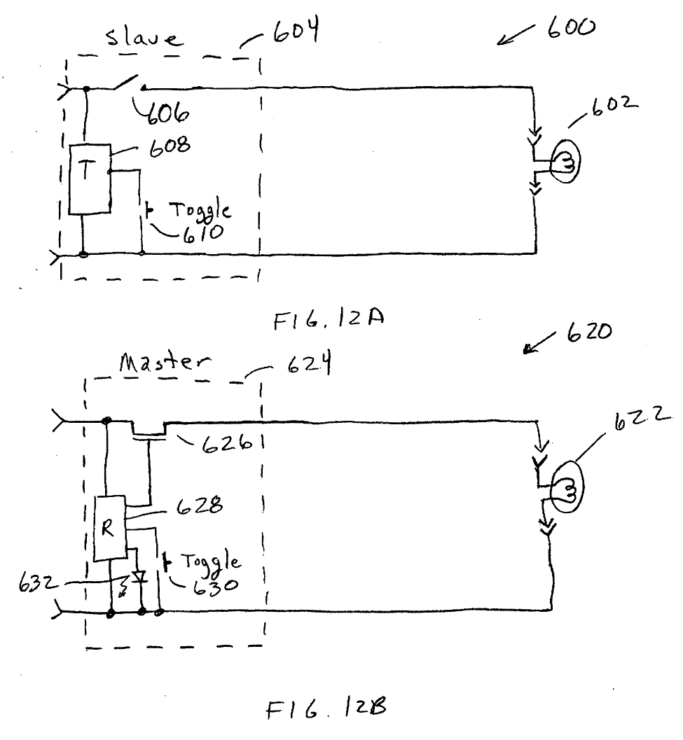

FIG. 11 depicts another embodiment 590 of auxiliary lighting in which a power source 592, preferably a battery, (or solar cell charged capacitor/battery, fuel cell, AC powered, etc.) provides the power for receiver 594 as well as low power lighting 596. Upon receipt of the transmissions receiver activates an internal switch to power light elements 596, such as LED light units. For example a couple of standard AA batteries could be used to power a stick-on remote light in response to the transmitter signal. The duration that lighting 596 is activated can be controlled by either transmitter 568, or a timing element within receiver 594, or a combination of the two. The invention can be embodied with a user selectable lighting duration, depending on the application.

### 4.3.3 Multi-Way Light Switching

In this embodiment the existing light wiring is augmented with additional circuitry to provide multi-way lighting without the need to change the wiring. A slave switch and a master switch are configured with a transmitter and receiver respectively for communicating state changes of the lighting. The transmitter and receiver preferably communicate by superimposing signals over the conventional power lines, although RF, magnetic, electric field, optical, ultrasonic, and other forms of transmission between the units may be utilized. In this embodiment one light switch is the master switch, as it is the one that the light being powered is actually connected. One or more other remote switches are configured as slaves switches to generate signals to the master switch for changing the state of the lighting. Preferably, the slave switches are configured to provide the control of another conventional light as well as the slave signals to the master, thereby eliminating the need for extra switches as any existing switch can be swapped out with a slave switch to control any desired light.

FIGS. 12A and 12B illustrate by way of example a slave switch arrangement 600 and master switch arrangement 620. A light element 602 is controlled by a light switch 604 whose switch element is 606. Light 602 is controlled generally conventionally. However, an additional transmitter and control circuit 608 is contained within switch housing 604 along with a selector 610. In response to activating switch 610, transmitter 608 is activated to send a signal to the master switch. It should be appreciated that the state of light 602 does not change in response to pressing temporary contact switch 610. The slave function can thus be embedded within a light switch used for controlling another light not associated with the master.

In master circuit 620 a light 622 is controlled by an electronically activated switch 626. A receiver and control circuit 628 is configured with switch 630, again preferably a temporary contact switch (i.e. PBNO). In response to activating switch 630, after debouncing, the state of a flip-flop within circuit 628 is toggled which changes the state of switch 626 and the ON or OFF state of light 622. A separate indicator 632 can be provided to indicate the intended state of the lighting, so that the state can be determined without the need to see fixture 622, and so that the state can be seen even if the light element 622 becomes inoperative.

In response to receiving a signal from transmitter 608 in FIG. 12A, the receiver in FIG. 12B toggles the state of switch 626 to the opposite condition and sets the LED activity accordingly. It will be appreciated that in this way light 622 can be controlled by any light switch in the house, wherein the need for extra wiring for multi-way lighting is eliminated.

The slave and master can even be coded so that multiple slave-master pairs may be utilized within a given household without interference. The code should be sufficiently long so as to prevent interference between adjacent households which can share a common power distribution transformer. Up to as many as four to about twelve homes can share a single power distribution transformer. It should be appreciated that these light control switches can be implemented in a number of alternative ways without departing from the present invention.

### 4.3.4 LED Transitions Bulb

This embodiment incorporates circuitry within an LED based light bulb for maintaining a light output after the AC power to the element has been turned off. The light output transitioning sufficiently at the time of AC being turned off, or another signal being generated, wherein the user is given sufficient feedback that they have indeed turned off the AC power to the light and the light is acting to execute.

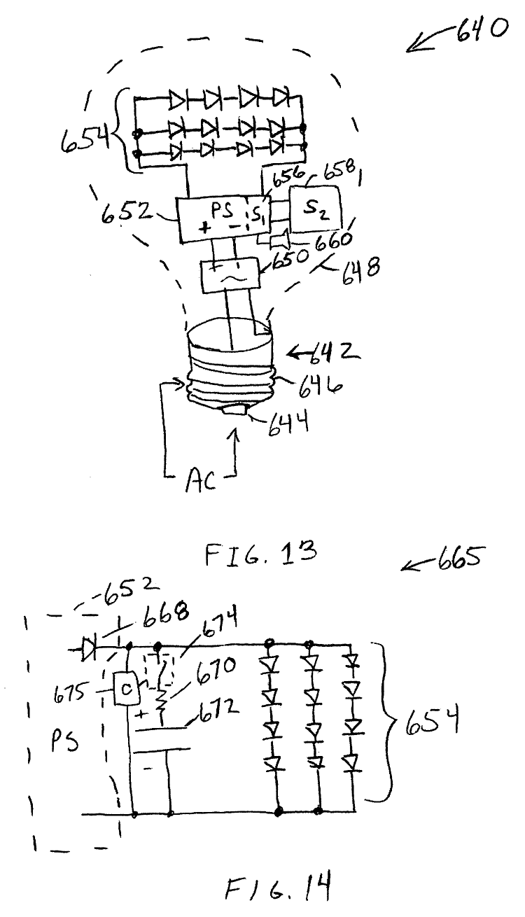

FIG. 13 depicts a schematic diagram of a multi-element LED lighting element “bulb” 640. The bulb embodiment shown has a base 642 with a center electrode 644 and a threaded electrode 646 for coupling to an AC power source. A housing 648 is shown, that is transparent or has at least one transparent portion to allow the light to be emitted. Circuitry with the light bulb comprises a rectifying means 650, such as a full wave bridge rectifier coupled to a power regulating device 652, which regulates the current provided to the LED array, shown as a combination series-parallel combination, although any form of connection can be supported as well as driving single LEDs of high power.

Additional circuitry is shown which provides the functions of the present invention with a circuit portion (S1) 656 within the power regulator and a power storage circuit (S2) 658 shown coupled to power regulator 652. When AC is being supplied to the bulb unit through electrodes 644, 646 the power regulator stores charge on power storage circuit 658. When the AC power is turned off, then power regulator 652 selectively utilizes the power from the storage circuit 658 for powering a timing control circuit which controls the rate at which stored power is applied to the LED lighting elements.

It should be appreciated that when the AC power is turned off that feedback should be provided to the user that indeed the power has been disconnected. This may be in the form of transitioning the light output from the LEDs as a signal, and/or using an annunciator, such as annunciator 660 (i.e. piezoelectric) coupled to the circuit section 656.

A light signal indicating power turn off may for example comprise one or more flicks of the light output into an off state, followed by the light output slowly dimming, or various other patterns. Control circuit section 656 within the regulator (or coupled to the regulator) controls the transfer of power from the power storage circuit 28 to the lighting. The power stored on the power storage circuit 658 may be stored at a higher voltage than can be supplied to the LED elements, wherein the power supply may operate to convert the voltage and supply only the necessary current to the LED lighting elements.

FIG. 14 depicts a very simplified version 665 of the circuitry within FIG. 13. In this embodiment the power regulator is configured with a limiting diode 668, or otherwise configured not to allow a reverse flow of current from the power storage element back into the regulator circuits. A means for limiting current, depicted as resistor 670, is coupled to a power storage element, depicted as a capacitor 672 (i.e. such as a dual-layer capacitor or other form of what is commonly referred to as supercapacitor having a high level of charge storage density).

An optional switching element 674 (i.e. a MOSFET switch) in combination with a control circuit 675 is depicted for providing additional control of current flow from the capacitor to the LED array. For example the controller generate pulse width modulated signal (PWM) for controlling the intensity of the LEDs and prolonging the time over which a low to medium intensity of light is provided, or allowing the use of a smaller storage capacitor 658.

In operation, the capacitor charges after power is applied, but the LED light output is not significantly dimmed nor is the power-supply overtaxed because of the current limiter 670. Once AC power has been deactivated, the power from the charge storage device 670 is supplied to the LED(s) (at less than their operating voltage which charged the capacitor), through the current limiter. It will be appreciated that as the light switch is flicked to OFF, that the light intensity drops immediately as the power supplied to the LED array is now through current limiter (resistor), and that the output light intensity fades in response to the time constant 1/RC. In this way the simple circuit provides for retaining energy for maintaining the lighting, for signaling the light change, and for transitioning the light from its active state as it dims over time to the off state.

One embodiment of the solid state lighting of the present invention can be described as a solid state lighting element, comprising: (a) a base configured for insertion with an AC powered light fixture; (b) at least one LED light emitting element contained within said base; (c) a power rectifying and regulating circuit coupled to said at least one LED element and configured for controlling the power applied to said LED in response to the receipt of external AC power to said regulating circuit; (d) means for signaling that the external AC power received has switched from an ON state to an OFF state and for retaining the power output from said LED light emitting element for a given period of time.

The means for signaling can comprise a capacitor configured to charge from DC power supplied by said power regulating circuit when said AC power is in the ON state, and then to discharge through said LED light emitting element(s) after AC power to the power regulating circuit has been turned off.

It should be appreciated that a number of different embodiments can be created from the teachings herein and in the parent application.

### PrePaid Mail eMail

Incorporated herein by reference:

Regular patent application docket “PSPid” application Ser. No. 10/066,495 filed 02/02/022;

Regular patent application docket “VideoCloakingRAST070103” application Ser. No. 10/612,686 as filed Jul. 1, 2003; and associated provisional application No. 60/394,160 filed Jul. 1, 2002.

5.1 Background:

Traditionally email has been free which is good for interpersonal communication, but leads to unrestrained impersonal communication, such as from advertisers (spammers) that send unrestricted thousands and millions of unsolicited emails at no cost to themselves.

5.2 Summary and Abstract

To reduce the problems with spam without reducing desired communications, the present invention provides means by which friends, associates, and business contacts can exchange emails at their discretion from other parties. The system is configured for charging for each email to be received by a user. The user in this case upon receiving email from someone they want to keep communicating with, clicks to automatically reverse the charges, therein sending an equivalent paid email back to the sender. This response provides a confirmation and equalizes the billing. Parties wishing to communicate can thus exchange mail between each other for free, while mail is received only from other parties that are willing to pay for the privilege.

5.3 Description

The present system provides a system in which the user can select to allow only prepaid mail to be delivered, which is email for which a cash payment is accrued to their account on receipt or more preferably when opened. The amount being prepaid by the sender as a prerequisite for a value being displayed in association with opening/perusing the email. (Otherwise it is feared that an advertiser may indicate a high payment on an email and then welch on posting of that payment.)

The system can be configured according to the invention so that the amount paid for the email by friends and desired senders is returned at user discretion, preferably in response to a single click or automatically based on information from the email, so that these forms of desired email are not restricted. Alternatively, the amount of the paid email can be declined, also in this way preventing the billing of the sender for the email. More preferably, the an email if equivalent value is posted back to the originator in another paid email, thereby providing a confirmation of receipt and of payment return. The email may be sent in a form of reply which may constitute a return receipt to the sender. Preferably, the payments are applied and deducted for paid emails within an account tracked by the user's internet service provider (ISP). In this way the user can charge their account if desired, and build up dollar credits based on opening paid advertising emails if desired.

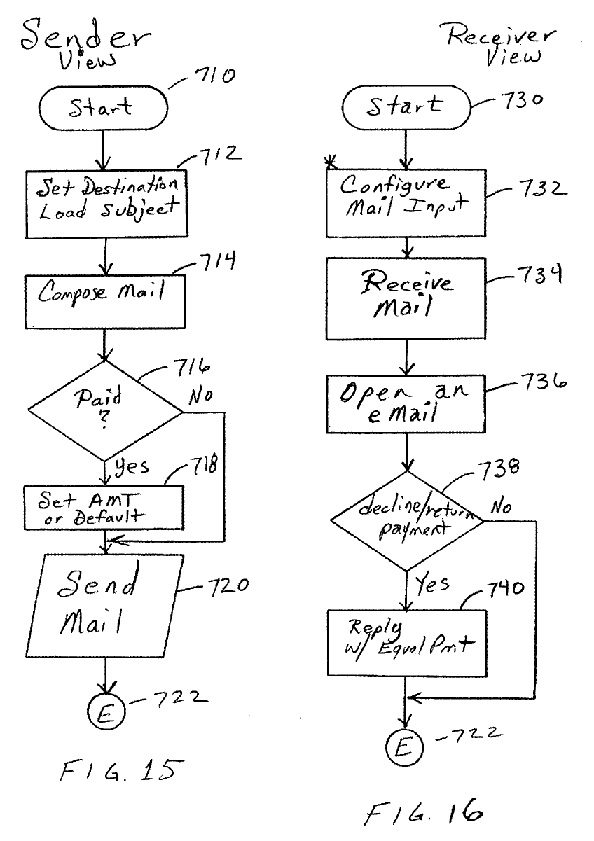

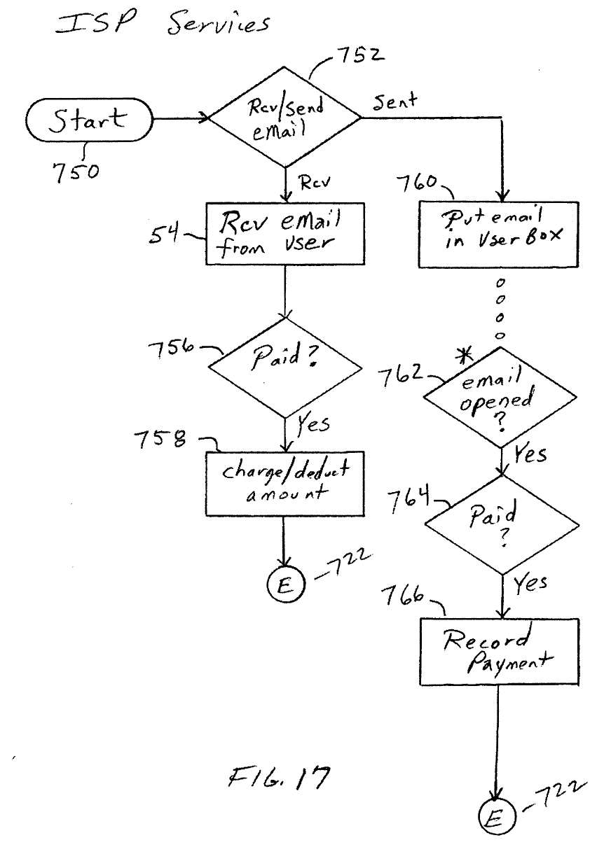

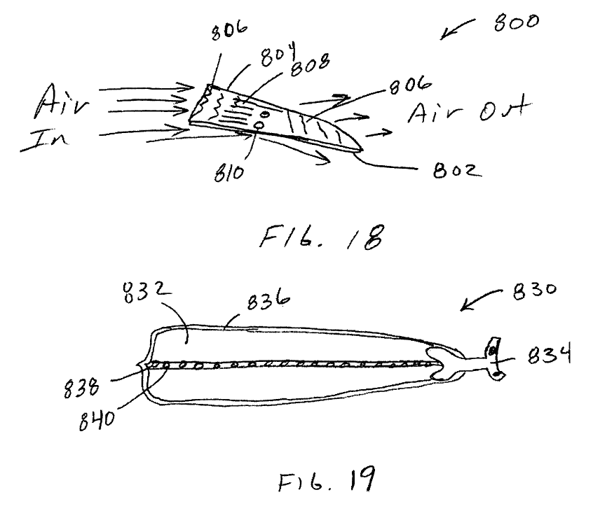

FIG. 15 and FIG. 16 exemplify sender and receiver views while FIG. 17 illustrates operation from the view of an ISP.

The sender starts at block 710 a browser session and sets a destination and loads a subject line at block 712 and composes the email at block 714. The browser (or a separate payment application to which email may be run through by the user or ISP prior to sending) asks queries the user for payment detail at block 716, which may be collected as a manual response or based on a session value, default, or other automated payment selection. Preferably, an amount can be applied to the email as represented by block 718, or a default payment value attached. It is preferred that a standard rate be adopted for emails of a certain size, such as less than 500k. Emails of larger sizes requiring a larger payment, such as by the megabyte. This encourages parties toward smaller emails thus reducing the traffic and slow-downs on the Internet. The email is then sent at block 720 with the associated payment, and this portion of the session ends as per block 722.

A fee may be collected for handling the payment transaction, which is preferably paid as a portion of the original email payment. For example, assuming a 1% fee being charged for handling the financial transaction for the email, then the sender could be charged an additional fee, such as a based on amount (i.e. 1 cent for a 25 cent payment amount), or a flat fee may be charged (i.e. 1, 2, 5, or 10 cents per email), the amount being generally at the discretion of the party handling the transactions as agreed by the user.

The receiver in a browser session at block 730 can configure their system as represented by block 732 to select if payment is required for mail to show up in their mailbox, or to otherwise order mail based on payment value. The configuration also preferably allows the user to set conditions under which payment is automatically returned to the sender, or for establishing the emails for one-click verification of returning the payment. The conditions for example may be set for certain parties and which can be further narrowed in response to the use of keywords in the subject line, or to address. By way of example anyone on the receiver's address list can be configured for one click responses.

It will be appreciated that this configuration step may have been performed at an earlier date or performed in a separate application or routines. Email is received at block 734 and displayed according to the configuration of block 732. Upon opening a paid email at block 736, the paid amount may be returned to the sender by a single action of the user, such as a single click, or automatically upon the email meeting the criterion of the receiver. Unless specified otherwise by the user, the email charge is accepted for email that is deleted by the user. The user has the option at any time of sending a equal charge response back to the sender. The user can include additional information within the email as desired within the given charge. The amount charged for the responsive email can be set to at least cover that of the email received.

Optionally the payment associated with opening the email as represented by block 736 may be subject to authentication that the content has been perused, such as if the email is a paid advertisement. For example, if the sender is a friend of the user and the user has elected to return payment from all friends in their list, then the payment return may be generated automatically, or it may be set as a default requiring the user to confirm it before returning payment. If payment return is elected then the payment is either declined by informing the ISP, or a responsive email is sent having an equal value which can also serve as a return receipt.

The email program of the user is preferably configured with additional data fields for each email address in the user's address book for tracking the amounts going in either direction. For example consider the email program of a Hugo Rolf, having an entry for the email address of Steve Smith which indicates a +$0.75. This value indicates that Steve has paid for $0.75 of emails that were not reimbursed from the user, Hugo Rolf. The user, Hugo, has the opportunity at anytime to select that the amount be returned, such as via a responsive email. The user can alternatively compose an email and elect to set the amount equal to the balance, insofar as it is positive in this case. In this scenario if Steve Smith were to look at his entry of Hugo Rolf he would see an amount $−0.75.

FIG. 17 illustrates programming at the internet service provider of a given user with programming that executes at block 750 in response to email sending and receiving as detected at block 752. If an associated user is sending email as per block 754, then it is received by the ISP, wherein a check is made to determine if the email is to be sent as a paid email at block 756. If a paid email, then the associated amount of the email is charged to the user account or alternatively deducted from an existing account sum as represented by block 758 before this part of the session is completed. In this way the email is prepaid, wherein the sender cannot make payment claims which are not fulfillable.

An aspect of the invention is a method ascertaining if the user has “viewed” the paid email content, as opposed to merely opening it and deleting it which would provide little value to an advertiser. Preferably additional fields are added for received emails which indicates if payment is associated with the email, along with the amount and rate of such payments. These additional fields can be supported on browser screens so that users can more readily ascertain which content they want to read.

One embodiment credits the user an amount just for opening the email, while additional metrics can be applied, such as opening the mail and keeping it on screen for a given amount of time.

A preferred aspect of the system allows crediting the user an amount based on how much of the email they had perused. Elements of this embodiment include:

(1) pay rate indicator—informs user prior to opening an email what the rate of payment for perusing the email is. The rate being based on the number of words in the content, number of paragraphs, number of pages, number of perusal responses required, or other metric based on the amount of content or interaction required from the user. Without this the user may open an email with a value of $1 only to find that getting that amount requires perusing a hundred pages of content. This indicator may be used in combination with a base level amount which is paid just for opening of the email.

(2) personal information indicator —IF achieving the email credit involves entering personal information, then it is preferred that this fact is required to be disclosed by the pay rate indicator, because many users would not want to disclose personal information or fill out personal questionnaires in response to

(3) perusal verification mechanism —it is preferred that this perusal verification mechanism be configured for capturing user interaction based on the displayed information on the page, BUT which can not be readily generated by programming, such as within a browser add-in, AND which can be verified to be free of requirements for the user to enter valid personal information. One preferred method of this is for the receiving user's ISP to verify content perusal, which prevents an unscrupulous advertiser from withholding payment to a user by ignoring or otherwise holding invalid the responses of the user. For example a graphic is displayed with an identifiable numerical aspect (i.e. number of duck bills shown, maximum number of balls on a small animated screen, and so forth; the ISP providing the test and answers.

It should be appreciated that the underlying system for charging for emails can be provided in any convenient manner, wherein the aspects of returning the charges and of indicating the cumulative charge balance between associated parties on the mailing list are described herein and may be implemented in any desired manner.

### EVRHeadsets—Communicate Via RF

Incorporated herein by reference:

Regular utility application docket “EVR Headsets” application Ser. No. 09/841,713 filed Apr. 24, 2001.

6.1 Description

This describes an aspect of the Environmentally responsive headsets within the associated parent application. This aspect provides for allowing RF communication while shielding unwanted noise. A receiver is incorporated within the EVR headsets that is configured to register radio signals from RF intercom, radio equipped traffic icons (alerts), outputs from other devices such as hard braking sensor output that communicates hard braking, swerving, crashes, etc. Preferably, a microphone and transmitter are also incorporated for certain applications to allow two-way communication while suppressing noise received external to the communication channel, such as from outside sources. In one application the headsets can be used for providing both noise attenuation and communication between roadway construction personnel, or other groups that could be served by communicating with headsets.

### FanFilter—Ionization Units & Sterilization

Incorporated herein by reference:

Regular utility application docket “KeyboardRAST070103” application Ser. No. 10/612,777 filed Jul. 1, 2003; and associated provisional application 60/394,160 filed Jul. 1, 2002;

Provisional patent application docket “PPA_RAST120103” application No. 60/526,376 filed Dec. 1, 2003.

7.1 Description

FIG. 18 depicts aspects of the invention which increase the ability of the FanFilter in the parent application to remove airborne contaminants and to ionize the air. An embodiment 800 is shown with fan blade 802 and an option fan filter housing 804 in which are contained filter elements 806, and plates for an ionizing unit 808 along with elements 810 of a UV sterilization unit (i.e. using lights or other UV sterilization elements).

The fan unit is shown incorporating UV sterilization unit, and/or ionization within the rotating fan blades. Although shown incorporated within the fan filter, it should be appreciated that these elements can be less preferably incorporated upon a fan that does not include the filter, without departing from this aspect of the invention. By way of example UV sterilization can be provided by integrating an ultraviolet lighting unit in a place over which the air passes, such as within a contained area preferably within the filter section. A ionization unit can be provided which is coupled to the fans wherein the effective area of ionization is dramatically increased in response to the movement of the fan blades. The ionization unit may be integrated within the fan or otherwise coupled to the a portion of the fan blades. In addition a receptacle can integrated for receiving air freshener, wherein the scent is dispensed in response to rotation of the fan. These aspects may be incorporated within the fan blades with or without the filter unit.

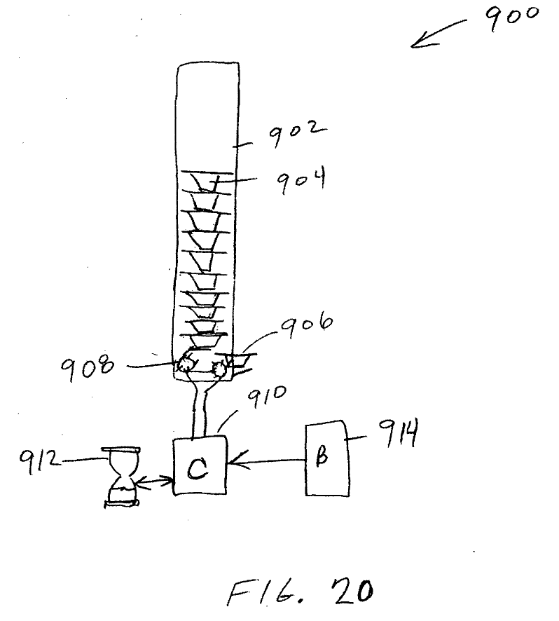

FIG. 19 depicts other aspects of the invention wherein lighting is coupled to the fan blades themselves. Incandescent and even fluorescent lighting have often been incorporated within a light fixture hanging from the fan unit. These lighting units can extend down to where they interfere with persons walking underneath, provide lighting from a limited area, and the fixtures are subject to loosening due to the motion of the fan and these units often generate annoying noises. An aspect of the invention therein provides a fan with solid state lighting 830 incorporated within the fan blades. It will be appreciated that solid state lighting, such as LED, or electroluminescent, or organic LED are not effected by centripetal forces and have a long life span. By integrated the lights over the surface of the fan the light can be made more disburse. A fan blade 830 is shown with a planar blade 832 and an attachment means 834. Lighting is shown 836, such as electroluminescent lighting, on a first area of the fan blade, by way of example shown surrounding the perimeter of the fan. Preferably perimeter lighting provides a substantially soft surface wherein the impact to individuals that accidentally stick their hand up too high or otherwise extend anything in the path of the blades, is reduced. However, lighting 836 may be oriented over any desired portion of the blades. large area lighting such as organic LED panels can be configured to substantially cover the surface of the fan blade, therein provided a diffuse light source. A section of LEDs 838 are shown by way of a lighting bar incorporating discrete LEDs 840, such as down through the center of fan blade 832. It is preferably that these forms of lighting be incorporated on the fan blade without substantially disrupting the airflow of the moving fan, such as flush to the surface of blade 832.

### Method and Apparatus for Providing Non-Attended Product Samples

8.1 Description

To allow distributing samples of various products, such as food samples, without the need of a representative at the location. The invention allows various product samples to be distributed according to limits without the need of an attendant.

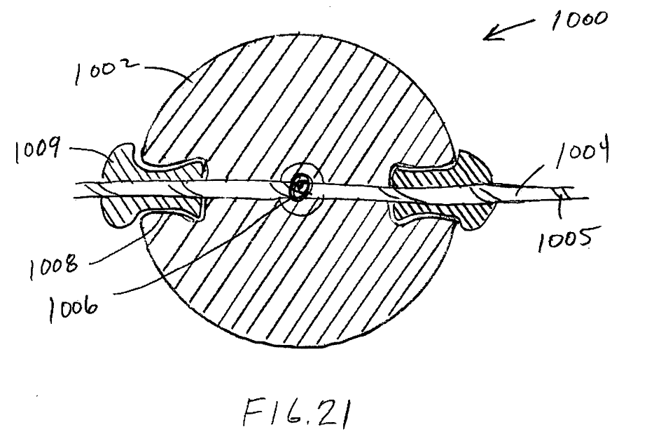

FIG. 20 illustrates by way of example an embodiment 900 of the sample distribution device. A housing 902 is shown for retaining a sufficient quantity of samples, such as to last until the next visit by the service person which stocks the device. The housing is configured to retain a number of sealed packages 904, one package 906 of which is in the process of being dispensed to a user (not shown).

A mechanism 908 coupled to controller 910 performs the dispensing of the packages and is configured to prevent users from obtaining a package unless controller 910 activates dispensement through mechanism 908. Controller 910 is configured for timing the time period between dispensement, thus providing a first limit on product uptake. In one embodiment a biometric scanning device 914 is attached to controller 910 for controlling the dispensing of samples to substantially unique individuals, that is preventing the same individual from obtaining multiple samples. A fingerprint for example is tested for a unique pattern against other recently received fingerprints. A button is labeled, such as “press here to obtain a sample”, which contains the fingerprint sense head. The fingerprints need only be checked against recent fingerprint activity, and the accuracy need not be anywhere near what is required for security application, therein allowing the use of simplified detectors and control firmware.

The invention may be described in a number of alternative ways, including the following. A hierarchical ordering of clauses below indicating an associative relationship therein. A method of automatically providing product samples to customers, comprising: (a) packaging a small portion of the product in a sealed container; (b) configuring said sealed container for being readily manually opened by said consumer and utilized in a substantially spill-free manner; and (c) retaining a plurality of said sealed containers within a housing; (d) configuring said housing to allow a limited number of product samples to be removed by a consumer for sampling.

The invention further comprising a means of identifying unique customers to limit the number of packages being delivered to each given individual.

Wherein said means comprises a biometric identifier selected from the group of biometric identifiers consisting essentially of fingerprint scanning, vein scanning on a particular body part (i.e. back of the hand), iris scanning, voiceprint detection, detecting pressure patterns on the feet of the user (i.e. tread patterns, size and weight distribution). It should be appreciated that the user need not be exactly determined as is necessary for security applications, only that there generally be a difference between any two individual that may want to get a sample within an interval of time spanning for example 15 minutes to 30 minutes.

The invention further comprising configuring said housing so that a predetermined number of samples may be removed from said container over a given time period.

Wherein the time required to perform dispensing of the sample limits distribution.

The invention further comprising detecting when samples are being retrieved at an excessive rate and generating an alertive signal.

Wherein said generating of an alertive signal comprises generating an audio alert of sufficient volume to summon an employee at the given establishment that is utilizing the automated product sampling.

The invention further comprising configuring said housing so that a predetermined number of samples may be removed from said container in response to detecting that a different consumer is attempting to remove samples from said housing.

Wherein said small portion of a food product is packaged in a small tear open plastic pouch.

Wherein said small portion of a food product is packaged in a small container having a lid that may be removed from said container to access the food product sample.

Wherein said small portion of a food product is packaged in a small container comprising a wrapper surrounding said food product sample.

Wherein said lid comprises a lid attached over an open surface of said container and configured to be pealed from said container to access the food product contents of the container.

Wherein said housing is configured for controlled dispensing of a predetermined number of samples without the services of one or more persons for regulating sample distribution.

The invention further comprising collecting said containers as waste from a consumer, after full or partial consumption of the contents of said container.

The invention further comprising tracking the number of samples removed from said apparatus.

Wherein said circuit records information about the distribution of said product samples.

The invention further comprising collecting responsive feedback from said user after dispensing one or more samples.

The invention further comprising displaying advertising graphics associated with said apparatus for getting the attention of a consumer.

The invention further comprising locating said housing at a location wherein the limited reach of a small child will be insufficient for dispensing a product sample from said housing.

The invention also being described as an apparatus for automatically distributing food product samples, comprising:

a sealed container within which is retained a small quantity of liquid or solid material to be sampled by an interested consumer;

a housing within which a plurality of said sealed containers may be removably retained; and

means for limiting the removal of samples from said housing.

Wherein said sealed container comprises a sealed tear-open envelope within which a product sample is retained.

Wherein said tear-open envelope comprises two sections of plastic material joined to one another at a seam which retains a quantity of sample material within said envelope.

Wherein said sealed container comprises a sealed rigid or semi-rigid container.

Wherein said sealed rigid or semi-rigid container comprises: a container structure formed with an open reservoir into which a sample of the product may be retained; and a lid sealed over said open reservoir and configured for removal by said consumer.

Wherein said means for limiting the removal of samples from said housing comprises a product sample retainer element configured to allow a predetermined number of samples to be disengaged from said retainer in response to a manipulation by a consumer.

Wherein said manipulation comprises the physical movement and manipulation of the product sample itself from said retainer element.

Wherein said physical movement comprises grasping a protruding product sample and applying sufficient force to remove said sample from said sample retainer element.

Wherein said physical movement comprises activating a manual or automated mechanism that dispenses a predetermined number of said samples.

Wherein said means for limiting the removal of samples from said housing comprises a dispenser configured for dispensing a predetermined quantity of product samples in response to an activation command received manually or electronically.

The invention further comprising means for collecting user feedback about said product sample.

Wherein said means for collecting user feedback is configured to collect user feedback subsequent to the dispensing of a product sample.

Wherein a predetermined amount of user feedback is required prior to dispensing of said samples.

Wherein said users are qualified as prospects prior to receipt of said product sample.

Wherein said qualification as a prospect comprises responding to one or more questions.

Wherein said means for collecting user feedback comprises switches configured for operation in conjunction with visual or audible cues.

Wherein said means for collecting user feedback comprises a microphone and audio recording circuit for use in conjunction with visual or audible cues.

Wherein said means for collecting user feedback comprises an input device for collecting written comments.

Wherein said input device for collecting written comments comprises planar material which may be written upon, a writing implement, and a repository for said planar writing material.

Wherein said input device for collecting written comments comprises an electronic writing capture device configured for collecting user comments and other information.

Wherein said visual or audible cues comprise questions regarding said product.

The invention further comprising means for communicating the collecting user feedback about said product sample to a remote location.

Wherein said means for communicating comprises a wired or wireless network connection configured for directing consumer feedback for analysis.

Wherein said consumer feedback is directed to a manufacturer, representative, or distributor.

The invention further comprising means for distinguishing between consumers so that product sample distribution may be limited toward each consumer.

Wherein said means of distinguishing between consumer comprises a biometric identification assembly.

Wherein said biometric identification assembly comprises an electronic circuit configured for registering a biometric identifier selected from the group of biometric identifiers consisting of fingerprints, voice prints, optical position sensing, image prints, thermal position sensing, thermal signatures, retina scans, breath analysis, weight, and combinations thereof.

### AutoCSLimit—Methods of Use

Incorporated herein by reference:

Regular utility application, docket number “AutoCSLimit” application Ser. No. 10/431,064 filed May 3, 2003.

9.1 Description

This describes additional aspects of the automatic charge card soft limit system as described within the parent application.

### 9.1.1 Concierge Limit Service, Limit Regulator

The soft limit service can be implemented by separate banks having different use plans: (1) as added feature without added incentive to use, (2) as feature with incentive (usage confers a bonus $%, gifts, miles, etc.), (3) use is required with issuance (limit peaks must be manually set above the base level charge limit).

### 9.1.2 Activating Soft Limit Feature from Varied Devices

A PDA, cellular phone, computer, or other programmable device capable of communicating over a network (i.e. phone network, or Internet) can be configured to generate a “limit bump” in response to a particular pattern being entered on the device. The “limit bump” can thereby be initiated by the consumer very conveniently. It is preferred that initiating an automatic limit bump be authorized in some manner, such as entry of a PIN code, biometric identification, or performing some hidden task on a personal assistance device or other electronics.

For example, on a PDA with a limit bump program the user selects the icon and then enters a password string for bumping the limit, (or a particular non-obvious sequence associated with the program or icon) the amount of the bump may be additionally entered to allow full user control and to optimally reduce exposure to fraud to just the amount required for a given transaction.

### 9.1.3 Using a Separate Cardholder Database

As an alternative to altering the centralized VISA database, decentralized MasterCard database, or database of similar card association or corporation, a separate database may be retained with the cardholder charge limits. It may be desirable to set the limit on a per transaction basis, rather than on a daily transaction basis, as this would not require synchronization of information, only subjecting the prospective charge to scrutiny according to the soft limits.

### 9.1.4 Identifying Cardholder

In the parent application the enhancement includes: finding cardholder account by phone number from which calling, if unambiguous then can go directly to taking PIN number perhaps with an extra digit code for security, or a query to be sure it is the correct person. No need to have them enter account number, although they can read it from their cards.

### Optical Meat Thermometer—Enhancements

Incorporated herein by reference, application describing a color sensing cooking probe, docket “KeyboardRAST070103” application Ser. No. 10/612,777 filed Jul. 1, 2003; and associated provisional patent application No. 60/394,160 filed Jul. 1, 2002.

10.1 Description

The optical meat thermometer incorporated herein by reference allows for collecting optical information about the relative “done-ness” of an item being cooked without delays associated with temperature sensors. A number of additional aspects of the invention are described below.

Temp sensing along probe. The optical probe tips can incorporate temperature sensors along the length of the probe. The temperature signals are registered and may be annunciated upon a display such as showing a temperature graph along the probe length. Alternatively, peak, minimum, average, or other forms of readings may be extracted from the probe information.

An embodiment of the device can be created in which the a controller within the device determine the suitability of the temperature of the heat source (i.e. too fast or too slow) as based on the color profile developing and the registered temperatures. The device can be placed in position near the cooking surface to register the temperature profile provided by the cooking surface. The tips can be configured for measuring grill temperature, while the sides can register the heat emanating from the cooking surface.

The device can be configured to operate based on programmed profiles for determining cooking times per side, overall time, temperature of heat source, and so forth.

The device can be configured to factor in post grill heating and displaying a color shift that substantially estimates the final color based on conditions.

The device can be configured with a temperature probe at the tip configured for registering heat source temperature.

The device can be configured so that the color probe extends from a heat source for continued monitoring of meat temperature and/or color.

The device can be configured with a tenderness gauge—optional gauge in the handle that registers the amount of force required to insert a color and/or temperature probe into the meat.

The device can be configured with an electronic ink display for recording information about a series of profiles during cooking.

The device can be configured with chemical sensors configured to automatically register the type of meat into which the probe has been inserted.

### HBLite—Preventing Unwanted Alerts

Incorporated herein by reference:

Regular utility application describing a color sensing cooking probe, docket “HardBLight” application Ser. No. 09/730,327 filed Dec. 5, 2000; and associated provisional patent application No. 60/153,084; filed Sep. 9, 1999;

Regular utility application docket “Display_RAST092303” application Ser. No. 10/670,432 filed Sep. 23, 2003; and associated provisional application No. 60/413,199 filed Sep. 23, 2002.

11.1 Description

Aspects of the parent application are described which prevent the hard braking anti-collision units from generating spurious alerts. In this embodiment, after generating a hard braking alert, the transmitter units are configured to go idle for a period of from approximately 2 S to 12 S to limit spurious (annoying) alerts from the unit, that is unless higher priority alerts are generated. In this way the alert rate that can be generated by the device is limited. Furthermore, the system can provide the user with a parameter so that they can set the number of alerts that are allowed per unit of time, or other metrics for controlling the extent of alert generation by the units. It should be appreciated that both the transmitter and receiver can similarly limit the rate of transmissions and the generation of annunciations, respectively.

### HBLite—AutoAccBrake—Automatic Braking based on Accel. Sensing

Incorporated herein by reference:

Regular utility application describing a color sensing cooking probe, docket “HardBLight” application Ser. No. 09/730,327 filed Dec. 5, 2000; and associated provisional patent application No. 60/153,084; filed Sep. 9, 1999;

Regular utility application docket “Display_RAST092303” application Ser. No. 10/670,432 filed Sep. 23, 2003; and associated provisional application No. 60/413,199 filed Sep. 23, 2002.

12.1 Background

Often it is difficult to properly apply braking during certain maneuvers, such as downshifting, working both the accelerator and braking, and so forth. Current braking systems require full-time manual control to be maintained in an active “drag inducing” state.

12.2 Description

To increase and simplify deceleration maneuvers within a conventional vehicle or racing vehicle. The present invention allows for automatic activation of braking based on detected vehicle conditions, such as downshifting, or other forms of intended deceleration. Automatically activate braking in response to sensing deceleration, such as detected by deceleration along with downshifting, wherein the user can work the accelerator and shifting, while not needing to be “on the brake” the whole time. The system operates in the background wherein the operator may not be aware of operation yet only find deceleration related operations to be easier to perform.

The system may be configured to augment traditional braking control or as a feature within a braking control system. As such, the system may be incorporated within a vehicle control system, such as a braking controller, ABS system, or similar, or configured in a separate controller.

The brakes may also be set to engage to a desired level of “background braking” in response to sensing that the operator has let off the accelerator while the vehicle is traveling beyond a give rate of speed. Therein quickly letting off of the accelerator constitutes a condition under which some braking is temporarily applied by the system. This speeds the transition between deceleration and braking and compensates for a number of situations. It should be appreciated that this feature and a number of others are applicable to both automatic transmissions and manual transmission vehicles.

It should be recognized that due to aerodynamic drag, and other drag sources, increasing amounts of accelerator pedal activation are required to maintain a given speed. For example, when traveling at 75 mph on the freeway the accelerator pedal will be depressed more than when traveling at 55 mph. It will be appreciated then that fluctuations from this “cruise” setting of acceleration indicate desired actions of the driver to either slow or speed up depending on whether the pedal is released or depressed further.

The increased pressure for generating acceleration can be readily detected in response to the movement of the mechanical link, and a number of newer automobiles are using “drive-by-wire” type controls in which the accelerator, brake, and other linkages are sensed electronically and not by a mechanical linkage, therein further simplifying incorporation of the feature. However, the present systems do not detect the release of the accelerator as signaling that the user wishes to slow down.

The amount of braking action induced by the system is preferably in relation to vehicle speed, as it will be appreciated that different levels of braking are required at different rates of speed to create a given level of deceleration. The system preferably smoothly applies braking and then temporarily maintains an amount of braking to make a smooth deceleration in response to the amount the accelerator is being engaged. It should be appreciated that “drive by wire” controls are being incorporated into the next generation of vehicles wherein electronic sensors are coupled to every control such as accelerator pedal, and generally the mechanical linkage to the throttle is completely eliminated and controlled electronically.

It will be appreciated that during low speed operations, such as in a parking lot (i.e. less than 20 mph) that the vehicle has little inertia and thus little need for background braking. However, at higher speeds a vehicle, in particular those with automatic transmissions continue to coast at the same speed when the accelerator pedal is released. The present invention can increase the amount of background braking in response to the amount that the accelerator pedal has been let up. In this way the driver can control their speed within a larger range of accelerations and decelerations by the amount of pressure applied to the accelerator pedal without needing to be continually pressing the brake pedal.

An optional selector can allow the user to set the amount of desired background braking. The may turn the unit off or select any amount of desired background braking.

An optional indicator may be utilized to indicate to the user that braking is being applied as they let off the gas. For example a haptic feedback unit may be coupled to the accelerator pedal (or steering wheel or other location capable of alerting the driver) which vibrates in response to the amount of background braking being initiated in response to the pedal motion and other variables, such as vehicle speed, cornering and other conditions. Alternatively, an optical and/or audio indicator may be utilized.

Preferably the control system and actuator are configured to increase braking, but so that should the system fail the brakes will operate conventionally. In this way failure of the system can not lead to loss of normal braking.

### 12.2.1 Additional Aspects of Hard Braking

Peak detect braking—the brake automatically can retain a given level of braking once activated without a continued level of brake pressure. The user can press the brake and it will remain with that level of braking for at least a give time period or until another action over-rides the setting. Over-riding actions may comprise: pressing the accelerator, pressing harder on the brake, shifting, clutching. These actions may arise over all conditions or be selective to given speeds, accelerations, and so forth.

The present invention may be described as a system for automatically applying vehicle braking, comprising: (a) means for sensing desired levels of deceleration; and (b) means for activating a desired level of braking in response to said desired level of deceleration.

Wherein said means for sensing comprises a deceleration sensing device.

Wherein said deceleration sensing device senses changes in vehicle deceleration.

Wherein said deceleration sensing device is coupled to said accelerator to sense changes in applied accelerator pressure.

Wherein said deceleration sensing device senses gear shifting activity within said vehicle.

Wherein said means for activating a desired level of braking can comprise: (a) an actuator coupled to the brakes of a vehicle; and (b) a control system configured for receiving a signal from said means for sensing a desired level of deceleration.

### iDose—Detailing Aspects of Invention

Incorporated herein by reference:

Regular patent application docket “iDose” application Ser. No. 10/009,041 filed Nov. 8, 2001;

PCT Application PCT/US00/35048 filed Dec. 22, 2000; and related provisional patent applications Ser. No. 60/176,961 filed Jan. 18, 2000, and Ser. No. 60/172,057 filed Dec. 23, 1999.

13.1 Description

Aspects are detailed which related to the iDose parent application pending in the US and foreign countries. The iDose system may be setup by a MS (Medication and Supplement) distributor in a number of ways depending the levels and types of services they wish to fulfill. In addition, there are often a number of ways in which a feature within the invention may be implemented. The specification lists a large number of these preferred and/or optional aspects of the system. It should be appreciated that the invention may be practiced with or without these aspects separately and using these aspects in various combinations, without departing from the present invention.

The term interaction may be utilized generically to include possible interactions, possible side effects, and possible contraindications for a given MS. For brevity, the term possible interaction or possible adverse effects are often mentioned to refer to these general types of adverse reactions.

### 13.1.1 System Access

Provide other methods of accessing the system and joint partnering between the fulfillment company and the other companies.

Distributing iDoses. The fulfillment company can charge retail establishments for fulfilling iDose medication and supplement orders, in this way the price of the fulfillment systems are leveraged across an industry. Labels from the retailer can be placed on the boxes of custom prepackaged doses as they are drop shipped from the fulfillment center. The customer is only aware that they ordered from the retailer and apparently received packages from the retailer.

Joint Fulfillment use. The comdav can be adapted to run over portions of a fulfillment area which are allotted to different, or specific retailers. The retailers could be provided space in the fulfillment center for their specific types of supplements. Flat fees could be charged for space used, fees per dose dispensed with monthly minimums, or other arrangements.

iDose Fulfillment Association. On-line retailers, Store-front retailers, drug store chains, and the like may be charged an up front association fee. Membership in the association being required prior to the organizations ordering iDose for their patrons through the system. The money can be used for initially setting up the iDose system. First round of participants is limited and those that sign up get preferred terms, such as getting special discounts on fulfillment for a period of time to recoup some of their association cost. The money from later entrants can be used to enhance or extend the system.

Slotting fees. Slotting Fees may be charged to supplement manufacturers that want their items to be sold within the system, not enough space to carry all brands—this can simplify determining which brands to carry?

Kiosks. Kiosks (use book-view drawings of it) may be put at retail locations such as groceries, drug stores, discount stores, health food stores, and the like allowing users to order prepackaged pills instead of the conventional bottles. It is preferred that the systems would facilitate logging on by the patron, such as by using a card, identifier (i.e. PIN) or a biometric input unit (fingerprint). For example, users sign on by fingerprint and their dose pattern is shown on the screen, wherein they may make changes to the account.

The pre-packaged doses can then be sent to the establishment for pickup and payment by the individual. The store thereby makes their profits and keeps the individual coming back to the store for other purchases. This also prevents the distributor from competing with the retailers.

MS Card (Health Card). User pill information and health related data can be stored on a card device, such as a smart card, wherein they need not be worried about their information being made available over the internet, and to otherwise facilitate privacy.

### 13.1.2 Revenue Sharing and Partnering with iDose

Link other health systems to iDose. (1) for providing information about MS, wherein a person browsing another health site can ask a question of the iDose system. This form of free link provides info to patients leveraging the database of iDose, while allowing a means to connect to a new patron. In exchange for the service a link to iDose is made available, preferably along with an advertisement for the individualized dosing packets. (2) Orders may be placed through the other health site which may utilize iDose as a fulfillment center of sorts, in this case the revenue can be shared with the site generating the order or referral.

Partnering with Drugstores, Health Stores, Superstores. The drugstore or other chain can be the intermediary, wherein the user can select dosing on the system with data stored in the computer and/or on a smart card or other device that may be used with the iDose system. The user can then pay for the iDose pills and any fill ins they may want until the shipment arrives. The user can get the pills by picking them up at the drugstore pharmacy. The marketing of iDose may allow them to do this without paying a shipping charge. Partner should carry bulk MS for fill-in.

### 13.1.3 User Interface

Health Dashboard. The interface to iDose can be a part of a “health dashboard” that allows the user to manage a number of aspects of health within an integrated environment. The software for the dashboard preferably utilizes the underlying health data for the individual (preferably with their permission) for providing help in a number of different health areas. Besides ordering their doses, the customer can get information in their conditions, on interactions, timely bulletins relating to their specific health needs and concerns. They can set up an agent to collect information, or new news about their condition. They can handle insurance related issues. They can investigate new treatments.

As a business model the health dashboard may be provided for free to anyone, as this gets them used to the system and they will at some time be ready to order doses the modern way—in iDose packets. Even if they are not buying packets they will generally be looking at screen that may contain advertising and visiting associated health related sites.

### 13.1.4 Ordering

Ordering based on Dose Profiles. The iDose system preferably allows users to select from prefilled dose profiles, when initially setting up their accounts. Preferably this is done by entering information about themselves and their health concerns. For example: age, sex, weight, lifestyle, conditions (problems), health benefits sought, and so forth. The system pulls up a generic list as a template.

The system can optionally generate the suggested list as a incremental set of templates wherein the user is started on a simple set of doses having few possible problems with interactions, side effects and so forth. Then they can select some the other suggested items on the template as they see fit.

Incremental Dose Schedule Expansion from Templates. It is preferred that individuals build up their dose taking incrementally, wherein they are less subject to serious side effects, and if they arise it is easier to determine the cause. The system may encourage or limit their initial ordering unless they indicate that they have previously been taking the MS. For example, a user transferring from bottles has used the supplements before, but the system has no record of it. Therefore, the system can prompt the user to determine if they had previously taken the MS.

Adding new items to dose list. Rather than waiting for next order arrives (i.e. if monthly orders) can get “fill-in” pills right away that will take you till the next set of packets arrives with the new pills filled in.

Variation: Partnering with the drugstores and other chains, the system is configured to take the order and have the user can pick up the fill in pills right at the location and have the item added to the next set of doses. Cost for one or both being paid for at the drugstore.

Accommodating Use of “Leftovers”. They may reuse these doses by “nulling” any doses within a set for which they wish to use the “MS leftovers”. They may use them on same date in next month, at the beginning of the month, the end of the month or however they choose. The system may just leave the designated pill packets from the set of pill packets. The system is configured, however, to provide “blank packs” which indicate the user choice of filling these from remaining MS. One embodiment is a same size packet, but empty and indicating that user selected to fill with “left overs”. Another embodiment includes a small segment between connected packets in which the information about user selected left overs is printed. Also, if doses are not strung together then the “left over” label may be placed in another manner.

Ordering by benefit/complaint. Rather than directly selecting the supplements, the user can list desired benefits or the symptoms being sought to be cured. The system can then provide information on the classes of MS that MAY provide the solution. The user can then select from these items, based on information available, although system will direct them to speak with doctor or pharmacist.

Variable Dosing. Clinical studies have shown that in many situations a condition may be more readily or safely treated by varying the dose levels during the treatment regime. With “bottle-based” dosing this has been difficult to administer die to packaging constraints and the unknowns involving how closely the patient may adhere to the schedule. The problems with execution are such that doses are almost always given in a simple flat-form dosing schedule (i.e. taking 25 mg of medicine YYY every 8 hours). The present system allows practitioners, (or individuals with non-prescription MS) to select variable dosing levels to maximize beneficial effects. Depending on the range of dose sizes available, or based on quantity used of smaller doses, a curve may be established for the dosing pattern to follow. The doses are then packetized accordingly by the system according with the selected profile. This feature may be charged as an additional cost to the consumer as it does require slightly more overhead. The fact that the user receives strings of doses for being taken on specific days can greatly improve the conformance with the regime while simplifying the process for the individual. “Ramp” Dosing. The strength of new MS pills to be taken may also be “ramped” from one level (i.e. none taken) up to the desired level to prevent severe reactions. If a new MS is to be taken then into the doses, wherein the initial doses are small to assure that the user does not have a strong adverse reaction before the higher level doses are taken. The system can recommend this for any new MS to be taken based on the characteristics of the new MS (possible adverse reactions) and the availability of lower level dosing within the system.

Marking New MS. The packetizing system can mark any selected pill or pills within a given dose so that it can be readily identified by the user. For example, a new pill added to the doses can be marked, wherein the user could readily know to stop taking that item should a reaction to the doses occur after having added that new items to the doses. The marking comprises an edible form of marking such as vegetable dies, sugar pastes or vegetable pastes, and so forth. The pills may be also be segmented into a separate portion of the packet for easy identification.

First use. When a MS is first used the chance of having a reaction to it are increased. A preferred aspect of the system that may be optionally adopted by a given distributor, is to ask if the user has taken the given MS previously. If not, and the MS has a reasonable probability of causing certain effects then the user should mark their consent of taking this slight risk before system allows issuing MS. System can also suggest that the user take a couple of sample doses to determine if any side effects arise before taking these regularly.

Manufacturer Sample Distribution. The system is preferably configured to allow manufacturers to distribute free or low cost sample sets of MS, other than those requiring a prescription. The available samples may be listed by type of condition, or type of sample. The system can add the set of samples, such as a week of samples, to the doses collected. It should be made clear that the samples are just for screening if any adverse reactions may arise, before committing to buying quantities of the MS. On the user's next order the system will prompt them for adding the new item to the dose packet in this next order. They can also elect to add the new doses to their next order at the time of ordering the sample barring them finding problems and then deselecting this MS next time.

Shipping Charges. A number of models can be created for covering the shipping and handling charges. For example: Shipping free for orders of at least $X/month being ordered. Shipping free after Xth month of orders and thereafter. Shipping free for first X months (encourage people to sign up). If the iDose packet string is distributed through a chain, such as drugstore, then it is preferable that no charge for shipping would be assessed.

Buddy-check system. System is configured to provide temporary passwords and a note taking scratchpad. The user can allow someone else to peruse their medical database and make notes for the user. When using the temporary password the person is not allowed to make changes to the dosing and pills which were selected by the user. The temporary passwords are preferably good for a limited period of time, such as one week, and a given number of accesses, such as three.

Pill Ordering Activation States. System is configured to allow the status of pills in selected doses to be changed between “Active” and “Passive” states. In this way the user can temporarily suspend ordering of certain medicines and supplements without deleting the items from the dosing schedule. They can switch between “Active” and “Passive” states or delete the selected pills.

Dosing suggestions. “Suggested” state: System is configured to allow pills to be entered into the dosing schedule in a “suggested state”, which does not result in ordering the pills, but is easy for the user to view. A comment field associated with the suggestions allow the person making the suggestion (or the user themselves) to note why the suggestion was made. The user can change the state to “Active” when desired, just as between the “Active” and “Static” states as described above.

### 13.1.5 Pill Packet Variations

Segmented Packets. Segment sections of package that contain controlled medications, these can then be readily identified in case the Rx has changed, and they should no longer be taken. A heated bar can come down to segment the item into a portion of the packet. The area over that section should be marked with a description of the item.

Packets in short strips. Send pill packets in strips (instead of a reel) so that may be sent as a flat pack at a low cost. Can be sent by 2-day mail for $3.95 or less for other approaches. With a single dose per day, a series of four strips, each containing seven packets, along with a short strip of a few packets covers the whole month. Two doses a day requires doubling the number of packets, and so forth. The user can be given the option of packaging choice, and shipping cost may be affected.

Mark pill contents per packet. Each pill within a packet may be marked on the packet, such as on the back. This may be most useful when strong medications are involved. To fit the information on the package it can be printed with small pitch, a foldout, or other form. Also separate small codes numbers can be listed which can be looked up on iDose to match the item contained therein. Color codes can be used to identify the type of MS that item falls into, such as red text to indicate a strong medication.

Interaction/side effect list printed with each order. The checked off “possible interactions and side effects” may be indicated on a print out to remind the user of what they have been warned of.

Custom time frames. Some users may want doses sent more often than once a month, for example if money is not a concern or they want to change their MS requirements often. Thereby the system is configured to allow the user to select a shorter intervals, such as two weeks, a week, or other intervals over which doses are collected and sent out to them.

### 13.1.6 Packaging of Pills Used in the System

Pill package changes. To facilitate use in the system the forms of pill packaging may be altered, such as to speed automatic dispensing, to reduce the size (for easier pill taking), to prevent unwanted effects of humidity, to increase the ability to recognize the pills, and so forth.

Examples: exterior of gel pills, such as Vitamin E, may be coated with a matted surface, such as sugar or cornstarch coating, or similar, to prevent them from sticking. The exterior may include a labeling, such as a bar code or color code. These bar codes and color codes need not be visible to the user, as they may be made very small or be based on ultraviolet optical effects. For instance a marking may be utilized with bands of UV reflective inks that reflect at different UV bands, these color codes are more effective than bar codes, in that each bar can represent a number of states by virtue of its optical reflective properties, such as 8, 10, 16, and so forth.

Making the pills smaller (although pill takers may be initially resistant) makes it easier to take the pills while it allows the system to minimize the number of sizes that must be carried. For example, consider Vitamin E having standard doses of 400, 800, 1000, 1500, 2000 IU. It will be appreciated that the carrying only the 400 IU doses allows all forms to be generally filled without the need to carry many sizes. In pill form the large dose sizes are preferred in that user must otherwise collect more separate doses, but with the iDose system the user need only take the precollected dose. Since the smaller pills are easier to swallow, to store in a pill repository, and to retain in a package they would be the sizes of choice. The system should even encourage the use of standard sizes to reduce the demand for off-size pills.

Marking Select Pills. The packetizing system can mark any selected pill or pills within a given dose so that it can be readily identified by the user. For example, a new pill added to the doses can be marked, wherein the user could readily know to stop taking that item should a reaction to the doses occur after having added that new items to the doses. The marking comprises an edible form of marking such as vegetable dies, sugar pastes or vegetable pastes, and so forth. The pills may be also be segmented into a separate portion of the packet for easy identification. The pills may be marked or segmented for any reason wherein it would be beneficial to be able to identify the given item.

Resealable Packets, Extra Resealable Packets. To facilitate user adding of MS to the pill packets the system can be configured to allow users to select “resealable” packets for their pills, although this may require an additional charge.

Alternatively, a user phasing over to iDose can elect to get a set of seven resealable packets (i.e. small zip lock bags with M, W, Tues, W, Th, Fri, Sat, Sun) in which they may place the packet along with any extra MS needed. If they setup for 2×doses per day, then they get bags for each dose (i.e. Mon. AM, Mon. PM).

Coding the Packets. Each packet may be configured with a readable code, such as bar code, text (i.e. ID numbers), color coding, smart tag, and so forth, wherein the packet use may be checked against the computer at the time of taking the medication. For example, assuming a bar code is printed by the system on each packet which contains patient ID number and/or name. Prior to the dose being taken the nurse wands the patient ID on the wall, chart, or bed, and then wands the pill packet. This records that the correct medication went to the given patient and prevents these types of errors.

Correlating packet code with wrist band. A bar code, transponder, or other machine readable indicia is incorporated within the wrist band (or leg band or ID in other location) wherein the bar code or transponder on the pill packet is checked for a match prior to the MS being given to the patient.

Correlating packet codes with a biometric. The system also preferably provides for gathering biometric patient information. It will be noted that patients may be changed from one room to another or bed, wherein the chart, bracelet, or other ID may be improper. However, the biometric remains true despite all of these situations. The biometric may be a fingerprint, iris scan, and so forth.

### 13.1.7 Interaction/Side Effect/Contraindication Checking

High Impact Interactions—Blocking fulfillment. In some cases the probability of an interaction may be so high that fulfilling the selected doses by the system would not be prudent. Also side effects for a given MS in relation to known patient conditions, (MS may be contraindicated) may increase risk of taking particular MS. Therefore the system is configured to handle the situation in two ways. (1) Require a doctor to OK the conflicting selections. The system is configured as described elsewhere in the specification, to allow a doctor, or other health care provider, to review the MS being taken by a patient. After signing on the practitioner can check the list of MS with the highlighted interaction, or possible side effect, problem—they can then OK that the patient is allowed to take this combination, wherein the system thereafter allows this combination for the patient. (2) Suggests alternatives to one or the other MS from which a severe interaction/side effect probability exists. (3) Block fulfillment of the order with the problematic selections.

Care taker Oversight. Many individuals can benefit from having all dosing being overseen. This is true on the case of: (a) those with complex medications or conditions, (b) those with mental limitation (i.e. Alzheimer's, senility, mentally handicapped). (c) those that want to maximize the benefits of a health program and want more supervision.

Automatic Patient State Checker. It may be beneficial to prevent users that are permanently or temporarily in an unfit mental state to order MS. The system preferably provides the option to test the user at the time of initially signing up for the services, and perhaps a shorter test at the time that changes are made to the doses. The testing may be additionally, or alternately, provided if the user chooses to ignore particular medium levels of dose interaction. The test may be require then to think a little and answer questions within a specified time, such as addition, or geography and so forth. The tests may also require following of directions on the screen, screen manipulatives, logic, memory, and so forth. The types and depth of testing to be determined by the company setting up the iDose system. This can prevent children or mentally incapacitated individuals from ordering MS without supervision, or ordering MS by bypassing known possible interactions, side effects, or contraindications listed by the system. The system in these cases can collect information about the patients doctor, such as email and perhaps a patient code and doctor oversight code, wherein the doctor (or other caregiver) can be automatically contacted and review the situation.

Outside MS. At the option of the company setting up the site, the web sites for ordering individualized doses according to the invention may be configured for allowing entry of outside supplements and medications, for the sake of record keeping and interaction, side effect, checking. Preferred to allow them to record purchases of quantity and rate of taking outside supplements, wherein ordering alerts provided. This is particularly useful of the item is not available (i.e. medicine), or is not in a pill form, or is not a regularly taken item (aspirin). Can provide extended service and increase safety.

Phasing in options. System is configured to allow the user to start a particular MS at any date within the interval. This allows a user with existing supplies of MS to use them up in conjunction with the pill packets. The user would be required to take the extra pills in concert with the contents of a pill packet. The system can allow the user to specify that the packets are resealable, wherein they may manually insert these remaining MS within the packets. Alternatively, a set of small resealable bags (i.e. one week) can be sent with the order so that user can place packet and separate pills into the dose package.

Find Effects. If the user is experiencing unexpected symptoms from the doses, then they can enter those into the system for historical tracking and for finding information along those lines. They can enter information about the symptoms, such as when they occur (time—morning, day, night; symptom—drowsy, insomnia, upset stomach, irritable, heart racing, etc.) The system software then check the symptoms in relation to the doses being taken, wherein it can determine which doses may be the cause. For example, suppose user ignores the warning about taking Ginseng supplements in their late night dose and was experiencing insomnia. The system could readily determine this an indicate that this may be the cause of the insomnia. The system utilizes expert system programming, heuristics, neural programming or combinations thereof for correlating the effects with the information in the database about the MS being taken, the combinations thereof, and the possible interactions, side effects, and symptoms.

Release of Liability. Require user to check off a “Release” button for each possible interaction, possible side effect, or other caution that is generated for a given batch of pill packets, in this way the user has been informed of the possible interactions, possible side effects, and has agreed not to hold the fulfillment system or manufacturer liable for their choice. This can be part of a general agreement signed with each order. This is similar to the licensing agreement signed by users of software, but it lists the new possible interactions, and possible side effects/contraindications, for the chosen MS wherein the user must check off each possible interaction or group of them so that it is known they have agreed to taking that risk.

A possible interaction/side effect/contraindication once mentioned need not be repeated each time, but only when new possible interactions arise, if new medical conditions entered for the person, and on a periodic basis as a reminder (the system lets them select the remind interval, so their can be no complaint of not being reminded often enough).

Hospitals or other care facilities, the system checks the new MS against (1) previous items taken to determine if the new drug is consistent with the diagnosis and past history, (2) check patient history for previous interaction, contraindications with condition and so forth. If these occur then the system flags the MS for an administrator, or doctor, to look into and indicate that the condition has been checked into. The iDose provides a centerpoint for collecting and checking this information.

### 13.1.8 Aids in Selecting Appropriate Non-regular Dose Items

It will be appreciated that aside from regular doses of MS, users periodically have a need for other forms of MS, for example analgesics. In many cases the choice of what “over the counter” (OTC) remedy to take is determined by the medical conditions of the individual, the type of MS being taken, the conditions under which the OTC is taken and so forth. The iDose system is preferably configured to make suggestions of these non-regular dosing items based on the information available about the individual such as their medical conditions, and current MS doses being taken. For example, individuals on certain forms of heart medication are cautioned against the use of certain analgesics.

Recommending Non-dose Items. System recommends which of the common OTC items are compatible with their information. The information for each of these may comprise a link to advertising materials for the product or products. These items can be purchased over the internet in bottle form, or outside of the system. This is especially well suited for use with partnering, wherein the user can get this information at the drug store where the information is available.

Screening non-recommended Items. In a similar manner the system is preferably configured to check a non-dose item by the individual against the information about that individual retained in the system. In this case the system can let them know if the product is contraindicated for one or more reasons.

Bar code reading. The system may be optionally configured to receive information from a variety of sources, such as bar code readers. Reading of bar codes allows the system to readily identify bar coded items without the user going through a difficult and confusing selection process. For example, in the above screening of non-dose items, the user could log onto the system (or plug in their card) whereafter they could swipe the items through the bar code scanner. Cautions and contraindications relating to the item can then be displayed to the user, wherein they can feel more comfortable with their choice, or select a different choice of problems are indicated. This mode of the system is particularly well suited for use with partnering.

### 13.1.9 Genetic and Other Human Factors

The possibility of an adverse reaction occurring can be estimated more precisely if additional information is known about the individual, such as their conditions, what other items they are allergic to or react to, body physiology differences, history, and even their genetic makeup. It will be appreciated that a DNA map for the individual may be generated based on a sample of DNA. A number of the patterns within the DNA have been identified with specific conditions and predispositions. This database of information is expected to continue to be expanded.

Assessing interaction/side effect/contraindication probability based on human factors. The additional information optionally provided by the user is utilized for assessing the relative probability of the different interactions, side effects, or contraindications. The system maintains all collected information on the user, at the user's discretion, and compares known information about the MS with this list to increase the accuracy of predicting possible adverse reactions. In this way the ranking of possible adverse reactions can be ordered according to known relationships. Genetic information entered into the system can provide increasing benefit as more genetic related information becomes available to the MS described in the associated database.

Recommending dosing based on human factors. The human factors described above, such as conditions, history of reactions, and genetics are preferably utilized by the system for recommending certain types of MS to the user. The system correlates the conditions and human factors against the MS database and selects possible appropriate MS. As a simple example in an elderly woman with osteoarthritis the system could suggest certain MS, such as iron supplements, Chondriten, and so forth.

### 13.1.10 Dose Checking

Fulfillment Dose Checking. Verifying the correct MS within each dose can be done with cameras, however, a camera is unable to distinguish between different MS that have similar shape and color. To improve the accuracy of checking, the camera scan may be augmented with, or even replaced with, an optical spectroscopic detector.

This unit can direct a beam upon each pill in the dose (prior to packetizing or afterward) wherein the spectrum of the reflected light is indicative of the composition of the pill. In this way different medicines can be distinguished even though they have the same appearance. It still may be preferred to mark each MS in some manner to make it distinguishable by humans, such as coding and the like. Using the spectroscope allows for matching the reflective signature of each pill with a set of expected characteristics. If they do not match then the wrong pill has been selected. This use also catches problems with binning errors on otherwise similarly looking pills.

### 13.1.11 Fulfillment of iDoses

Batch Mode Packetizing. Packetizing machine may be set different volumes of packets (i.e. 10/20/30 pills). If insufficient sizes are simultaneously available, then pill packetizer may be adjusted for a given size, which are then run, then the machine set for another size followed by a run which fulfills those sizes.

Small Scale Conveyance System. The iDose packetizing may be performed on a small scale than indicated, wherein a smaller set of MS would be subject to use within the system. The fulfillment process may also include semi-automatic or even manual elements. For example a small system may require pill bottles emptied into hoppers that make doses, or even the user to drop the pills into separate compartments for which the doses are packaged. The location at which the system is located can sell the MS by quantity, wherein the user need not carry pill bottles in and out, only buy what they need as they have their packets made.

### 13.1.12 Historical Information

Dosage History. (1) System is configured to store a history of each pill packet purchased, with date, dose, composition of packets, cost, and possible interaction/side effect/contraindication information. (The user signoff for possible adverse reactions is also recorded in case a dispute should later arise.) The history is preferably maintained at the discretion of the individual (as some are paranoid about others having any information about them). (2) System allows user to enter any effects of the doses into the history (i.e. drowsy, stomach upset, headaches, insomnia). The iDose can then attempt to correlate the condition with the doses being taken (see Find Effects). (3) User may elect to enter the doses not taken in the last interval to maintain a complete record. (see use of “MS leftovers”).

Accessing Dose History. (1) By date. (2) by particular MS such as showing the history for this given MS. (3) by MS having particular benefits or side effects.

### 13.1.13 Clinical Trials and Similar MS Testing

Clinical Trials Selection. The system can be utilized for overseeing a clinical trial. All patients to be within the trial needing to use their MS from iDose so that the clinicians can monitor what other MS taken, symptoms, and other factors of the trial. Presently each company and/or clinician must establish a number of elements to administer and monitor the tests, wherein the present system allows this to be handles in large measure using the iDose system. The system preferably provides a number of aspects particularly suited for this application.

(1) Fulfillment considerations—Clinician's can set up a bin of trial MS at iDose fulfillment. The system locks out these bins and requires a special key coding to be transmitted for unlocking these, or otherwise allowing the COMDAV to enter into the section of trial bins. User's already on the iDose system are given special information on selecting the trial doses within their pill packets, such as a code and password. New user's may have an account set up by the clinician, with a prescribed set of doses within the bins.

(2) Maintenance—At the discretion of the clinician setting up the trial, the user may be required to enter if and when each dose was taken. Furthermore, they may be required to enter how they are feeling with any symptoms and so forth reported.

(3) Lifestyle Information—Under certain trials the user may be required to enter additional information about diet, activity and so forth. The iDose system allows the clinician to select a template for collecting desired types of information and they can then select the fields desired and the types of information and depth of information required.

(4) Clinician monitoring & communication—before participating in the trial the user preferably must sign that the clinician will have access to these records. Using the system the clinician can then access the data collected for each specific user, and for the group of users. The system also allows them to pass along message and other information to patients separately, per control group, per clinician selected groups, or as a entire group participating in the given trial.

(5) Collecting Data to Aid Health Research. The system is preferably optionally configured to ask users if their MS and health information may be anonymously shared with researchers (not sales companies) to speed research on health issues, such as more readily finding possible side effects, interactions, contraindications, and so forth. The system provides an interface wherein it “depersonalizes” the database information being collected for use by clinicians and researchers.

### 13.1.14 Hospital or Care Facility iDose Aspects

IN-HOUSE iDose fulfillment system. Dispense from an in-house system that can provide doses for this hospital as well as any smaller satellite hospitals that may not have such a system. The doses are collected based on the dosing schedule.

Generating Billing. The iDose system is configured to generate billing information to the hospital, or caretaker, billing system, wherein the doses need not be separately entered, but are automatically recorded and added to the bill as they are collected. Additionally, the connection to insurance company databases can allow certain MS to be paid for by the insurance company.

Hospital Record Maintenance. The iDose system can provide extended functionality to hospitals, and other care facilities. To properly check the doses against the patients taking them to verify the type and quantity of dosing, the system requires information about the patients. This is preferably accessible in patient data files. The system can provide off-line secure backups of this data in the process, wherein data recovery can be facilitated.

Doctor Review of Meds Facilitated. The system provides a single point of access for doctors to more readily check on the Rxs for the patients. The system can generate warnings about the items selected if the don't seem to match previous forms of treatment and the like. The doctor is always the last word on what is to be prescribed, however, this acts as a safety net which flags prescriptions which don't match well with prior treatments, patient's medical condition, patient history of reactions, and so forth.

The doctor is given more peace of mind and more accurate meds result.

Secure Hospital Record Linking. The iDose system needs to access information about patient records, such as dosing schedules, conditions, and so forth. In order to prevent security breaches, the system is preferably configured with at least one software module that runs on the hospital system for performing the checking for interactions, side effects, contraindications, and also for checking the selected MS in relation to patient dose and medical condition history. These checks can't replace doctor care, but are contemplated to reduce oversights significantly. The system running in this mode provides the user interface and the checks and verification of dosing, and is configured to generate dose orders in a simple format to a main repository. (The hospital may later choose to have their own system on a small scale, wherein they can then replace the outgoing interface application with an application that runs the in-house fulfillment system.

By way of example and not of limitation. The hospital is sent software for running iDose in this mode, wherein a customizable user interface is provided, or a set of API style calls to underlying actions, and a set of routines for performing the various forms of checking and so forth. The interface may be customized to suit their existing systems and interfacing. The routines that analyze the dosing data in relation to the patient records is customizable to their existing database, wherein it can query to retrieve an necessary information. The order fulfillment process routines can be linked directly into hospital billing routines, wherein the charges are automatically accumulated for each patient. The additional features, such as dose history and the like also link into the client hospital (or care facility) wherein they can collect the desired information in a similar manner as described previously for users over the Internet.

### 13.1.15 Small Packetizing Systems

Small Scale Packetizing. To provide a small packetizing system for health food store use and similar applications allowing small volume customization of individualized doses.

Primarily directed at the health food store market, or other venues selling supplements, or similar products.

Different configurations, including: (1) One that packetizes based on small set of hoppers electronically dispensed for creating packets, (2) a substantially manual system in which doses are manually dispensed into compartments that represent the doses to be packetized.

User loaded bins. This device packages pills into plastic dose packages. Customer deposits the contents of each vitamin or prescription pill bottle pill into a separate hopper. The then insert a scan card into the machine that tells the machine how to package and label the packets. Each little scan card contains the “directions” for making one type of packet. (i.e. morning vitamins) Customer would use a card for each different dose. The machine produces little plastic ‘envelopes’ containing the desired doses and labeled for when they are to be taken. With many people now taking numerous vitamins and supplements 3 times a day this machine saves time and space making it more convenient to package your vitamins for the months use. More regular use and simpler dose tracking will lead to increased sales of vitamins and other supplements.

CONSTRUCTION: Consider having 8-10 bins. The plastic envelopes are made from a plastic tube bag on a reel. It is cut and sealed like the seal a meal gadget. The bag is printed on before being cut with a small label printing head. The cards to be read are filled in with a pencil and kept by the customer or kept “on-file” at the store. A packet counter reads out the number of packets created so far. The hoppers should be cleaned out after every use for the sake of cleanliness. Estimated production cost in qty estimated at $400-500. Retail cost then is about $1200-1800.

CUSTOMER USE: Store would write up the customers first dosing card and could let the customer use the machine after that by themselves. Store may provide machine as a free service for supplements purchased on the premises. Alternately the store could charge by the envelope for using the machine. Stores could even setup a monthly “maintenance” contract with customers. The customer then buys their supplements as a monthly supply of various dose packets. This has many advantages: Customer need not keep track of their own supply in numerous pill bottles, store can order pills in bulk, environment is helped by reduction in pill containers, customers would miss fewer doses helping them and the store.

SALES: Lease the machines to the store on a monthly basis. Lease covers the cost of any repairs necessary. Stores pay directly for the bag rolls, ink cartridges, and blank dosing cards. Lease would cost between $80-120/month. For repairs the device is both small and light, it can easily be shipped back when repairs are needed.

FDA: Don't know the ramifications. Some FDA approval should be required as the device will come in contact with food supplements and drugs.

Customer Separated Doses. This level consists primarily of the packetizer, wherein the customer can load a series of compartments, such as on a wheel, that are then loaded into separate packets.

### 13.1.16 OTHER Aspects of the System

Diagnostic Modes. The iDose system contains a health database for performing a number of aspects of the invention. This database may be extended to aid in patient diagnostics comprising one or more of the following:

(1) Connecting to practitioner (or medical staff)−They can get communicate on line, real time or asynchronously, for getting answers to health problems and such. These can be paid consultations, wherein the system tracks the elapsed time of the visit (optional) and the occurrence of the visit, and can generate billing information automatically to the insurance company. These ‘visits’ being less costly than an office visit can save the insurance company money, while saving time for the patient.

(2) Symptom flowcharting—user follows through a symptom flowchart (not that they'd see it as one) wherein the answer to each question directs the search for a diagnosis. This can be utilized to aid the user in selecting supplement and over the counter MS, or for deciding that they need to have medical attention.

(3) Collecting additional information—The iDose system is preferably configured with additional data collection devices, such as a camera, speaker and microphone, non-contact spot reading thermometer, blood pressure machine, blood glucose machine, and so forth. This information may be analyzed by the iDose system, such as in combination with the symptom flowcharting or utilized in combination with connecting to the practitioner.

(4) Patient Screening—One preferred use of the above is for patient screening and fast consultations, wherein the information for the doctor has already been collected when they communicate with the patient. By way of example, the user logs on and enters a problem and then follows the symptom flowcharting above. During the flowcharting process data may be collected as to conditions, actual patient temperature, blood pressure, and so forth, along with sounds and images collected. This data collected depends on the type of conditions. The data is then sent to the doctor, or other form of practitioner, wherein they may contact the patient at a later time to get additional details and to make recommendations and to prescribe for the condition. This form of treatment should be useful both for common ailments, common colds, as well as complex situations in which expert help, which is not close by, is made use of through the remote connection.

### MotoG—Bead insert Enhancement

Incorporated herein by reference:

Regular patent application entitled “Abrasion Resistant Conformal Beaded-Matrix for Use in Safety Garments” as docket “MotoGarb_2” application Ser. No. 10/613,800 filed Jul. 5, 2003;

Regular patent application Ser. No. 09/718,735 filed Nov. 22, 2000 which issued as patent 6,589,891 on Jul. 8, 2003; and

Provisional patent application Ser. No. 60/167,593 filed Nov. 26, 1999.

14.1 Description

These aspects provide additional benefits the material and garments which utilize the conformal beaded matrix described in the parent application MotoG_{—}2, and the issued patent serial number 6,589,891.

### 14.1.1 Bead Inserts

A first enhancement can be embodied in using a compliant material through which the cords of the matrix passes as it exits the bead to distribute the forces and reduce the chance of cord being cut by the material of the bead. The compliant material may comprise a plastic, silicon, latex, or other material that preferably has properties similar to rubber.

FIG. 21 depicts embodiment 1000 of a conformal bead having bead body 1002, such as comprising ultra-high molecular weight polyethylene (UHMWPE). A cord of high tensile strength material 1004 (i.e. Kevlar having a breaking strength on the order of over about one-hundred pounds). Cord 1004 is preferably configured with integrated elastic 1005 to provide some constriction so as to retain the corded matrix in close contact with the wearer. A crossing cord 1006 is shown coupled to cord 1004 within bead body 1002.

The exits 1008 for the cords in bead body 1002 are configured in this embodiment for receiving a second material 1009, which is preferably more compliant than of bead body 1002, wherein abrasion under loading between bead body 1002 and cord 1004 is reduced. The shape of material 1009 and exists 1008 is preferably configured to prevent them from separating, also material 1009 is preferably bonded to cord 1004 to further reduce the opportunity for separation.

The figure depicts a shape that provides a smooth transition for the cord at the exit, preventing excess damage, and prevents easy separation of the soft material. The external “knobs” of material also prevent the cord from being abraded at the exit until the material is worn through.

### 14.1.2 Alternative Bead Attachments

The beads of the anti-abrasion garment may be connected within a matrix in a number of alternative ways, as described in the parent application. A few additional methods are described herein. Multiple cords have already been seen connected to a single bead, such as through the center, however multiple cords may be coupled to the bead in a number of different embodiments.

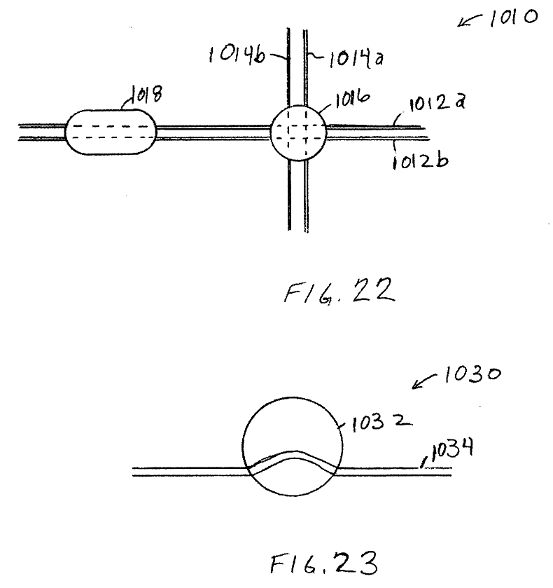

FIG. 22 depicts an embodiment 1010 that utilizes multiple separate substantially parallel cords 1010. Parallel cords 1012a, 1012b and 1014a, 1014c are shown transversely passing through bead 1016. Another bead 1018, by way of example shown as an elongated bead, is shown coupled to a single set of parallel cords 1012a, 1012b. Use of multiple cords passing through each bead, coaxially or disperse, can also be used to control rotation, if desired.

FIG. 23 illustrates the use of an off-center cord 1034, or cords 1034, passing through bead 1032. It will be appreciated that a number of alternative configurations can be provided without departing from the teachings of the present invention. Passing cords through the beads non-axially can be utilized as a mechanism for offering a selected surface for contact with the ground, if desired.

Sections of the anti-abrasion material may be utilized in air flow patches within a motorcycle garment. For example flow patches that can be opened and closed depending on the weather conditions.

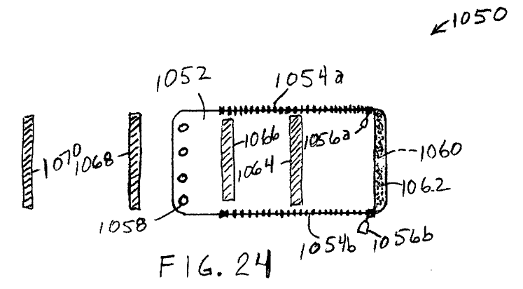

FIG. 24 illustrates an example of a variable vent 1050 that can be opened or removed to alter the airflow into the suit to which it is attached. The patch provides air flow access through the conformal beaded matrix. It should also be appreciated that air can easily flow through the beaded matrix as it holds the material away from the skin of the user, allowing air to more readily circulated within the suit.

A flap section 1052 overlays the conformal beaded matrix (not shown). Zippers 1054a, 1054b with tabs 1056a, 1056b allow opening the sides of the flap whose proximal end is held to the garment with snaps or buttons 1058, and the underside of whose distal end 1060 is retained by hook and loop fasteners. The outer side of the distal end 1062 of flap section 1052 has a hook or loop fastener which is configured for being attached to a complimentary section of hook or loop fastener at locations 1064, 1066, 1068, 1070 allowing the user to select the amount of airflow into the garment. The zippers themselves may be opened to provide slight venting. The flap may be completely removed by unzipping, releasing the distal end hook and loop fastener and unsnapping or unbuttoning the proximal end 1058 of the flap, such as in warmer weather. Any form of fasteners may be utilized to replace those shown in the figure, and flaps may be formed in any desired shape. It should be appreciated that the above is given by example only and that numerous venting arrangements can be implemented relying on various forms of fabric fastening and flap or packet arrangements.

### TipTracker—Alternative Rotation Drives

Incorporates by reference copending application(s), and patents:

Regular utility patent application docket “TipTracker_{—}02” Ser. No. 10/245,909 filed Sep. 15, 2002.

Regular utility patent application Ser. No. 09/854,028 filed May 11, 2001, which issued as patent 6,486,798 on Nov. 26, 2002.

15.1 Background

Aircraft ground incursion during taxiing result in damage and safety issues with aircraft. The present system provides a method and system for remediation.

15.2 Summary and Abstract

This application adds additional embodiments to the parent application for creating the nutating output pattern of the laser light. This embodiment converts a linear motion variable to a circular motion variation by an elongated shaped lens or reflector, which curves along the span over which the laser is directed toward creating a nutating pattern from a linear motion applied to said laser. By outputting along only a portion of the linear range of the reflector semicircles, arc, or other pattern indicative of size in response to distance from target, can also be produced.

15.3 Description

### 15.3.1 Additional Drive Embodiments

An aspect of the invention is the use of various forms of actuators for driving the laser output direction or alternatively the angle of deflecting the laser beam, such as from a mirror or through a lens or prism. These outputs can be driven by motors, but also using voice coils, magnetic deflection, and piezo motor mechanisms as well as others for rotating or deflecting the beam in a desired pattern.

### 15.3.2 Additional Lighting Choices

Use of Red and Green LEDs to replace the incandescent lighting (multiple elements provides redundancy). Less heat buildup Use a clear lens for less interference with laser light output. Unit can be molded into a single piece, no colored lens needed, wherein a clear lens may be used on both right and left sides of the aircraft, with less optical loss and significantly less heat buildup.

### 15.3.3 Motor Driven Nutation—Additional Embodiment

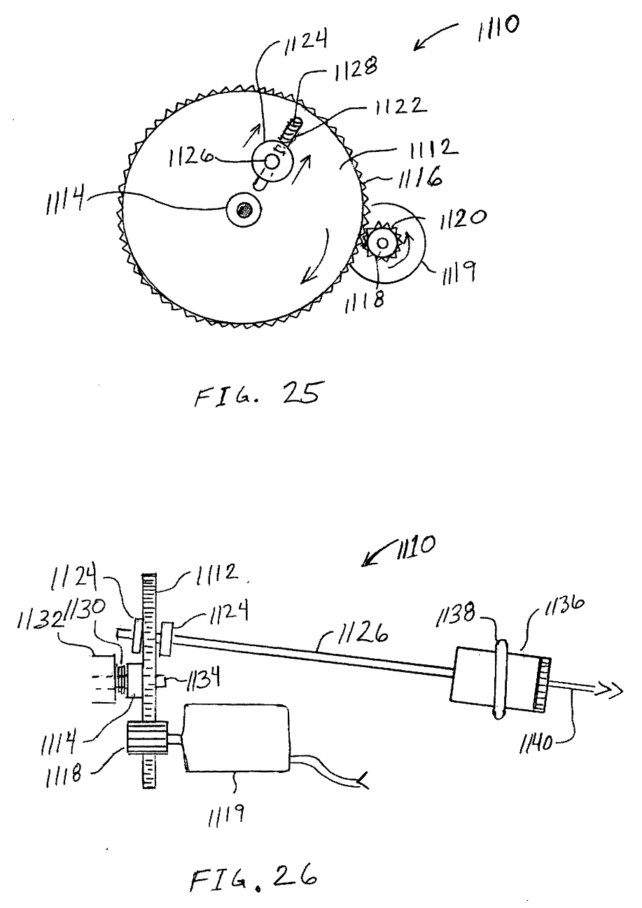

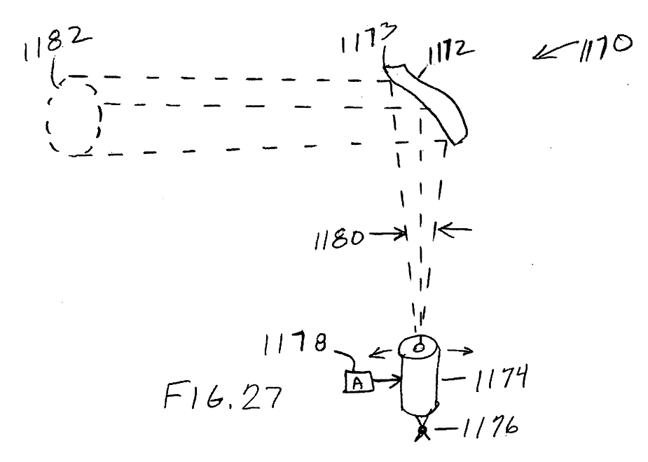

FIG. 25 and FIG. 26 depict another embodiment 1110 of driving the laser output direction. A first gear 1112 is coupled to pivot 1114 and has gear teeth 1116 for being driven by teeth 1118 of second gear 1120 of motor 1119. A slot 1122 in gear 1112 receives an end of positioning rod 1126 having retainers 1124 on either side. An optional biasing means is provided, depicted as spring 1128 retained in slot 1122 to allow changing the angle of laser nutation in response to speed of rotation. Pivot 1114 of first gear 1112 is shown coupled to a housing member 1132 and containing bushings 1130 to reduce friction. An opposing end of positioning rod 1126 is coupled to laser 1136 which is flexibly retained in a retainer 1138, such as an O-ring, wherein the laser output 1140 of laser 1136 is directed according to a nutating pattern whose divergence angle is created in response to the speed at which motor 1119 is being driven. Motor 1119 is preferably driven by a control circuit using pulse width modulation (not shown).

### 15.3.4 Linear to nutating output converter

FIG. 27 depicts a device 1170 for generating a nutating output within the tip tracker device from a linear movement of the laser. An elongated reflector strip 1172 having curving outputs 1173 along its length deflects the beam from a laser 1174 attached to pivot 1176 and moved by a single axis actuator 1178. The single axis laser sweep 1180 impinges on the curving reflector strip 1172 each portion of which controls both an elevation and a lateral direction of the laser, creating circular pattern 1182. It will be appreciated that the circular pattern 1182 appears as a laser line circumscribing from one point on the circle around a full circle and then back again in the opposing direction.

Limiting the linear sweep alters the amount of the circle which is traversed.

### 15.3.5 Tip Tracker Laser Bulb

The parent application describes a laser element incorporated within a housing which is configured to replace a conventional navigation bulb. The bulb housing contains a power supply for the laser diode (or diodes) and preferably a temperature compensation circuit to aid in driving the bulb. As described, the bulb incorporates the traditional navigation lighting output, although this is preferably implemented with a plurality of LEDs instead of with incandescent elements. The navigation lighting can be configured to flicker at a high rate (i.e. 2 Hz-20 Hz), almost imperceptibly, to increase visibility.

The use of LEDs allows for outputting green light on one side and red on the other while utilizing clear lenses, which provide less attenuation of the red laser through the lenses, in particular the traditional green lens.

Additionally, the modulation of the navigation lighting is controlled by the circuits within the TipTracker bulb, such as in response to activation signals received from switching the power switch through multiple transitions.

Furthermore, selectors can be incorporated on the laser navigation bulb to allow the user to select operating modes. For example the use of snap in jumpers, switches, plugs, rotatable contactors, applying conductive paint over contact pairs, any other convenient option selection means and combinations thereof. Additionally, the options can be selected at the factory with factory set conductive patterns and the like. This options can include the output pattern, size of pattern, speed of pattern, when to activate bulb, and other operational aspects. This allows a single bulb unit to be utilized while allowing the user to customize the operation to suit their desires.

The aircraft navigation lighting switch may also be adapted with a power converter allowing dropping/boosting voltage being applied to the navigation lighting at the tip for optimizing operation.

The system can preferably synchronize the modulation of navigation lights with strobe—example having a timer module near switch(es) which sends pulses or timing pulses for triggering the activity of the navigation lights and strobes. Can turn off navigation lights as strobes flash.

These aspects of tip-tracker may be described in a number of ways including as an apparatus for generating a horizontal collimated beam from a lighting element mounted proximal to the wingtip of an aircraft, comprising: (a) a laser element coupled to an electrical power regulating device and configured for outputting a collimated beam of light; (b) a single-axis actuator coupled to said laser element and configured for modulating the direction of said laser element along a single dimensional axis; and (c) means for optically redirecting said collimated beam across a second dimensional axis in response to said collimated beam traverses said single dimensional axis.

The tip tracker unit may further comprise a power supply configured for supplying a sufficient current to said laser element for generating said collimated beam.

The tip tracker unit may further comprise means for activating said power supply for said laser element in response to pilot input.

Wherein said activating means comprises a circuit coupled to said power supply and configured for detecting transitions arising within a source of power being applied to said power supply.

Wherein said transitions arise in response to toggling of a navigation power light switch by the pilot.

Wherein said optical redirection means comprises a mirror configured with a non-planar element.

The tip tracker unit may further comprise a controller configured for generating a signal to said optical redirecting means directing the output of said laser along said single dimension axis.

The tip tracker device may be implemented in a number of alternative ways without departing from the teachings herein. Remember—the tip you save may be your own.

### PlayMe—Personal Tune board

Incorporates by reference copending application(s):

Utility patent application entitled “Method and System of controlling automotive equipment remotely” within docket “Steer_{—}01”, section describing skateboard music generation within Ser. No. 10/279,480 filed Oct. 23, 2002;

Provisional patent application for above regular application Ser. No. 60/346,753 filed Oct. 23, 2001.

16.1 Description

This aspect of the invention describes new aspects of the SkateTunes device taught in the parent application and a personal Tune board which may incorporate the aspects newly described.

16.1.1 Incorp. of RF Port Into Personal Sound Systems

To allow the personal sound system to be utilized with a number of external control devices such as the described skateboard having the sensor deck, an RF port is preferably incorporated into the walkman or other form of sound system. The RF port preferably comprises a separate communication link, such as operating by the Bluetooth™ standard or any other RF standard. Although communication may be less preferably linked by way of unused AM/FM broadcast bandwidth, this however prevents simultaneously receiving input from the port and listening to an active AM/FM broadcast station.

16.1.2 Incorp Headphone with Mic to Personal Sound Systems

In this embodiment of the invention the sound port (or ports) comprise transceivers allowing the personal stereo to communicate with external devices as well as for receiving information from external devices. One feature of this allows the user to send commands from the personal stereo to the external device, such as skateboard sensing deck, steering wheel input device, or any other device configured for receiving control inputs and selections.

By incorporating a microphone, such as by way of a mic boom attached to a headset, the personal stereo systems can communicate with one another. This can allow a group of skaters to have voice communications between each other and/or listen to a common music source, which can be modulated/modified by the singular or collective outputs of the skateboard deck described for the SkaTunes device. The users can also share audio files, control files and the like. Preferably the communication channel can be selected allowing a group of skaters to have their own private channel. A simple form of voice encryption may also be utilized to make them feel more secure that other skating groups are not privy to their conversations.

### 16.1.3 Play-Me Personal Instrument Device

The general functionality of SkateTunes and SteerATune is incorporated within a garment allowing the user to play tunes on their own clothing, or on someone else's clothing. The clothing can even contain a display screen, such as using elnk with a buried row column drive matrix in one embodiment.

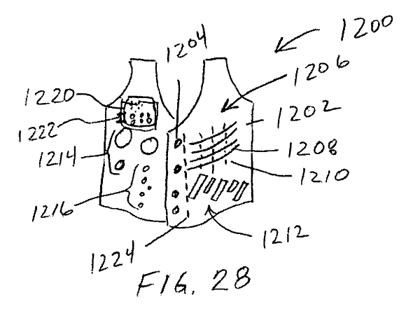

FIG. 28 illustrates an example of the tune functionality incorporated within a garment, herein shown as a vest although the elements may be incorporated within any desired garment. A garment 1200 is shown with a material body 1202, fastener 1204 (i.e. buttons) which can itself serve as an input device based on touch, twisting etc. The garment is configured with input devices to allow generating sound. On set of input device is shown as the strings of a guitar, or other stringed instrument. As with all the input devices the sounds produced from the inputs is based on the software being run on the controller and not the input device itself. For example string input 1206 having strings 1208 with frets 1210 may be utilized to generate sounds for a guitar, bass, steel guitar, banjo, violin, viola or even non-string items like piano, drums, woodwinds, and so forth which are not normally controlled using a string type input device. Keyboard input is shown 1212, drum inputs 1214, and woodwind input 1216.

A control device and audio annunciator is depicted 1220 removably coupled to the PlayMe garment. The control device may comprise a proprietary device manufactured for the PlayMe device or another form of device which is executing software to run the PlayMe device. For example an MP3, PDA, personal stereo, handheld gaming device, or even a cellular phone can be configured for operating the PlayMe tune garment. The ability to remove the control device allows the remainder of the garment to be washed without harming any circuitry in the vest. The interconnections within the vest may comprise conductive threads, polymeric material forming circuit traces or other means of conductive interconnection.

The input device preferably comprise sealed polymeric switches, sealed piezoelectric elements that respond to flexure and so forth. A connector 1222 is provided, such as within a retention pocket, to allow the host device to be connected to the PlayMe garment. The control device can be configured with a communication device to allow the music being created to be shared, such as forming a band wherein the data on user input is shared, locally or remotely, and played out for all instruments at each location. All the attributes that allow playing in groups and communicating the sound to a remote walkman, boombox or other audio system can be utilized herein.

Furthermore the garment can incorporate flex sensing materials, wherein aspects of the music can be altered or controlled in response to user motion. For example the user can warp the music being played by bending at the waist. It should be appreciated that the device can be used in a number of ways for controlling music by allowing the user to download different control programs wherein they can create any set of musical instruments and effects desired.

Auxiliary control units can be provided for the device using RFID technology, described elsewhere herein, which communicates with the controller. It should also be appreciated that limited functionality stick-on instrument devices can be created that can be temporarily attached to bare skin or clothing and which can contain its own audio output, or more preferably communicate, such as via BlueTooth, or similar, with an audio device which plays out the created sounds.

### USB Personality Module

17.1 Background

Many appliances, and other devices, are subject to limited programmability because of the difficulty and cost of providing a user interface allowing sufficiently complex input to set the parameters of the device. The devices, by way of example may include telephones, video recorders, audio systems (i.e. home, vehicle, portable) television sets, remote control units, washers, dryers, refrigerators, HVAC system controllers, automobiles, communication radios, spa controllers, exercise equipment, advertising signage, and various devices containing electronics for use in the home, in vehicles, or in the commercial/industrial sectors.

It will be recognized that many situations arise in which user programmability of features must be limited due to the limited capability of the interface on the device. These limitations may be so severe are relying on switch settings, or switches on combination with status indicators. Even if the device has switch inputs and a display, it can remain very difficult to represent complex selections on simplistic interfaces.

17.2 Summary and Abstract

Method and system for programming the features of a device without direct connectivity, or a sufficient user interface. This is described in the related provisional application.

17.3 Description

Adding internet connectivity to an appliance does not immediately rectify the difficulty with programming these device, because a complex interface is still required for interacting over the internet. Having the device controlled by a remote computer is not generally an option either, since this requires tying up a wired or wireless communication channel. Even temporarily connecting the device to a computer system for it to serve as interface is a generally unattractive option in many cases as the device may be remote from the computer, wherein establishing a connection is problematic.

In addition, the ability to download historical data from the device can allow its operation to be debugged, or provide more information than is otherwise available. For example in a traditional phone, the number called can be retained in a call log that is accessible to the PM. Obviously a number of applications of data retrieval from a target device provide benefits.

The present inventive aspects provides a means for communicating data with a device coupled to the internet and a means for retaining personality data. The device is generally referred to herein as a personality module (PM), and it may be implemented as a stand-alone device or its functionality integrated within a memory device (i.e. stick, USB memory fob, cellular phone, PDA, multimedia (audio) player, and so forth.

The device is preferably non-volatile for at least sufficient time to allow it to be moved from being powered by the device to being powered by a computer based system. Preferably, the PM is non-volatile and can be removed wherein it will not lose its data despite remaining disconnected for any period of time. Alternatively, the PM may provide sufficient non-volatility to allow removal from the device, wherein it retains memory during programming until it is again connected to the device.

The means for communicating data is preferably a standard interface supported on a plethora of computer based systems. The use of a USB (Universal Serial Bus) benefits from low cost and the USB ports are ubiquitous on a wide variety of systems.

If the device has a separate memory for holding parameters, then a non-dedicated memory stick device may serve as a PM. In this case the unit may be connected to the device and parameters collected from the device into the memory unit (PM). Once programmed, the memory stick (PM) is again attached to the device and the programming is then downloaded back to it.

This application differs from the use of a memory stick for storage. In some devices, notable an MP3 player, the songs can be downloaded to the memory stick over a USB interface, and then the unit is plugged into an MP3 player allowing the songs to be played out. The present invention, however, utilizes a web application over the internet that is generally specific to the device (or class of device) being programmed.

The PM contains information, (i.e. domain name, extension, web page information, serial number and associated password), that when inserted in a network enabled computer device causes a web application associated with the device to be brought up on screen.

This application allows the user to set any desired forms of operation for the device, and parameters for operation. Furthermore, data may be collected from the device for maintaining a log of information or other forms of retaining the data.

For every device that is to be controlled by the PM, web site pages are created which provide a means for selected options for the device. Parameters for controlling the device as well as actual firmware for supporting the features can be loaded from the web site onto the PM for transfer to the device to be programmed. Preferably the files collected for the device are retained in a segment of memory that is readily found by the device and not easily overwritten inadvertently. As new device features arise the user can customize the unit.

In operation, the PM is first connected to the device, wherein the device recognizes the presence of the PM determines if any new data is available, and if not it downloads data about itself and the manufacturer. For example the device name, model number, firmware revision number, date of manufacture, list of options, current settings, and manufacturer web site can be downloaded to the PM. Once downloading is completed a signal is preferably generated by the device and/or the PM (i.e. audio, LED in PM, or any other convenient signaling means). The PM can then be coupled to a device having a sufficiently complete user interface (i.e. preferably a PC, MAC, or laptop computer having DSL or other high speed connectivity). Software on the system is then preferably configured to detect the PM and to automatically retrieve the device data and to bring up the web site. Optionally, if no automated execution is provided, the user may need to execute a program for the PM which commences the process.

Once on the web site the correct user interfaces pages are selected in accord with the specific device, model and date. If new firmware is available the user is alerted wherein they can perform a download to upgrade their device. Otherwise, the interface pages show the current settings of the target device in a plain manner and allow the user to make changes accordingly. In some cases special passwords, such as associated with a service contract or other program, may be necessary for accessing the site of a particular manufacturer.

The new settings are thus established on a system having a very comprehensive interface, and retained in the PM. Once completed the PM is moved back to the target device (i.e. phone, PDA, refrigerator, Heating and cooling controller, sprinkler system, personal audio system, home audio system, and any other device for which added control is desired and/or for which a limited user interface is otherwise available. The present invention allows personalizing the device without the need of a user interface, or network connectivity, on the device for setting the features. The present method and system allows displaying or logging information collected from the target device without the need to establish a network connection.

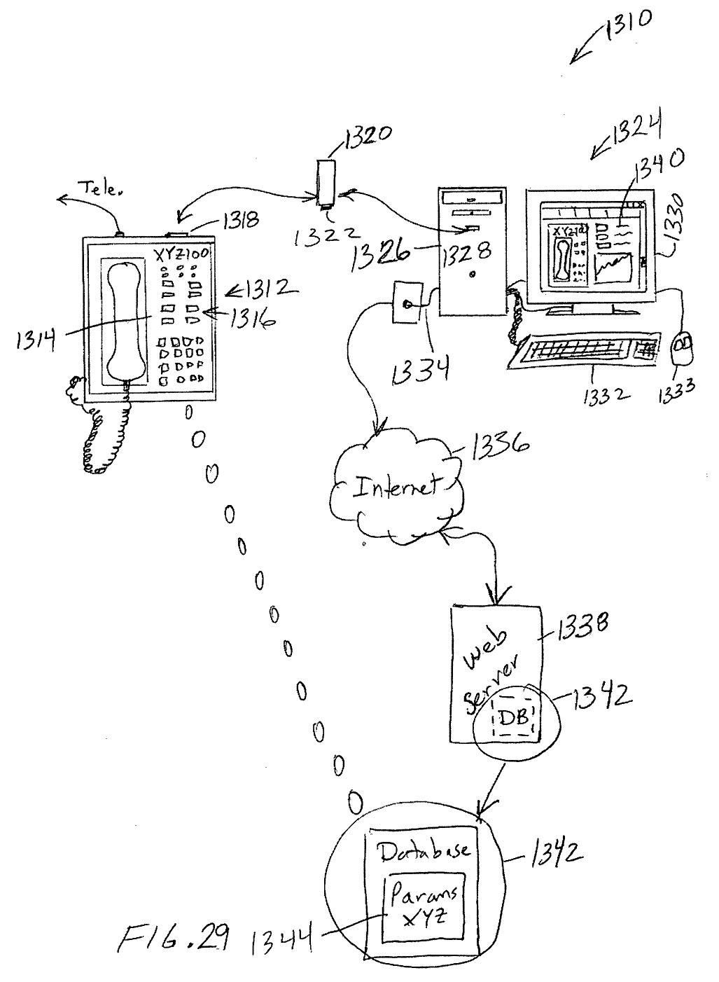

FIG. 29 represents an embodiment 1310 of the present invention of personality module. A target device 1312 is shown for having a number of selectable features 1314 and some of them associated with feature selection buttons 1316. An interface to the personality module 1318 is provided, either directly or via an adapter from another communication link. In a less preferably mode the communication can be wireless, such as via BlueTooth™ link, WiFi link, or other communication standard. The personality module 1320 (PM) is shown with connector 22 configured for coupling to target device 1312 and network enabled device 1324, depicted as a desktop computer system. A central processor unit 1326 is configured with software for controlling the uploading and downloading of information from PM 1320, as well as browser software and internet connectivity to allow a web site to be accessed as well as navigation and communication with that web site. The computer contains an interface 1328 to personality module (PM) 1320. A display output 1330, input device (i.e. keyboard) 1332, and optional pointing device (i.e. mouse) 1333 provide a substantially complete user interface wherein the selection of operating modes, parameters and settings for target device 1312 can be readily selected (if the web interface is well designed).

The computer 1324 is configured with a network interface 1334 for accessing the Internet 1336 and web-server 1338 from the manufacturer, wherein a web interface (application) 1340 is displayed for the target device.

A database 1342 within the web server is configured with data about the specific target equipment including selectable parameters and features and the availability of new firmware downloads, any or all of which can be downloaded as params and data for the target device specific features 1344.

FIG. 30 depicts an embodiment of PM 1320 having a communication interface 1322 coupled to a controller and interface 1348. A permanent, or removable, memory 1350 is coupled to the PM controller 1348. Optional identification 1352 within the memory and controller allow different memory cards to be used with various PM controller modules. The memory provides, preferably segmented, storage for parameters and other data used for controlling and establishing the operation of the target device. Optional interfacing 1356 on the PM allows the user to select operating characteristics, to signal that the device should prepare for removal, download device statistics, or other aspects.

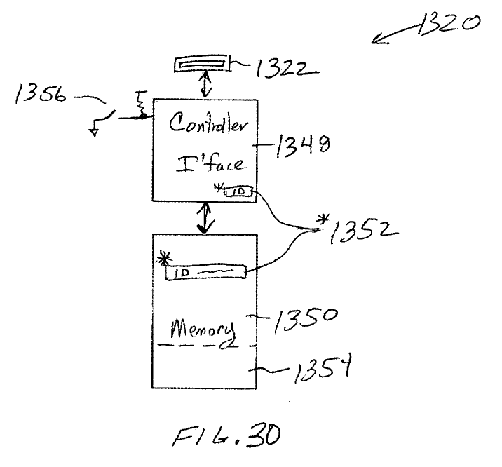

FIG. 31 depict an embodiment of a process for setting operational parameters of the target device.

Program execution commences in block 1370 and the PM is first connected at block 1372 to a target device configured for communicating with the PM. If new data is not available in the PM as detected by block 1374 then a new operation must be commencing and information is loaded from the target device to the PM as represented by block 1376 in preferably a standardized format, containing a full pathname to the web address associated with the device, then information about the model number, rev date, software revision, all control parameters, and so forth, as well as historical information about the use of the target device, and any other pertinent information which is stored in the target device. Completion is preferably indicated by the target device or PM as per block 1378, after which the PM can be removed as per block 1380 and connected as per block 1382 to an internet-enabled device having a sufficiently complete user-interface, such as a personal computer, laptop, PDA, proprietary device configured as a “mothership” for the target device, and so forth.

Upon connection the PM is detected as per block 1384 data is loaded for execution, and the proper web address is accessed as per block 1386 for the given target device and model number. The user can then select options, such replacing old firmware, as well as setting any parameters, features, and so forth of the device, including the downloading of new audio segments, display control elements and so forth. Optionally the web site can allow the user to print out a short or complete guide of the selected features, since the entire operation of the target device could be reconfigured if desired by the current process.

The user can also work with the historical data collected from the target and can use this information for selecting features, for chronicling important use aspects of for updating a log of activity for the device.

Once the user is finished with setting up the device and historical data the user selects to save the data and remove the device as per block 1390, wherein a new data flag is set as per block 1392, after which the PM is removed at block 1394 wherein via connector A at block 1396, the PM is reconnected to the target at block 1372. This time new data is detected at block 1374 and the new data from the PM is uploaded to the target to establish new operating parameters and optionally new firmware as per block 1398. Once configured the new data flag is reset and the PM indicates that it is done as per block 1378, wherein it can be removed as per block 1380, until the next time the user wishes to upload historical data or set parameters.

Application specific data can comprise elements that making a connection with the proper web server over the internet for the specific target device. For example, the application specific data may be selected from the data elements consisting of: application programs configured for establishing a connection with a web site, script programs configured for establishing a connection to a web site, web address information, manufacturer, model number information, options of the device, revisions, current parameters.

User interface of the network enable device provides sufficient sophistication to provide for the display of information and the programming of parameters for the target device. Interaction between network enabled processing element and server is preferably under user control. For example they may determine what operation to perform, such as display/log information collected from the device, or to set operating parameters and features for the device.

### 17.3.1 Aspects of Invention:

Separate Storage Sections—A PM as a memory device with USB port (or similar communications interface), wherein the unit is configured with storage locations that are only accessible in a selected mode of the unit. For example, a switch selects between the conventional memory storage area and a storage area containing non-volatile information about devices which may be programmed. In this way the unit need not be loaded with device information on each programming cycle. Furthermore, having the memory area set aside can simplify the process whereby the computer distinguishes the use of the device and the memory to be used.

Device File Organization—As an alternative to a separated storage, a common device file may be retained on the device which is readable by the program accessing the memory unit. Preferably the device file is at least partially human readable, wherein persons can check select information in the device list. If retained as a file, then each device to which the unit is attached can modify the file to include information about itself.

Target Device finding file—Upon Target Device detecting that PM is inserted (automatic detection or manual alert) a specific file may be looked for in the PM. For example the make and model of the device may be listed on the filename.

Manual Device File Creation—In some instances less overhead is involved if the device file is created by the user, or downloaded/modified from a source, such as a web site for the device. In this way the device need only be able to read from the PM device.

Detecting Upon Insertion—When inserted into a network enabled computer system, the software running on the computer reads device information and if information for more than one device is retained in the memory it provides a selection list (or similar) allowing the user to select which of the devices they want to program.

Uploaded Device Data Detected—When inserted into a network enabled computer system, if the unit previously has been loaded with information from the device, this will be detected and an indication will be preferably provided to let the user know that information is available.

The aspects of the invention can be described as a method of personalizing a device that contains electronics, comprising: (a) connecting the personality module (PM) to a target device; wherein the personality module is configured with non-volatile data storage; wherein data is retained for at least a sufficient period of time to allow the personality module to be disconnected from one source of power and reconnected to another source of power; wherein the personality module is configured with an electronic communication interface through which data may be exchanged between the personality module and a computer based system; (b) downloading information about the target device including manufacturer web site and optionally device history; (c) removing PM from target; (d) connecting the personality module to a computer based system; (e) activating an interface routine within the computer based system at a target device specific web site for reading settings from the personality module and making changes thereto under user control; (e) removing said personality module from its connection with said computer based system after the user has set the desired parameters of operation for the device; and (f) reconnecting said PM to target device at which time the new parameters as well as optional new software is loaded into the target device.

Wherein said device provides a first source of power for said personality module.

Wherein said computer based system provides a second source of power for said personality module.

### Methods of Local Advertising in Printed Periodicals

### (Category: Subscription Services)

18.1 Background

All prospective advertisers can't afford a national advertising, or even a large region of advertising such as in which the magazine is assembled differently for each region. Furthermore prospective advertisers may not want to reach all readers, but only readers following a select demographic profile, such as represented in the qualification data collected by the publisher.

18.2 Summary and Abstract

Customization of printed periodicals magazines on the fly to incorporate local, regional, or customer specific (targeted) advertising. The invention is particularly well suited for magazines. The present method allows a standard bound version of the magazine to be modified for each subregion and/or demographic or combination thereof of the party to which it is being delivered. The term magazine will be utilized herein to refer to any form of wide circulation printed periodical, such as magazines, newspapers, phone books, catalogs, and so forth.

18.3 Description

One way to describe the present invention is by example. By way of a first example, a restaurant in Sacramento may want an ad that is just included in issues sent to the Sacramento and surrounding areas (i.e. based on selected ZIP codes, counties, or other geographic selection criterion). WITHOUT the need to pay for advertising over the whole region or country.

By way of a second example, a BMW specialty parts dealer may want to advertise only to parties that own at least one BMW, regardless of where they are located. While other parties may want to advertise based on the salary category of the recipient, or whether they own or rent.

The system can also provide for direct party-to-party customization of a portion of the advertising content. Advertiser selects which parties from the subscriber list that they want to receive their ad and they pay for the advertising accordingly. Standardized sections of advertising can provide easy swapping and of possible ads in creating a custom advertising piece.

The reader service card can be enhanced to include numerous demographics or allow the reader to write in their own areas of interest. In this way the user can in essence select the type of ads that appear in the magazine they will receive.

For Example:

Please select any categories of advertising that are of interest:

Automotive, New Vehicles, Used Vehicles, Recreation Vehicles, Make(s) ______, Home Electronics, Entertainment systems (TV, DVD, Music), Gaming systems, Telephone systems, etc., etc.

The customized advertising is selected by a computer executing an advertising selection application program in response to knowledge of the subscriber, such as their address and any selection criterion submitted by the subscriber.

The following describe embodiments of the invention. In a first embodiment the magazine is printed conventionally but with blank areas or areas

(1) Printing the periodical with blank pages/areas or pages/areas with a background that may be overprinted with advertising;

(2) Binding the periodical;

(3) Retaining periodical in an open position; and

(4) Overprinting sections of the periodical in response to demographic and/or location information for the recipient.

A second embodiment is provided by way of example and not limitation, in which sheets are selectably inserted into the periodical for adherence therein.

(1) Printing and binding a periodical;

(2) Selecting or printing at least one custom advertisement in response to demographic or location information of the recipient for said periodical;

(3) incorporating an adhesive within at least a portion of the custom advertising, which only adheres to surfaces upon being activated; and

(4) Activating the glue of the custom advertising to assure retention within the periodical.

Wherein said adhesive is heat activated and the magazine is heated under pressure to activate the adhesive for retaining the custom advertisement.

A third embodiment is provided by way of example and not limitation, in which areas of electronic ink are “programmed” to a specific advertisement. Using this technique it is a simple matter to tailor the advertising to specific individuals. An electrode bar is passed over the elnk areas while an electrode on the opposing side of the elnk material retains an opposing polarity, so that the ink is non-volatile programmed to display a desired advertisement. The elnk may be on the front cover, such as on a label, or on any other portion of the magazine to which an automated system can gain access. It is preferred that the location of the elnk section be easily located, such as near the front or rear, or located adjacent to a stiff insert or similar element that can help locate the elnk areas. The elnk areas may be retained just beneath the front or rear covers wherein if may be programmed through the cover without the need to open the magazine at all.

(1) Printing the periodical with blank pages/areas or pages/areas with a background having at least a first electrode over which an electronic ink material is deposited;

(2) Binding the periodical;

(3) Programming desired portions of the electronic ink of the periodical in response to demographic and/or location information for the recipient.

Wherein said at least first electrode is configured with a conductor that is accessible from the closed magazine;

Wherein the electronic ink is programmed by passing a second electrode from the front or rear cover

Wherein the conductor comprises a conductor connected to said first electrode which is routed to the spine of said periodical for applying a biasing voltage to said first electrode; wherein programming is performed by passing a second electrode having a plurality of pixel-sized segments whose voltage is modulated in relation to a voltage retained on said first electrode to program the pixels of the electronic ink region.

Further comprising after the binding process: retaining said periodical in an open position; establishing an electrical connection with said first conductor.

In less preferred embodiments, the custom advertising may be bound to a portion of the periodical, such as attached to the rear of it. The custom advertising may also comprise a custom selection of separate sheets (full or partial) of advertising that are retained within an envelope retained within the magazine. Separate sheets (full or partial) may also be retained within the protective cover for the periodical.

Another aspect of the present invention is a method of forming address tags on a periodical, or a protective jacket for a periodical, wherein at least a portion of the mailing tag, directing delivery to the intended recipient, incorporates electronic ink region or regions that may be programmed by selectively modulating pixels as electrical fields nearby the address label. These address labels have the advantage of being faster to print than conventional labels, while they are also capable of being reprogrammed to retain different information at a later time.

It will be appreciated that the aspects of the invention describe both (1) A method of customizing subscriptions, and (2) A method of customizing address tags as described herein.

### Premium Subscription Delivery Services

19.1 Description

Provide a method and system of increasing periodical revenue by providing different forms of premium delivery and catering to the more upscale clientele. The method involves providing levels of premium subscription service and “prepublication” distribution.

The leaders in various industries need to find out the latest news in their industry with away to make proper decisions, often decisions that could require them vying with competitors for products or services. Therefore, it is important in many cases to get subscription information as soon as possible.

Many persons also like to be the most up to date on an industry and would be willing to pay increased rates for that privilege.

The present invention adds at least one class of “prepublication” subscription distribution, wherein the persons receive the information before general subscriptions are received. These publications may be printed conventionally, but in a first run, or they may be printed with a lower volume (higher cost) printing process that has faster turn around time.

The following classes of service are provided by way of example and not of limitation.

Premium delivery—Pay per when delivered. Single or multiple levels of premium delivery. The magazine bears a label indicating special status of subscription.

Example of different rates:

Gold Premier Subscription:

+$50

mailed 2 priority mail from first run (Arrival ˜14 days early)

Gold colored “Gold Premier registration label” on magazine front cover

Option: +$10 for Protected—with coated magazine cover

Silver Premier Subscription:

+$20

mailed first class from first run (Arrival ˜10 days early)

Silver colored “Silver Premier registration label” on magazine front cover

Option: +$10 for Protected—with coated magazine cover

Premier Subscription:

+$5

Mailed in first wave. (Arrival ˜5-7 days early)

Notation on mailing label as Premier

The invention can also be described as follows.

1. A method of providing enhanced subscription services, comprising:

(a) defining at least one class of premium subscription service at a price above normal subscription rates;

(b) printing prepublication copies of the periodical for at least one class of premium service;

(c) mailing said prepublication copies to provide reduced shipping delays in relation to normal subscription rates; and

(d) labeling the periodical or wrapper with notification of the premium service level being provided.

### Medley Back Issue Subscription Services

20.1 Summary and Abstract

Provide additional revenue from unsold periodicals and serve the community by allowing the keeping of good magazines at Doctor's, Dentists, and other professionals offices. An inexpensive method of providing subscriptions for select markets from oversupplies and unsold magazines as returned from retailers.

The company does not want their own addresses showing on their old magazines, and besides people appreciate CURRENT magazines (within a few months).

20.2 Description

Can select from a choice of a number of different magazine. Can prioritize in different ways. (i.e. select based on availability following choices). Can select based on how current they are, less current being less expensive.

Subscriber selects number of magazines to receive per month, and when to receive them during the month. (i.e. May want 2 delivered about the first of month and 2 more at mid month). These are then selected based on availability from the choices available. A flat fee is charged per magazine per month even though the choices may be of varying cover prices.

Options:

A Special label for the establishment—to identify the company/establishment—as a form of advertising. The label may cover a portion of the front of the periodical, such as printed on a transparent sheet section, which allows the underlying text to still be read. These may be given away by the establishment as newer magazines arrive-allowing the establishment to send “advertising” home with the patron.

Aspects of the invention may be described as follows.

1. A method of distributing periodicals at low cost, comprising:

(a) signing up a subscriber for a number of periodicals per a given period of time;

(b) collecting overstock on various periodicals which are not necessary the most current; and

(c) shipping overstock periodicals according to the number per given period to which the user subscribed.

2. A method as recited in claim 1, further comprising signing the subscriber up for one or more periodical subject areas or a list of periodicals from which the items may be selected.

### Remote Landing Assist System

### (Category: Transportation Subcategory: Aircraft Safety)

21.1 Background

One of the dangers of single pilot aircraft operations can arise as a result of a pilot becoming incapacitated during flight, such as from a heart attack or stroke, wherein the aircraft will crash killing the pilot, any passengers aboard, and perhaps individuals on the ground.

21.2 Description

Allows an aircraft with an incapacitated pilot to be remotely piloted to a destination and landed. A system for enhancing the autopilot systems of the aircraft such that upon an incapacity situation the aircraft can be flown from remote instructions wherein it is vectored to a large airport or less populated area, and wherein the aircraft may then be remotely piloted down for a landing without the need of pilot intervention.

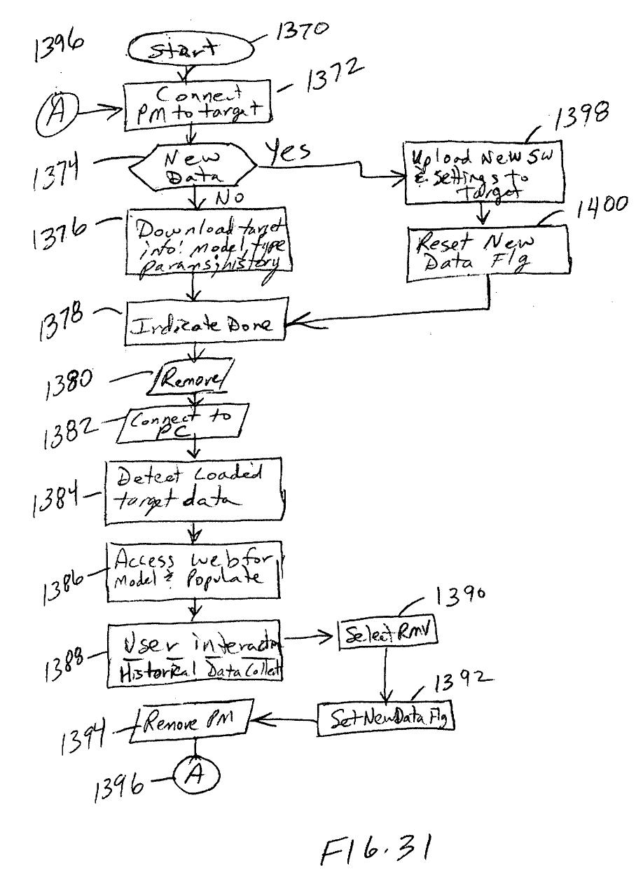

FIG. 32 illustrates by way of example a system 1410 connected into an aircraft for directing the aircraft flight path and operation in an emergency situation. An emergency direction system 1412 is shown connected through the communication system 1414 and optionally the transponder 1415. An emergency event can be detected in response to an emergency cord 1416, that preferably passes through the cabin so that persons in the back have access to it. Alternatively, or additionally an emergency button or switch can be provided 1418 (which can provide over-ride of the cord if desired). Additionally, other forms of sensors 1420 may be utilized such as detecting user handling of the controls, or flight path, when the autopilot is not activating. Furthermore sensors to detect breathing, pulse, or some other metric can be utilized for automatically triggering the emergency state if the pilot is flying by themselves and becomes suddenly incapacitated.

Upon an emergency being detected, emergency director (ED) unit 1412 kicks generates and audible alert over speaker 1424, and activates the autopilot 1428 to maintain the last valid non-wavering heading. Within a few seconds, giving time for emergency to be rescinded if invalid, such as accidentally tripped by a passenger. A voiced transmission is generated over the communication system to air traffic control, which can be heard over the aircraft speaker.

Air traffic control responds to the alert and activates a data unit configured for communicating encrypted data to and from the emergency director system within the aircraft. The data received by the unit includes codes for directing the ED unit. The microphone is activated to pick up sounds in the aircraft, as passengers may not be capable of operating the microphone. Air traffic can turn on and off the microphone if passengers are overly load preventing two way voice communication. Information available as to aircraft status, such as orientation, heading, speed, engine RPM, and so forth are transmitted over the data channel to air traffic control.

If a bonafide emergency, air traffic control will pass flight parameters to the autopilot, such as heading, and preferably rate of descent and engine settings if the aircraft autopilot is so equipped. The passengers are assured by air traffic control which controls the operation of the aircraft while controlling it toward an emergency landing site. Preferably a passenger may be available on board to manipulate controls under the direction of air traffic which are not under digital control of the ED unit. Air traffic control uses their data console and preferably a set of analog controls to manipulate the aircraft. As the aircraft reaches a controlled airport the direction of it is handed to an air traffic controller that completes the landing sequence. It may be preferable that the air traffic controller proceed out to the intended runway with a remote control tied back to the control tower, wherein the controller is able to modulate the aircraft controls and perform a landing if persons aboard are not capable of attempting to do so.

In a worst case scenario, wherein the pilot is incapacitated and the aircraft runs out of fuel, has an engine failure or the like, the ED unit can attempt to direct the aircraft toward the most level ground based on GPS and map information, and control the descent and speed for a crash landing. Obviously if persons aboard are able to control the aircraft, then the system would generate audio to help walk them through making an attempted landing.

If upon the emergency being detected, air traffic control does not respond back on the set frequency, then the communication system is automatically set to an emergency frequency, and additionally if coordinates are available such as from optional GPS unit 1432, the correct frequency for a local controller is looked up in a database. In remote areas the direction of the nearest airport can be fed to the autopilot so that the aircraft is directed to where it will readily be under the control of an air traffic control personnel.

FIG. 33 depicts a block diagram of an embodiment of ED unit 1412. The core of the unit comprises a controller unit 1450, which is preferably configured with at least some redundancy, such as shown using three processors 1451,1452,1453, tied in a voting scheme and which perform background operations under non-emergency situations based on flight parameters so that any anomalies in any of the processors can be detected prior to an actual emergency.

A communication interface 1454 is configured for controlling the operations of at least one communication device within the aircraft, or it may be connected to a separate dedicated communication system having the necessary digital control interface. It is far preferred that the aircraft have at least two independent systems, wherein a failure of one does not leave the aircraft without communication. A data module is connected from the communication interface for registering digital data that is encoded within the audio channel as it arrives from the air traffic controller, and for encoding data into the audio channel from data generated from the ED unit. Preferably, upon an emergency situation ED unit 1412 generates a coded transmission to air traffic control which must response with a response to the given code in order to take control of flight systems within the aircraft. The correspondence between coded transmission and response not being disclosed to the general public. Additional security measures may be taken as deemed necessary, and which are generally known to those of skill in the art.

A transponder interface 1458 allows controlling the setting of the transponder, such as to alert emergency personnel. If air traffic cannot be reached on the communication radio then an alert can be sent on the transponder along with a frequency channel to which air traffic should respond.

A user interface 1460 comprises the sensors and controls for detecting an emergency situation and for receiving feedback from a slightly incapacitated pilot or their passengers. Furthermore, the user interface preferably provides at least one input to which a passenger can answer yes or no to queries from the ED unit. This is particularly useful if air traffic personnel can not be reached on the radio, so that the ED unit can operate in combination with any available passengers when selecting landing sites and so forth. The input for example allows the passenger to indicate their ability to direct the plane down onto a smooth surface for landing, wherein the autopilot directional control can be released to the passenger.

An audio interface 1462 is under the control of the ED unit to allow air traffic to communicate with any occupants of the aircraft.

An interface to a GPS system 1464 or other forms of locator systems, (i.e. Loran), is provided so that additional information may be gathered by air traffic control, in particular if the aircraft is not in range of radars.

An instrument interface 1466 collects data from any instruments that provide available digital information, so that the ED unit and air traffic (if available) can be kept apprised of the condition of the aircraft.

An interface to the Autopilot 1468 allows the ED unit to control aspects of the flight regime, based on data received from air traffic or lacking that based on mapping information and coordinate data.

An optional camera interface 1470 is shown which allows the feed from a camera (i.e. pointed out the front of the aircraft) to be communicated over the communication interface 1454 by way of controller 1450, allowing more intelligent decisions, in particular if landing of the aircraft is required.

Auxiliary inputs 1472 can be utilized to gather additional information from the aircraft and to control additional aspect of the flight as per the specific ED unit installation.

Memory 1474 connected to the controller provides both programs for execution by the controller as well as all data needed for the given aircraft. Shown by way of example, the memory contains situation data (i.e. scripts) utilized for determining the actions of the ED unit for a given set of conditions. These are preferably encoded as scripts to reduce the space requirements and programming overhead. These scripts may be customized for the specific ED unit installation, such as based on what data and control is available in the given aircraft. Data codes are provided for communicating with air traffic, for encryption and decryption purposes, and for aircraft system control. Autopilot parameters are contained that describe the operation and control codes necessary for directing the autopilot, and optionally for reading any data from the autopilot that it may provide. Map information should be stored in the system or in a data module, such as hard drive, optical drive, non-volatile memory card, and so forth to be used in combination with a positioning system, such as GPS, allowing the ED unit to make decisions based on terrain and location of airports if control from air traffic control is not available. Instrument parameters are stored for interpreting the data received from the instruments. Voice segments are stored allowing the ED unit to interact with any available passenger (or somewhat incapacitated pilot) along with the ability to communicate with air traffic control using voice (particular for first call up prior to engaging a data communication mode). Identification data is contained in the memory to identify the aircraft and any pertinent data about the owner of the aircraft, wherein air traffic can alert personnel on the ground as to the condition of the pilot and passengers.

Aspects of the invention may be described as follows.

1. An aircraft safety system, comprising:

a remote selector control activated in response to pilot incapacity;

autopilot engaged by said remote selector and configured for controlling flight aspects of the aircraft;

a secure communication channel for receiving sequential vector instructions and limits for said autopilot from authorized remote locations;

2. An aircraft safety system as recited in claim 1, wherein said pilot incapacity may be detected in response to indicators of pilot incapacity as selected from manual inputs, aberrant attitudes, lack of responses.

3. An aircraft safety system as recited in claim 2, wherein said manual input may be selected by a pilot that is aware of an actual or impending incapacity.

4. An aircraft safety system as recited in claim 1, further comprising a status communicating system wherein the status of critical aircraft systems, such as fuel, power, speed, flap position, landing gear position, and so forth are communicated remotely.

5. An aircraft safety system as recited in claim 1, further comprises a voice link wherein a microphone can monitor sounds from within the aircraft and communicate these to remote personnel, and the remote personnel can communicate with parties on board the aircraft to communicate information to them.

6. An aircraft safety system as recited in claim 1, further comprising a forward looking camera that may be activated in response to said secure communication to aid in the landing of said aircraft.

7. An aircraft safety system as recited in claim 1, wherein a full series of vectors is communicated at earliest convenience so that if contact is lost then aircraft still directed at correct location.

8. An aircraft safety system as recited in claim 1, wherein said autopilot is configured to follow the procedure associated with the vector limit if a new vector is not received within the allotted time or location.

9. An aircraft safety system as recited in claim 8, wherein said limit may include a subsequent vector, a holding pattern, or other set of actions to reduce the risk associated with subsequently missed vectors.

10. An aircraft safety system as recited in claim 1, wherein flight aspects of the aircraft include direction, speed, attitude, ascent/descent, throttle, landing gear position, and engine cut off, are controlled by the ED unit and/or air traffic control through the ED unit.

### Physical Monitoring Interface for LANs

### (Category: Office Subcategory: ReceptSentry)

Incorporated herein by reference are provisional application Ser. No. 60/394,160 filed Jul. 1, 2002 in a section describing a “Reception Sentry”, and provisional application Ser. No. 60/413,199 filed Sep. 23, 2002 describing additional aspects of the reception sentry invention.

22.1 Description

To be used in combination or separately from the reception sentry device described in the application incorporated herein by reference, to automatically communicate selected physical activity to remote locations within an organization. In particular the system provides for remotely indicating physical activity at physical entries and exits, in secure areas, or operation of controlled resources.

### 22.1.1 Detecting Physical Activity

A physical monitoring interface, hereinafter referred to as a PMI, is a hardware device configured for attachment to a LAN, or through an intermediate communication media such as a USB cable to a computer capable of communicating over a LAN.

The PMI is configured with inputs for monitoring physical activity. These inputs may be triggered using wired connections (conductive wiring or optical cable), or wireless connections (acoustic, radio frequency, broad band, optical wavelength broadcast).

Inputs, or input modules, provide sensing the physical environment either optically, acoustically, or according to other physical characteristics such as pressure, impact, motion, and so forth. The following are provided by way of example:

Pressure sensing mat—

Light beam interruption—

Door motion sensor—

Door position switch—

Switches for detecting states of other physical items—

Acoustical sensing head—(presence sensing, voice recognition for identification, voice recognition for commands, etc.)

Optical sensing head—(simple with one or a few optical elements)

Camera head—(sensing a substantial number of optical elements to register images)

Software on the LAN is provided in association with the PMI for interpreting the signals received at the PMI and establishing a desired response over the LAN to one or more stations, or other devices.

Compares data collected by PMI with administrator set conditions and alerts the proper locations over the LAN based in response to the data exceeding limits set by admin.

By way of example, conveying an image from the front door to one or more remote consoles (i.e. PCs) connected to the LAN in response to the front door being opened. This can be further conditioned by sensing a particular physical characteristic that can determine the general identity of the person (i.e. with company or not).

The addition of physical information monitoring increases the value derived from a device which monitors the reception area, although it may be less preferably utilized separately.

### 22.1.2 Detecting Phone Activity

One embodiment of the invention comprises a version of the PMI, referred to as a TMI (Telephone Monitoring Interface) that passively monitors phone traffic on one or more phone lines associated with the given company.

Preferably the TMI extracts information about which numbers were dialed, indicates if call is FAX or voice, the time of the call and the duration of the call. This information can be utilized for generating reports that may be utilized in checking phone bills and for otherwise controlling the use of telephones.

Additionally, the TMI may incorporate active elements which can impact the call, the device being referred to herein as TMI-Active. According to administrator control settings, TMI-Active can perform a number of functions, for example.

(1) Block calls to unwanted numbers, such as certain long distance areas or abused numbers called. Call progress tones may be generated by TMI-Active that disrupt the number being dialed, such as extra digits, or call progress tones that cause the call to be dropped or routed to an operator. An audio response may also be generated to the user to alert them that the system has blocked the call.

(2) Limit calls to a selected length (fixed or variable) based upon administrator settings. TMI-Active can generate a string of noise, or voice, when the selected length has expired and otherwise put the party on notice that their allowed time has expired. Preferably, TMI-Active first generates at least one subtle reminder that the time period is nearly over to allow the user to gracefully end the call.

Aspects of the invention may be described as follows as both an apparatus for monitoring physical activity at an entry/exit location and as an apparatus for monitoring and/or controlling phone activity.

### Augmenting Wireless Services for Use in a Vehicle

### (Category: Transportation Subcategory: EnhancedVehicleWirelessSvcs)

Incorporated herein by reference are patent application Ser. No. 09/730,327 filed Dec. 5, 2000.

23.1 Description

To enhance the functionality of wireless device when used within a vehicle, or alternatively within a building or other location containing power and electronic equipment. The vehicle (building etc.) communicates with the wireless device, such as cell phone, PDA, and so forth to enhance the functionality. In this way the user can carry the wireless with them but have access to additional functionality, range, services when they are within their vehicle or otherwise within range of the extension services.

### 23.1.1 Enhancing Cellular GPS Signals in Transit

A communication link is established from the extension services to the wireless device, which may be wired (i.e. through the charging system) or wireless (i.e. BlueTooth).

A wireless GPS, such as on a telephone handset, is shielded within the vehicle making use difficult as good fixes are hard to obtain. The GPS location information collected by the vehicle is therefore communicated to the wireless device upon request so that that a correct location may be communicated over the wireless device. Furthermore, GPS coordinates received over the wireless device may be communicated to the onscreen moving map, or other form of display found in the vehicle.

Furthermore the signal is often not broadcast at sufficient power to reach the desired destination from a cell phone. wherein the present invention provide mechanisms for augmenting the cellular phone signal to reach a repeater site.

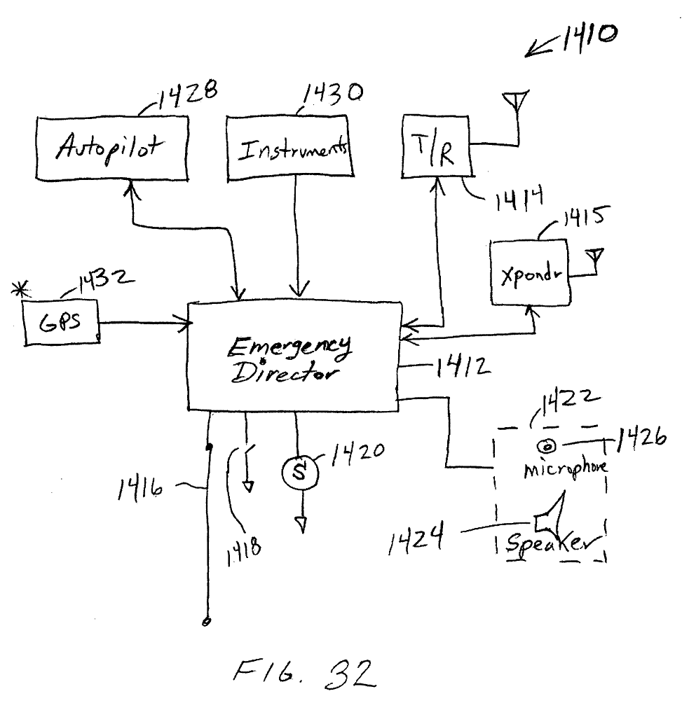

FIG. 34 depicts a system 1510 which augments wireless services provided by handset 1512, which is shown inserted in a base 1514, preferably connected to a power supply 1516. Services are connected through a data control unit 1518, preferably connection through power supply 1516 and base 1514 to the handset. Optionally this connection may be made by way of a wireless communication path, such as Bluetooth™, or other protocol.

A hands-free audio system is preferably connected through the data interface, although it may be connected through a conventional dedicated audio connection. An audio interface 1520 is shown for controlling a headset 1522 (wired or wireless with speaker and microphone) or separate audio elements 1524 comprising a speaker 1526 and microphone 1528.

An RF amplifier 1530 with external antenna can augment the range of the wireless unit as it amplifies the radio frequency power.

A GPS 1532 within the vehicle (i.e. car, boat, aircraft, or less preferably a structure) that retains the cellular phone, is connected to the cellular phone and configured for communicating the necessary coordinate data to the unit. In addition information from moving maps 1533 and so forth can be communicated to the handset, such as when the driver is communicating coordinates to persons at a remote location. For example the driver may locate position on a map which they wish to convey to the far end party they are talking to on the phone. They can elect to transfer data about the coordinate to the far end party wherein the GPS information is passed through the data interface and transmitted through phone 1512 to the far end and displayed.

Vehicle data 1534 can be transmitted through interface 1518, such as in response to automated toll systems charged through the phone, transmitting accident information for emergency personnel and so forth.

A database 1536 is shown that may contain information for moving map 1533, or other data that may be shared over the phone, including a contact list database.

A central processing unit preferably orchestrates the operations of the separate elements to work seamlessly with one another.

### Auxiliary Personal Computer Controls

### (Category: Transportation Subcategory: EnhancedVehicleWirelessSvcs)

24.1 Description

To provide additional means for controlling a computer using existing devices. Numerous different methods exist for controlling a computer and inputting information into the computer. These methods arose to speed computing because keyboard input is often a slow process for controlling the computer. Aspects of the present invention provide a number of methods for enhancing computer input.

### 24.1.1 Using a Personal Portable Device as an Input Device.

One must maintain their personal portable device, such as a PDA, in a state of charge and in the case of a PDA, or similar, it should be synchronized with one or more computers. The present invention utilizes the personal portable device as an auxiliary interface for a computer to which it is connected. The device may be coupled to the computer in a number of different ways.

### 24.1.2 Power Plane Coupled Devices.

A device that forms charge connections to the device when it is set on the power plane in almost any location. The power plane is configured to sense where the device is located wherein it can apply a correct charging voltage at any appropriate location on the power plane.

Two general types of power planes exist: (1) contact-based, (2) remote power from inductive or capacitive charging.

The power plane can be configured to sense the position of the personal portable device. In a connection-based power plane the contacts are switched on based on the position that the device is placed on the power plane. The position is registered and can be communicated back to the computer. Moving the personal device can be sensed in a manner to provide a mouse function, wherein the user can control aspects of the computer in a similar manner as using a mouse. Similarly, in a remote power based system, such as inductive, the location can be similarly sensed by either actively applying small amounts of power across selective areas to form a “challenge” and listening for a response.

Data can be communicated across either type of power plane. Controls and inputs on the personal portable device can be communicated through the power plane back to the computer. The inputs on the device may be utilized for controlling the computer or collecting input to the computer. For example, keys, icons, microphones, cameras, bio-metric sensing (fingerprint scan, retina scan) finger motion sensing, and other forms of input may be utilized and coupled back to the computer to control a computer session.

### 24.1.3 RF Coupled Devices.

A personal portable device may communicate with the computer via an RF link.

### 24.1.4 Operations of Device for Augmenting Operations.

Auxiliary display of notes, reference material, paste buffer(s). The programming for controlling augmentation allows the user to define a portion of the screen which is then displayed on the personal device, while the user moves off to other screens.

Icon selection of applications or macros. The programming allows a set of icons to be selected for display on the personal device, such as in response to a configuration process. During use the programming maps the display of the icons on the personal device to the action that is to take place on the computer system, thereby providing simple way of automating application selection. Similarly, macros may be attached to icons, or otherwise displayed on the personal device to allow the user to readily access the macros, which may be displayed with descriptive text if desired.

An input device (i.e. camera, microphone, handwriting drawing). The input portions of the personal device, such as camera, microphone, stylus pad, may be utilized for inputting information to the computer, wherein the programming provides communicating of the data between the personal device and the computer.

A personal identifier. The personal device is kept on the person generally at all times and can therefore communicate a personal identifier to the computer to authorize access to sensitive information. For example upon pressing a function on the personal device, a password is transmitted to the computer which unlocks one or more security layers allowing the user access.

It should be appreciated that programming within the computer is configured with parameters set for each specific personal device that take into account the attributes of the specific personal device, such as to screen size, type, input keys, functions available, audio capability, operating system, and so forth. The parameters are read by the computer during configuration allowing the computer to make maximum use of the personal device.

### 24.1.5 Similar Concept Different Embodiment:

Mouse (term mouse utilized for convenience, however, function may apply to trackballs, touch-pads, and so forth) for use on a “wireless” power-supply, such as a power supply plane (active connective, inductive, and so forth). Can be utilized without wires: (1) power being transferred to the mouse, and (2) position information is registered by the power-supply or the mouse in reference to signals from the power-supply which is communicated back to the computer. Power to the mouse may be intermittent, wherein the mouse will provide an energy storage means, such as a capacitor, or battery. A preferred implementation utilizes a super-capacitor for retaining power when between connections of the power-supply or otherwise when power is temporarily interrupted.

The mouse can emit warnings when power has been interrupted for an extended period of time. Furthermore, the mouse can provide location feedback for use on a discrete positioning power-plane, so that the user is alerted to position the unit to receive power prior based on cessation of operation and preferably prior the hand of the user being removed from the mouse.

It will be appreciated that this aspect of the invention describes a method of utilizing a personal electronic device for controlling aspects of a computer to which it can communicate according to the description of the present invention.

### Bands on the Net

### (Category: Music, Internet Subcategory: BandsOnTheNet)

Incorporated herein by reference are provisional application Ser. No. 60/394,160 filed Jul. 1, 2002 in a section describing a “Video Cloaking” and another section describing “Stage Cueing”.

25.1 Description

Facilitating band interaction over networks, such as the internet. A suite of tools for allowing bands to practice, compete, give a concert remotely, or market their music. Allows bands to distribute live content. The system also provides real time connectivity for band members wherein they can practice from their own residences but hear the combination and interactively jam. The multiple feeds from separate band members is combined together into a seamless performance output to each member, and others if desired. The band can “publish” content in real time allowing those interested to watch rehearsals and such in a raw form. A mixer within the system allows controlling how the different feeds are mixed; preferably both in terms of audio and video. Each band member can select own mixing attributes, or one selected for the whole group. Optionally, another party at another location can perform real time mixing of the content seen by the band members.

A number of aspects are described:

Multiple feeds to each band member.

Lyric text on screen. Lyrics displayed automatically synchronized with the score in relation to the feed being received from the band members (live or canned). A DSP circuit can readily maintain this synchronization and interact with a computer that stores the music tracks.

Live Internet concerts—free or audience can electronically pay to watch.

Separate feeds preferably stored as separate synchronized channels, although a combination may be mixed and saved for distribution or other purposes. Separate storage allows members to be dropped out for practice sessions and the like.

Band members can remain at home but practice as a group.

Mixer at one or at each spot, or remote.

User can get video from one or more feeds.

Combine with video cloaking to rewrite backgrounds.

On-screen timing (optional) to aid keeping band in synch.

Playing of canned track (i.e. beat) for band to synchronize on, or to bring in an additional party such as a missing band member.

Band member triggering of canned tracks.

Record other players and fill in with own riff. Can change it with each practice. During an individual practice session, members of band can play back all but their own part of the music—allowing them to practice a given piece while hearing the rest the band playing that piece in a canned format.

Mixing of inputs and selection of which inputs active, such as microphones for vocal tracks, can be programmed or selected on the fly based on user inputs (i.e. input sensors, keyboards, voice command, touch sensitive microphones). Programming allows inputs and mixing synched to the music set to change mixing automatically in response to the music.

Music Responsive mixing—mixing can be created as a musically responsive program. The program may be created by writing it, by storing manual mixing for a given piece, by setting sets of parameters and music related timing, by making notations on a computer stored musical score, or by combinations thereof. The user can in this way rely on prestored mixes for a given piece or may program new mixes. Old mixes may be modified to try new approaches and such. The programmed mixing is generally performed based on non-temporal elements, such as based on the mixing program keeping track of where the musicians are in the score, and not on temporal conditions such as time since start of piece. Furthermore, elements such as volume on each element may be set using relative criterion, such as percentages wherein absolute setting (which require interactively adjusting each input feed) is no longer necessary. Enveloping parameters also can be used wherein the volume or shape (frequency bending, shifting, and so forth) are controlled automatically based on programmed settings.

System generally comprises a network enable computer having audio input, audio output, video output, and optionally video inputs, and at least one user input device, such as keyboard, trackball, mouse, and so forth. Programming configured for execution on the personal computer system performs the majority of the functionality provided.

Audio and optionally video is fed from each band member active at the time to all other band members. The systems negotiate a simple synchronization timing pattern, that is similar to persons on a combat mission synchronizing their watches with one another. In this case any arbitrary time is selected and agreed upon, or a base line time is established at the start of playing. Optionally incorporating a timestamp receiver based on atomic time, is a preferred way to synchronize the systems. A time value recognized on the other systems (agreed upon) is passed within the audio stream data over the network, wherein the received feeds can be properly matched up despite differences in transmission delays between members of the band connected at different locations.

A programmable mixer routine within the application is configured to receive inputs, preferably including video feed, from each designated active band member and to combine them according to settings established by one member or more members or as a standard for all members. The mixer is displayed on the PC along with other controls for setting the overall sounds at each band position.

The system stores tracks from prior sessions for each band member and piece separately, wherein the canned performance tracks can be mixed with live feed for practice sessions when one or more band member is not available. A band member may practice by themselves but with real live feed.

Preferably the system includes DSP audio synchronization routines that allow canned audio to be maintained in synchronization with the users playing wherein the user need follow the tempo of a canned track, and wherein canned tracks from different sessions can be mixed into a single session.

Lyrics and optionally the notes (or timing) for each song are preferably stored within a repertoire section for the band wherein data for each tune is stored, such as preferably in separate folders. Furthermore, the programming is configured to display the lyrics for the song in accompaniment to the music, such as using the DSP audio synchronization routines. The lyrics are preferably displayed with a marker on the appropriate section of music and/or text.

A canned track can be used to synchronize playback at the user discretion.

The system may be implemented as program code that is loadable on a sound card, or a computer system having a soundcard, wherein the program code is executable on the computer system. The program can be distributed as functions for use with the sound card.

### Method and System of Simulating Handwriting in Documents

### (Category: Computers Subcategory: SimHandwriting)

26.1 Background

It is often desirable to provide the appearance of a handwriting to a document that is retained as character codes, such as ASCII codes retained within a computer associated with a document being written or edited with a word processor or other computer application configured for generating a text output.

Users can currently select from any of different fonts to which their character codes may be mapped when converting the retained character information into a displayed or printed document. The user may even have a font created based upon their handwriting style.

26.2 Description

Provide a method and system for generating simulated handwriting from a document retained as character codes, such as ASCII. The present invention recognizes that the use of various fonts, including those based on the users own handwriting, still does not appear handwritten and appears as fake handwriting. This problem arises from having every instance of a given character appear in a given format according to the font selected. The use of ones own handwriting for a font in many cases appears less authentic because the unusual twists or turns within a given character is duplicated for every such character. Therefore, users rarely bother to create and utilize fonts based on their own handwriting or printing.

By contrast the character coding for simulated handwriting within the present invention allows the user to code variable characteristics into the presentation of the document.

Current systems display each text character as it is found in a bit mapped font. The present invention, however, creates or modifies the displayed writing based on writing characteristics from templates or from actual writing samples. The characteristics include use specific characteristics, such as the difference in formation of different characters based on what the former string of characters included, and other parameters.

The system may comprise a routine, or application, that is executable on a computer system capable of displaying and/or printing documents. The programming of the present invention may be included within a computer readable media that may be read in by a computer, such as in loading the application, or the routine embedded within another application.

The program has access to different sets of characteristics that are retained for different writing styles. These characteristics extend beyond the character by character fonts and describe aspects of the writing style as a whole for application in simulating handwriting and printing. Presentation of text can take on the style of actual writing because character formation is responsive to nearby characters and positioning, as well as randomized and/or sequenced variation in style, smoothness, flourishes, and other stylistic elements found in handwriting. The system can utilize the characteristics in a number of ways for converting character coded information into simulated handwriting.

(1) Characteristics are used to select which font, within a related family of fonts used for representing a given set of writing, is to be used for each character.

(2) Characteristics are applied over one selected base font to modify the font with the selected set of characteristics. This approach has an advantage of allowing the text to displayed in a similar font for editing, which can then be modified one or more times based on one or more sets of writing characteristics applied until the result is pleasing to the user.

(3) Characteristics are applied over a combination of different fonts. These percentage flow between fonts can be fixed or vary in response to characteristics, positioning in the document, or randomly.

(4) Characteristics include a specification for how to form characters which are formed mathematically before being added to the result document image. This mode could be thought of as a vector mode wherein the characters are written by a vector manipulation routine based on the characteristics the incrementally “writes” the character as lines formed on the basis of the characteristics. This mode can create the most authentic simulations as it can actually perform the handwriting based on the character codes received. In essence this modes uses a simulated hand to write or print the output based on the writing characteristics selected. The output may be a bit-mapped output or a vector output, such as including control points and curve information.

(5) Combinations of the above approaches along with additional variations may be added to generate the different writing.

The above simulated writing routines generate an output that may be utilized by the printer or other output device. Typically the output is bit-mapped, however, it may be formed as a vector map, or any other convenient rendition form. Characteristics are described below by way of example, it should be appreciated that a number of characteristics of writing are known and that handwriting analysis has been a topic for many years, wherein there are great number of ways to characterize handwriting, any or all of which may be utilized within the present invention to generate the characteristics upon which the writing is to be based.

Example Parameters (by way of example):

Prior character —what character and where was exit point and curve path at exit.

Next character —what character and where was exit point and curve path at exit.

Word —what is the meaning of the word (i.e. “love” in the style may be represented with specific forms of flourishes not generally found elsewhere).

Sentence tone —the meaning inferred from the sentence allows determining the tone of the sentence upon which aspects of the writing style are based.

Location —what's the location of present letter in a word, sentence.

Smoothness —control points per length along the path of the writing.

Flourish —the type, extent, and variation on flourishes which do not represent character but merely add artistic elements to the writing.

Random variations —what randomized variations occur in a given letter.

Any emphasis —is the text to be emphasized (encoding of bolding, and so forth).

The creation of a “handwriting style” or “printing style” comprises the following general steps.

(1) User prompted to copy a set of text in their own handwriting. The lines are to be written to convey certain tones and meaning, in other words the writer is to write them as if they really mean what is being written. The text being selected to substantially include the characteristics upon which the writing style is to be based. For example providing a range of types of transitions between cursive characters.

(2) The handwriting is then scanned and analyzed in relation to the text upon which it was based to create a set of characteristics that allow vector creation of the handwriting or a base font is created upon which the characteristic elements are imposed. Heuristics, neural net, signal processing, handwriting analysis, along with other techniques and variations may be utilized for characterizing the written text. Alternatively, an extended character set may be provided to span a range of characteristics for each character, for example, a family of fonts wherein a given letter may be selected from the family based on characteristics.

(3) Samples may then be generated of the writing based on different situations wherein the characteristics may be user refined. If the user is happy with the output they move on, or they may input more samples of writing under these conditions to enhance the characteristic data base. For example, the writings of an individual, such as Benjamin Franklin or Leonardo DaVinci could be input to the system in association with a textual input and meaning information, wherein subject to enough writings the system would have a number of characteristics on which to simulate their writing.

When the document is to be presented, such as on-screen or on a printer, the characteristics can be invoked to properly render simulated handwriting. In one approach a base font is displayed while the user edits the document. When they want it rendered for printing, display in a bit file or other form of rendering, they can invoke the program to modify the document. The user can invoke the fixed characteristics for the given font and may modulate the effects of different aspects, such as using a control panel (i.e. the amount of flourish could be selected from a range of flourish levels). The user could also select combinations of different styles to use when converting the text. The selected characteristics are preferably saved for later use with the document or in general. The user can return to edit the document in standard, single font, form at any time, and may preview the stylized handwriting again at any time applying any desired characteristics.

Furthermore, the writer may choose to indicate other nuances within the writing such as emotions. They can preferably select a portion of text and indicate what emotions should be conveyed, wherein the characteristics of the writing are selected based on that emotion. This allows the user to refine the simulated writing to suit what they are attempting to convey. As previously, stated this information may be retained for use in other situations, wherein the simulated handwriting may be refined to any desired level of precision.

It should be appreciated, that even a simple set of characteristics utilized within the context of the present invention can greatly enhance the appearance of simulated handwriting and hand printing, wherein the depth of characterization described above need not be performed.

It should be appreciated that aspects of the present invention describe a method of converting text to computer simulated handwriting having variability extending beyond a font based decoding of characters, as described herein.

### Light Model Aircraft Controls

### (Category: Robotics Subcategory: NanoRC)

27.1 Background

Traditionally the radio controls that have been used for directing small aircraft flight patterns have relied upon servo-mechanisms that have a motor coupled to a set of gearing, a feedback potentiometer detecting servo position, and control logic that operates the motor in response to the difference between the desired position as input by the user and the actual (present) servo position.

However, these servo devices are heavy which limits the size of aircraft upon which they may be used. Therefore a need exists for light weight servos and receivers for driving those servos based on user inputs.

27.2 Description

To provide control inputs to a model aircraft with minimal weight penalty. Using low weight actuators for controlling micro-flight or other very light aircraft. The light weight servo devices are preferably integrated with the receiver to reduce overall weight. The servos designs herein eschew the use of traditional motors.

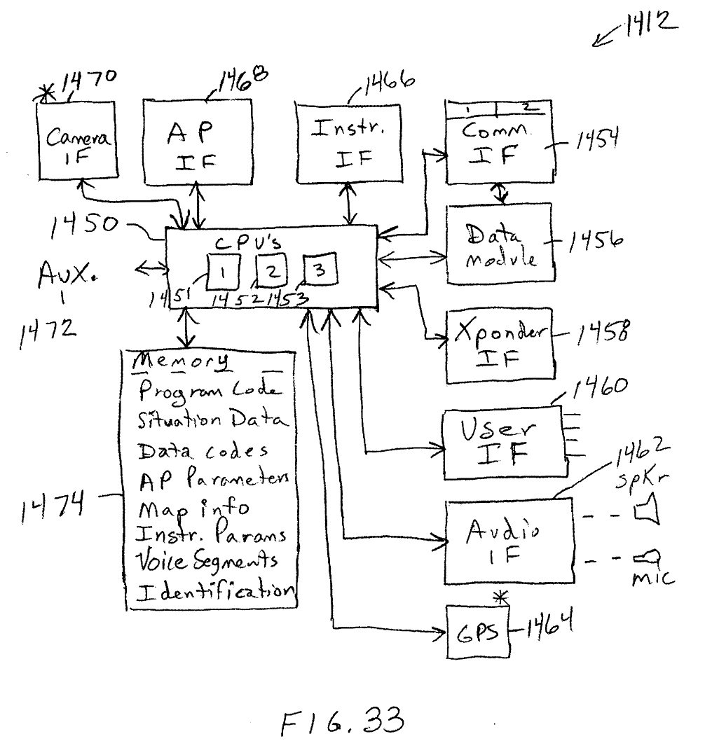

FIG. 35 depicts a piezoelectric servo 1610. A piezoelectric material 1612 configured to flex in response to a sufficient electrical pulse is configured with a edge for catching the teeth of gear 1614 in either a first or second direction of rotation. It will be appreciated that piezo electric actuators of this form are available.

An output shaft 1616 is attached to gear 1614 for coupling the motion ratcheting surface wherein a small piezo electric stepping “motor” device is coupled to a take up spool of output shaft 1616 that is connected to one or more threads 1618 in tension to a horn 1620 on a movable portion 1622 of control surface 1624.

It will be appreciated that a single thread in tension against a surface biased to oppose the pull of the thread can effectively couple movement of the thread into control surface motion. Additionally a pair of opposing threads may be utilized, such as from adjacent spools, to simultaneously push and pull on the control surface in different directions. For example actuators may comprise muscle wire, piezo-electric actuators, and so forth.

Operation of the servo only requires that pulses be generated in either a first or second direction, and that the receiver maintain a count of the number of pulses that have been issued in each direction to maintain a reference in relation to a center value. In this way the weight and complexity of a position feedback system are eliminated on the present design. For example, the following is a general flowchart illustrating operation of the receiver.

1. Initialize position to zero at power up (requires user to set position if not at zero).

2. Register RF data input.

3. Extract data for single channel as a step count (may be multiplied if desired to reduce data requirements, but then less positional accuracy obtained).

4. Step motor according to step count, with count sign determining direction.

5. Repeat steps 3 and 4 for each channel.

6. Return to step 2.

It will be appreciated that a simple low-cost microcontroller, such as an eight bit controller can execute the above steps easily, or it may be implemented as a digital logic element.

It is preferable that the actuator assembly to mounted on a on the radio frequency receiver, thereby saving the weight of additional housings and interconnect wiring.

Optionally the piezoelectric element is configured to simultaneous generate audio at the discretion of the user, such as set by configuration, based on the rates and patterns at which the steps pulses are generated by the receiver to the piezo electric device.

FIG. 36 illustrates an example of muscle wire surface control 1630, wherein a radio control receiver 1632 having batteries (or capacitors) along with RF and decoding circuits 1636 is configured for actuating control surfaces with muscle wire.

Pairs of connectors 1637a, 1637b, along with 1639a, 1639b, are configured for engaging muscle wire loops whose end pairs are 1638a, 1638b, and 1640a, 1640b. The connectors preferably allow the slack of the wire to be readily taken up, such as a press connector through the PCB of the receiver, wherein the connector is pressed while the wire is tensioned and released when at the proper tension to hold the wire with the excess extending on the opposing side of the board where it cannot short out circuitry. Muscle wire may comprise any suitable shape memory material that can change phase based on passing a current through a thread shaped section of the material. For example, Nitinol, or similar alloys or newer polymeric muscle fibers.

It should be appreciated that polymeric muscles are now becoming available which are expected to provide improved operation at lower weight. It may be preferable to sheath the muscle wires as described elsewhere in this application depending on the connection and existence of routing obstacles toward the control surface.

The muscle wires are connected to the power drive of the receiver. Each muscle wire, which may be from approximately 2 to 15 thousands of an inch in diameter, is looped through a control surface horn, one being shown for rudder and one for elevator, although more or less control surfaces may be controlled.

A potentiometer associated with each loop of muscle wire is connected to the receiver for setting the maximum contraction corresponding to full control surface deflection. For example, after installation of the receiver and muscle wire through the control horns, or other deflection structures, the potentiometers are set for a safe (low value) for example counterclockwise. The receiver is then switched into a full-scale test mode wherein it deflects each control surface (simultaneously or separately), allowing the user to adjust the deflection by turning each potentiometer for maximum desired deflection. After this adjustment, the unit may be taken from test mode and utilized. The extreme low weight of the unit makes it ideal for controlling light indoor model aircraft, dirigibles, and so forth. It should be appreciated that other mechanisms may be utilized for adjusting full deflection without departing from the teachings of the present invention.

The loop of muscle wire may also be replaced with a loop of material that contains a section of muscle wire and a section of another conductive wire that has an opposite temperature coefficient within the ambient range, wherein relaxed state fluctuations in control surface settings as a result of temperature fluctuations are minimized.

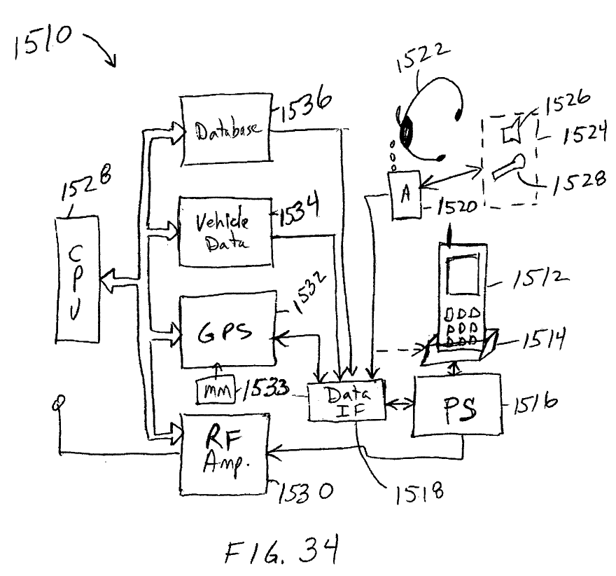

FIG. 37 depicts a simple dethermalizer or flight control for small aircraft 1670, (or for other purposes) which may be implemented using muscle wire with a small charge source. A battery 1672, or capacitor (i.e. 0.003F), is coupled to a very thin section of muscle wire 1678 (typically from a couple thousandths of an inch in diameter up to a few tens of thousandths in diameter) through a fixed connection 1674 and a removable connection 1674 that can operate as an on/off switch. The connections 1674,1676 preferably allow the amount of muscle wire to be adjusted for controlling the maximum control surface deflection in response to battery current passing through the wire.

A control thread 1680 connects between the muscle wire and through the attachment point (i.e. hole) 1688 in control horn 1686 which controls the position of movable portion 1684 of control surface 1682. The movable portion being biased away from the direction of control horn travel, such as represented by bias load 1690, which may be implemented with spring hinges, live hinges, or elastic threads attached to a control horn on the opposing side of the control surface.

In operation the user connects the removable connector 1674 which causes the muscle wire to contract providing the desired first level of deflection. As the battery wears down the amount of deflection created by the muscle wire diminishes. This A very fine strand of muscle wire is connected to a charge source, such as a battery or capacitor, through a resistor and a switch. Upon being activated the muscle wire contracts and then slowly relaxes as the charge is depleted on the battery. The result is a smooth transition of actuation from a first setting to a second setting. The capacity of the battery and the size of the muscle wire utilized determine the timing of the deflection changes.

It should be appreciated that many similar embodiments may be created by one of ordinary skill in the art without departing from the teachings herein.

The embodiment may be utilized in numerous applications, such as for small model aircraft control including dethermalizers, flight control for indoor models, and so forth.

Connected the muscle wire end to end with a wire having reverse temp coefficients of the muscle wire, therefore the setting does not change in response to temp changes. Alternatively a clamping arrangement can be used on muscle wire and set it just prior to use, then unclamp during storage.

### Self Powered Remote Sensors

### (Category. Industrial Subcategory: Self PoweredSensors)

Incorporated herein by reference are:

Provisional application Ser. No. 60/394,160 filed Jul. 1, 2002 in a section describing a “Reception Sentry”;

Provisional application Ser. No. 60/413,199 filed Sep. 23, 2002 describing additional aspects of the reception sentry invention; and

Regular utility patent application Ser. No. 10/279,480 filed Oct. 23, 2002 describing RFID devices.

28.1 Description

A self-powered sensor configured to remotely transmit information in response to a sensed condition while being powered from that same condition or another condition that preferably occurs at the same time as the sensed conditions.

By way of example and not of limitation, such as a piezo-electric sensor, is coupled to a transmitter, such as the transmitting portion of a transducer. The result is a self-powered sensor that transmits information to a remote location.

One example of this type of sensor is a security floor sensor, that can transmit the presence of activity to a receiver associated with a security system. In this way there need be no wiring connections, while the need to maintain batteries within the sensor unit are eliminated.

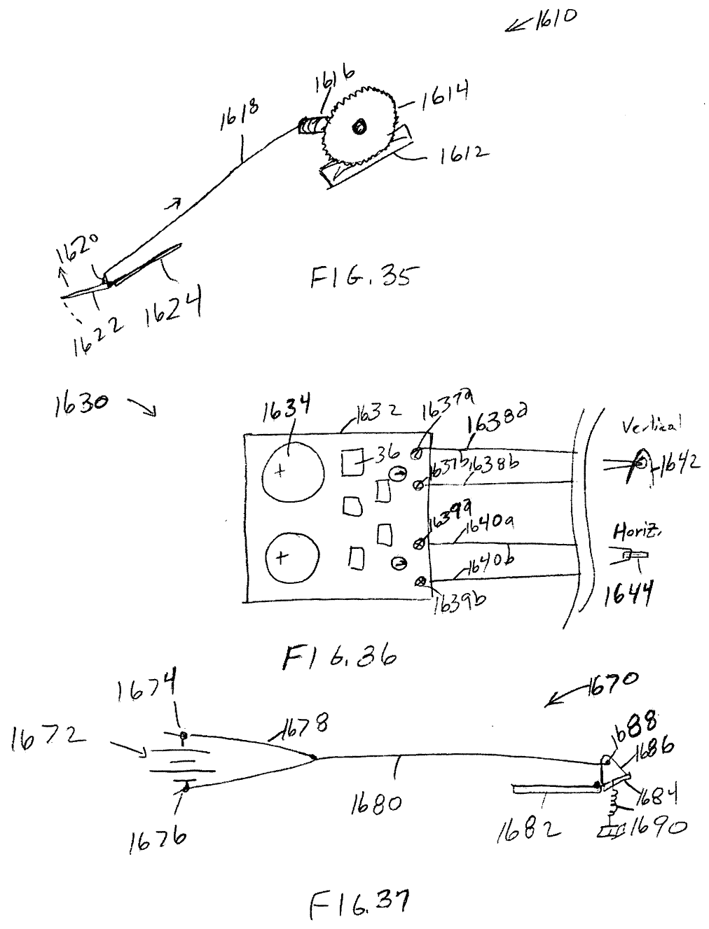

FIG. 38 depicts an example of a security floor sensor 1710 shown upside-down with tapered edges (optional) and a raised central section 1714. It should be appreciated that the floor sensor need not be raised if the floor beneath the unit is sufficiently compliant wherein stepping on the mat deflects the piezoelectric material sufficiently to generate the desired signal output. A first piezo electric sense ring 1716 and a second ring 1718 are shown connected to a low power transmitter circuit 1720 with unique ID 1721 for communicating to nearby receiver 1722 for detecting intruders.

As the intruder steps on mat 1710, the piezo electric material 1716,1718 is deflected generating a sufficient voltage wherein the transmitter 1720 is activated and generates a preprogrammed or user selected ID value to receiver 1722, which for example can annunciate an alarm.

The sensor may utilize other forms of sensing, such as movement, temperature, chemical properties (i.e. cell pH), level of impinging light, and so forth.

The unit may alternatively or additionally utilize solar cells or other forms of generated power to charge a capacitor or rechargeable battery, wherein the power from the sensor may be used for triggering operation, wherein its energy need not be utilized if sufficient power is stored on the charge storage device.

### System for Stabilizing Aircraft Flight Pattern

### (Category: Robotics Subcategory: FlightRPVSenseStable)

29.1 Background

Aircraft flight attitude and altitude are subject to the flow of the air currents. Even large aircraft can be jostled about by turbulence, while the flight pattern of small aircraft can be severely impacted.

As remotely piloted aircraft vehicles (RPVs) are being increasingly utilized for reconnaissance, recon-in-force, or even combat (UCAV), the problematic effects of air currents are being seen. The ability to produce small lightweight RPVs is particularly challenging as even small wind gusts and turbulence can severely effect the flight path and aircraft operations.

The present invention solves many of these problems and may be implemented in any sized aircraft, from miniature remotely piloted systems to large aircraft autopilot systems.

29.2 Summary and Abstract

System for Stabilizing Aircraft Flight Pattern by determining air patterns prior to which the aircraft is about to be subject. %

Aircraft flight control is described which detects external conditions and motion of the atmosphere which occur prior to a resultant change in aircraft attitude. The systems utilize digital signal processing for detecting wave fronts and air movement, from which estimates on the attitude effect on the aircraft are computed. In response to which the control surfaces are deflected just in advance of the condition so that the aircraft attitude can be retained in a more stable state.

The present invention describes the use of lasers and sense whiskers for detecting the pressure gradients external to the aircraft. It should be appreciated that other systems for sensing the motion and pressure gradients within the atmosphere near the aircraft may be utilized without departing from the teachings of the present invention.

29.3 Description

FIG. 39 illustrates by way of example a small remotely piloted aircraft 1810 having wings 1812, and fuselage 1814. Lasers 1816 are coupled to the airframe directed generally forward in the direction of flight and modulated so that pattern detected in the reflections can be matched with the proper portions of the transmitted signal to arrive at a reflective distance measure. The lasers preferably sweep a conical area that takes into account possible directions of aircraft travel. A series of optical detectors 1817 are configured for registering the directional light reflecting from the air from lasers 1816. The reflected light intensity pattern can indicate the density of air at that region in space, It will be appreciated that the laser wavelength may be set to any desired range or sweep of frequencies depending on time of day and atmospheric conditions.

The data is processed by digital signal processing system 1818 and evaluated by the flight computer 1820 which estimates the effect over time and can change control deflections, engine operation and so forth to compensate to maintain greater aircraft stability.

A second form of sensor is shown in FIG. 39 with flex sensing whiskers 1822, such as formed with carbon fiber strands having a piezoelectric core that generates a voltage in response to the amount of deflection. It should be appreciated that the aircraft having a finite mass is not subject to immediate deflection of attitude in response to air pattern changes, wherein in many situations, particularly at slower speeds, the air patterns about the aircraft can be sensed to determine the air pattern before a measurable attitude change takes place. The whiskers 1822 have the advantage of being less expensive and easier to install and an entire network of them may be configured to generate information in a serial configuration to the controller.

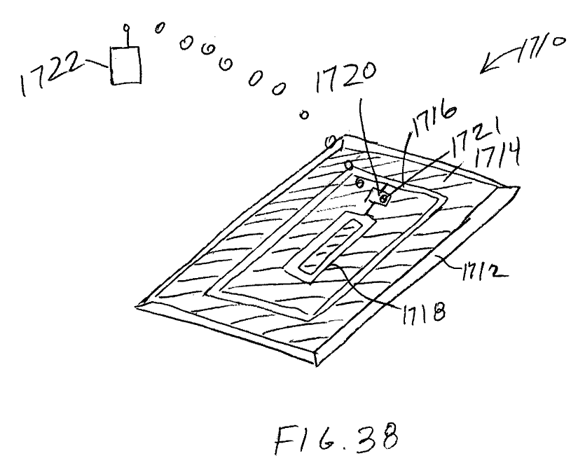

FIG. 40 depicts a block diagram of the system, with transmitters 1816, receivers 1817, signal processing 1818 and flight direction 1820. The laser outputs are controlled by transmitter interfaces 1826, while the receiver inputs are decoded and conditioned by a receiver interface 1828. Once conditioned, the transmit and receiver are preferably correlated in the analog domain primarily due to their high speed, to reduce the data rate to a manageable level. The correlation data between send and sense is then converted to the digital domain through A/D converters 1832 to a digital signal processor 1834 that continuously executes atmospheric analysis algorithms to estimate upcoming changes in the atmosphere that will be flown through. Air data 1836 and flight data 1838 are constantly communicated to the signal processing sections. Relative aircraft heading in relation to the sensor data is preferably constantly maintained as a parameter for the analog and/or DSP processing to reduce the computational overhead associated with plotting multiple desired flight paths.

The resultant estimates are then passed to the control processor 1840 of the flight control system which again can utilize air data 1838 and flight data 1838 in determining its response. The flight controls for power 1842, rudder 1844, elevator 1846, aileron 1848 are modulated in response to the estimations in view of intended aircraft flight path wherein the aircraft flight path is further stabilized.

It should be appreciated that the whiskers 1822 of FIG. 39 may be utilized in place of the optical detection elements described in FIG. 40.

### Flight Stabilizing System

### (Category: Robotics Subcategory: FlightStableAugment)

30.1 Background

When a pilot has the controls of the aircraft in unstable air, they must often be continually modulating the ailerons, elevator, and at times the rudder and engine controls to maintain a desired altitude, heading, and attitude, while attempting to maintain a generally smooth flight.

If the aircraft is equipped with an autopilot this can be used, but then the pilot can not easily modify the flight path as desired.

The present invention is particularly well suited for use in aiding the pilot by reducing control overhead, while it may also be utilized in conjunction with or as a rudimentary autopilot.

30.2 Description

To reduce pilot overhead in compensating for air current conditions. Implementation. It may be implemented as a separate unit, incorporated as a mode within an autopilot system, coupled to an autopilot system, or it may be implemented to function as a rudimentary autopilot system itself.

A preferred means of coupling the device into the control system is by way of a “soft linkage”. This linkage from the controls to a control surface is still connected by conventional mechanical linkage, however, an actuator is coupled within it to provide a limited amount of control authority. In this way, even if the system went haywire or completely inoperative, the pilot would not be subject to a loss of control.

System can be coupled to the detection systems described above for determining the air pattern conditions before the aircraft attitude is significantly altered by those conditions, wherein correction may be provided more readily.

For a less expensive implementation the system is preferably configured to detect slight attitude changes such as pitch and roll, wherein it compensates for small fluctuations while still providing control to the pilot. A two or three axis acceleration sensor may be utilized for detecting the small changes to the flight attitude. While it is preferable that pilot inputs be registered with sensors to assure proper and speedy detection of pilot input.

Features: Pilot may set a “smoothness” for the flight wherein the controls will damp out perturbations that exceed the level of smoothness (up to the given control authority).

Smoothness alerts: pilot may preferably be able to utilize the smoothness detection mechanism without the control aspects, wherein the system alerts them to the level of flying smoothness.

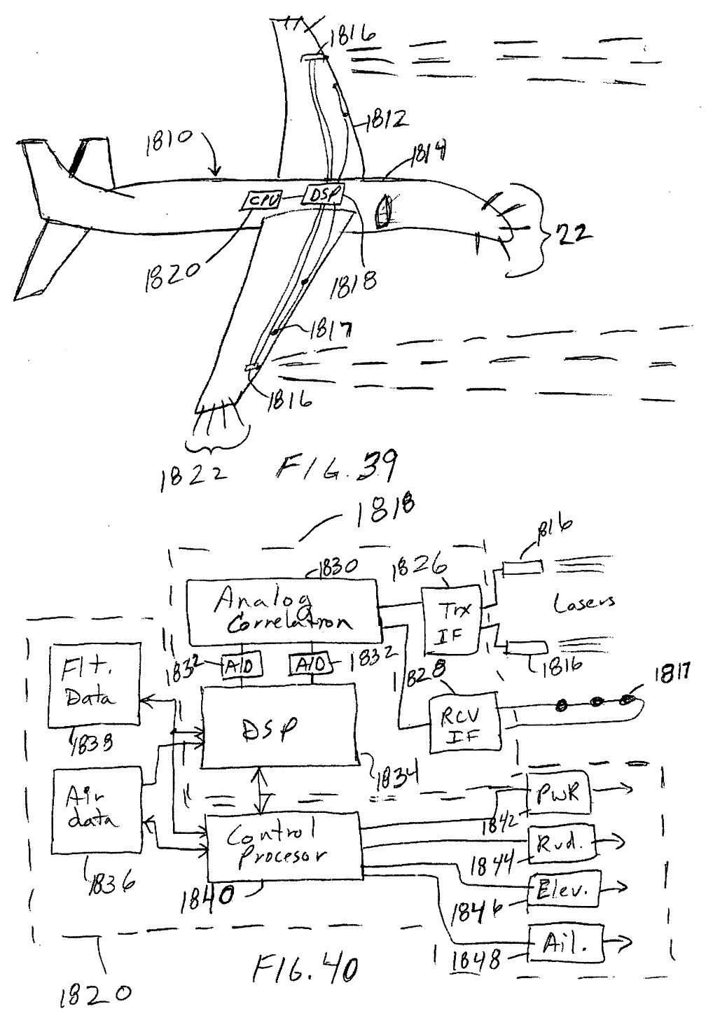

FIG. 41 illustrates a simple example of the flight stabilizing system 1910, depicting use on a single axis of an old style (WWI) flight stick 1912 with pivot 1914, handle 1916, and elevator attachment linkage 1918.

A stiff linkage 1920 extends back from stick 1912 to a soft linkage 1922 having an actuator 1924 with movable coupling 1926 to the rear portion 1928 of the stiff linkage connected to a horn 1930 on the movable portion 1932 (elevator) of the horizontal stabilizer. The soft linkage is preferably configured so that failures within the coupling should not result in the front and rear portions of the linkage becoming disconnected from one another, such as by using an integral housing that retains the two elements in place despite a motor or motor drive failure.

An acceleration sensor 1934 detects changes in attitude immediately as they occur, while a movement sensor 1936 detects pilot input to the stick. A control system 1938 correlates pilot stick movement with attitude changes. Small changes in flight attitude are damped as the control system 1938 modulates the actuator position within soft linkage 1922 to stabilize the flight, making it more enjoyable for the pilot and passengers.

### PopEye —Peripheral Vision Optical System

### (Category: Robotics Subcategory: PopEyes)

31.1 Description

To increase the field of view of an electronic imaging system without reducing resolution. Correction of aberrations on collected image is well known in the art. For example in astronomy the lens aberrations are corrected algorithmically. Recently they have been mapping the atmosphere with a laser to use in correcting the lens distortions from atmospheric effects.

In one demo for applying corrections a badly out of focus image is shown on the screen and then a wavy clear wavy (potato chip like shaped) is placed onto the projector which clears up the image.

Also certain Astronomical telescopes couple a plurality of CCDs to a surface and coupling them with fiber optic bundles to each section of the image plane. This allows images to be collected from each CCD in parallel while providing high resolution.

A vehicle may be equipped with multiple independent image collections systems. For example a first system comprising a pop-eye perspective camera and optionally a conventional camera, while a second system may comprise any desired image collection cameras, such as cameras for: visible light, ultraviolet, infrared, and cameras that provide perspective, zooming, panning, tracking.

Additional Aspects of Invention:

Couple a conventional lens into the system whose image is processed in conjunction with the pop-eye perspective lens. In this way the conventional camera can be used to pan and zoom to enhance definition on any portion of the image collected by the perspective camera. An indicator on the screen can indicate the direction the conventional camera is facing, for example with a cross-hairs.

Alternatively, or additionally, the conventional image may be shown on a separate screen, or on the same screen such as split screen, screen in screen and so forth. If zoomed then the surrounding areas about the zoomed field can be estimated by magnifying the images collected from the perspective camera an amount matching the zoom and then placing it about the zoomed area. In this way the zoomed section is shown in “context” with its surroundings. Panning the lens allows different areas to be viewed.

### Programmable Patterned LED

### (Category: Displays Subcategory: ProgPatternLED)

32.1 Background

Providing patterned outputs has generally required that a microprocessor or other sequential circuit be specifically configured for a given pattern and coupled to an output source device, such as LEDs, audio annunciators and similar. However, the circuit cost, assembly costs, size, and design costs are prohibitive for many applications.

32.2 Description

To provide a reprogrammable autonomous patterned output for LEDs, audio annunciators and the like. The present invention provides a device that automatically generates a varying output in response to a selectable programmed sequence. Although the description is primarily directed at an LED, such as containing red, green, and blue elements, the present invention may be implemented on other forms of LEDs and other light emitting indicators such as incandescent and electroluminescent, as well as for audio transducers, MEMs devices, and so forth.

The device can be programmed by putting it into a programming mode and then sending programming signals to it. For example the entry into programming mode can be detected in response to changing the input voltage or reversing the polarity of the input voltage, or a combination thereof. The data to be programmed into the static memory may be received electronically or optically. When received electronically it may be received over the power signals, or on one or more additional signal lines. When received as optical signals, it is preferably detected by the LED element operating as a light detector wherein the unit may be optically programmed to follow a sequence of light transitions.

The device can also be optionally configured to alter its output in response to ambient conditions, such as based on light, temperature, pressure, electric field strength, magnetic field strength, vibration, sound, and other externally sensed criterion, and combinations thereof. It should be appreciated that altering the output in response to these ambient conditions allows the unit to exhibit a series of personalities which convey aspects of the environment.

Considering light intensity responsiveness, the output of the unit shifts from one pattern to another in response to the light intensity detected. A simple example is the output of a different pattern at high ambient lighting conditions, than at low ambient lighting conditions. Light can be easily sensed with an LED element in an off state using it as a light detector, wherein the unit alternates between using the LED in input mode and in output mode. The other conditions may be detected by circuit elements inherent within the device, or elements added to the device for sensing the given condition.

The sensing of conditions can be coupled to higher order address bits (when the unit is in a non-programming mode) wherein the data being output is derived from a different portion of the static memory. For example, considering two light intensity conditions being sensed, a threshold bit from a circuit connected to the LED for registering high and low light intensity is coupled to the a high address bit of the memory, wherein data output from the first half of memory can correspond to low ambient lighting conditions, and output from the upper half of memory correspond to high ambient lighting conditions. Programming of the static memory may be performed under high ambient lighting to load the upper addresses, or low ambient lighting to load the lower addresses. Alternatively, the data may be loaded sequentially through the entire memory space by switching the high address line from an optical sense input to an upper bit of the address counter used for selecting input memory locations.

If multiple colors of light output are provided within the device, then it is capable of shifting through colors following any desired pattern. These patterns can be programmed from data input over the signal connections or via light input sensing or the sensing of other ambient characteristics.

FIG. 42 depicts a programmable pattern LED (PPLED) 2010 comprising an LED being driven 2012. A clock circuit 2014 with timing set by R and C drives counter 2016, whose ladder outputs drives addresses in a one bit serial non-volatile memory 2018 (i.e. FLASH). Output from the memory drives a MOSFET which switches high or low to control the state of LED 2012. The counter continues cycling through memory repeatedly according to the pattern loaded in the memory.

A programming circuit 2022 is configured for being triggered by a PGM signal, wherein the pattern on data line D is sequential loaded into the memory as a new pattern. Program data, or triggering may also be generated in response to variations in the light impinging on LED 2012 during short off times between each bit output. It will be appreciated that LED can be utilized for sensing light intensity when no forward current is forced through the junction.

It should be appreciated that optical outputs may be produced from the device aside from the use of LEDs. By way of example, incandescent lighting, electroluminescent lighting, organic LED lighting, electronic ink display output, LCD outputs, and so forth may be incorporated as the optical output. The circuits may be encapsulated with the optical output element. For example, the circuits may be embedded such as using polymer based circuit deposition, which can even be performed using ink jet printers and similar for depositing the circuit layers on a material forming the electronic ink display.

Another embodiment of this device comprises an electronic ink label configured to change the displayed output in response to a change in ambient conditions, for example an input pressure, temperature, acoustic energy, light energy, and so forth.

In a first embodiment an electronic ink region is sandwiched between and electrode grid for driving each area of electronic ink into at least a first or second optical display state in response to the electrical polarity and voltage applied between the electrodes. Coupled to the electronic ink region is a static memory whose output bits are configured to drive the display elements, such as one bit output for each row being driven and one bit for each column. For instance a small display may be arranged with 32 rows and 128 columns which would allow approximately 60 character on a total of 3 lines to be displayed, or graphics or other indicias and so forth. The memory may be configured with the desired width or utilize a serial to parallel converter means, such as a shift register to transform multiple output from sequential addresses to control the entire display.

The memory contains a series of patterns that may be displayed on the electronic ink. The selection of which sequence to display can be determined in a number of alternative ways. (1) temporal—the output of the display changes over time wherein the output changes from one pattern to another. (2) user input—in response to a user input, such as touch, changing light intensity, electric field, and so forth, the output of the display changes. It will be appreciated that the small display can allow the user to access a depth of information which essentially extends the capacity of the electronic ink display. For example a shelf tag may be implemented using the present invention, wherein it may display unit price in a first state and then either automatically, or in response to user input, display the price per unit weight, the calorie content, or other information about the product.

An electronic ink display does not require power for maintaining a given display output state, and power is only needed for programming the display to a new state.

Therefore, it the user input can be configured to generate the power necessary to change the display output. For example, a piezo electric switch input device can be included upon, or proximal to the electronic ink display, that converts the movement/pressure associated with a user pressing the piezo electric into power for operating the circuit for changing the display state. Preferably, a small amount of the current is stored for retaining information about the current state of the display (i.e. which panel of information from memory is being displayed), and optionally enough current to allow the display to revert back to a default output, such as after a given time after last being pressed.

Photo responsive regions may be incorporated with the apparatus, such as beneath a layer of electronic ink to generate a small electric current for driving the display apparatus. It will be appreciated that this current can be used to operate the unit continuously or to charge a storage device such as capacitor, for powering the display only when power is needed.

The display device may be programmed in a number of alternative ways. For example a set of contacts on the unit may be provided for selecting programming mode and for passing data into the device for storage onto the unit. To speed identification each display unit may be configured with it own ID wherein the programming unit polls the unit ID and then downloads information to the unit based on the unit ID. In the case of a store shelf tag the unit ID may comprise a SKU, or similar product identifier. When the information is to be changed it may be downloaded from a back office server to a PDA or similar. The PDA may then be contacted to each tag wherein it reads the SKU, finds the data associated with the SKU, downloads the new data to the tag, and indicates completion wherein the user may go on to the next one and so forth. The unit allows the changing of selected items, wherein the description for the item may be displayed on the programming device, such as PDA, to allow the user to locate the correct label, (i.e. “Duraflame® Four hour color firelog SKU 977 223 445”). The unit verifies the correct SKU before downloading and informs the user in case they have not located the correct tag.

Each tag apparatus may be optionally configured with a transponder device that allows the data to be downloaded remotely without establishing electrical connection with the tag. In this situation the challenge generated contains an ID, such as SKU, wherein only the correct label would respond and be downloaded with the new information. The labels could then be programmed from a series of output heads located about the store which are in sufficient proximity to allow programming of all available labels, or personnel could be dispatched to walk the aisles wherein the PDA unit could automatically make contact and download information to all the labels as needed. It will be appreciated that information would not need to be downloaded to labels that did not require changing.

The units may be additionally responsive to coded inputs by users for directing the automatic output of the units. For example, in view of the store labels described above for use in a grocery store. It will be appreciated that users have differing dietary needs, such as those that are diabetic, retain water due to heart conditions, or have allergies to specific ingredients and so forth. It is often difficult for these persons to qualify the large number of items within the store according to these criterion, as they must examine each carefully (if the information is available).

Therefore, the present invention can register the particular need of the consumer based on a specific user input and provide an automatic single or sequenced output in response thereto. For example, a transmitter card may be configured for the user with specific product selection criterion, needs, or limitations. The information can be transmitted from the card to nearby product labels, such as in the form of a coded challenge, wherein the local tags respond to the received information by adjusting their form of output accordingly. Such as listing the price with the sugar content or other information that suits the code or codes transmitted.

The transmitter cards may be programmed for indicating particular buying criterion or conditions in a number of ways. One method is providing a series of check box style links on the card which the user alters to select the purchase information that is most important to them. These check boxes may comprise electronic inputs whose state is changed based on the severing a conductive link, or alternatively adding a conductive ink or other conductive material to interconnect locations on the grid. A simple way to produce the cards is with a series of inputs connected in a known configuration portions of the conductors being accessible at checkbox regions wherein the user scratches off the conductive material to select the given buying conditions, such as sugar content, fat content, calories, salt content, unit cost, nutrition, and items to which the person may be allergic such as lactose, peanuts, MSG, and so forth. The card generates challenges in which the selection data is encoded for receipt within the tag. The displayed information is then changed in response to the transmitted data. The transmissions may occur continuously, such as hung from the users neck, to alter the priority of information display on the tags, or it may be transmitted only in response to user selection.

The device may alternatively be configured to autonomously generate audio sequences instead of light sequences. An audio annunciator can replace the LED element. The circuits may be fabricated directly upon a piezoelectric audio transducer to form an intelligent audio annunciator.

Aspects of the invention may be described as follows:

1. A light emitting diode device configured for generating a programmable light output, comprising:

a device housing whose exterior is configured with signal connections;

a lens attached to said device housing; and

a circuit enclosed within said device housing including, at least one light emitting diode element positioned beneath said lens, a current modulation element coupled to each of said light emitting diode element,

a static memory having an output coupled to each said current modulation element and configured for being externally programmed,

an address counter coupled to said static memory and configured for sequencing bits of static memory to said current modulation element for each of said light emitting diode,

a free running oscillator coupled to said counter and generating clocking for said counter.

2. A light emitting diode as recited in claim 1, wherein said signal connections comprise a power and ground connection.

3. A light emitting diode as recited in claim 1, wherein said signal connections comprise power, ground, and programming signal input.

4. A light emitting diode as recited in claim 1, wherein said current modulation element comprises a two-state current switching element.

5. A light emitting diode as recited in claim 1, wherein said current modulation element comprises a current switching device providing more than two states of output current.

6. A light emitting diode as recited in claim 5, wherein said current modulation element provides a pulse-width modulated output.

7. A light emitting diode as recited in claim 5, wherein said current modulation element provides an variable analog output in response to its input.

8. A light emitting diode as recited in claim 1, wherein at least two light emitting diodes are incorporated having different color outputs.

9. A light emitting diode as recited in claim 1, wherein said external programming of said static memory comprises: means for sensing a programming mode; and

means for loading received data into said static memory;

wherein upon sensing entry into programming mode the data received by said means for loading received data is loaded into said static memory.

10. A light emitting diode as recited in claim 1, wherein said means for sensing a programming mode comprises voltage polarity sensitive circuit which is configured to detect a voltage applied to the light emitting diode device in a reverse polarity direction.

11. A light emitting diode as recited in claim 1, wherein said means for sensing a programming mode comprises voltage threshold sensitive circuit which is configured to detect a voltage level change being applied to the light emitting diode device.

12. A light emitting diode as recited in claim 1, wherein said means of loading received data into said static memory comprises a mode of said address counter wherein clocking signals are derived from said received data.

### Smart Power Disruption Module

### (Category: Lighting Subcategory: LightingAfterGlow)

33.1 Background

Many devices, in particular electromechanical devices, utilize circuit breakers, fuses, and temp cutouts for open circuiting power if a dangerous condition arises. For example these devices are found in consumer devices, such as vacuum cleaners, paper shredders, hair dryers, and so forth as well as in numerous industrial devices.

Unfortunately, as current circuit disruption device designs are “dumb”, in that they are triggered in response to a single threshold (i.e. overcurrent, overvoltage, overheat) the power may be inadvertently discontinued when not warranted, or worse yet not disconnected under circumstances where a danger does exist.

33.2 Description

Simplify control of breakers and cutout circuits, while providing additional protection from fire and damage. The present invention describes intelligent power modules that may be programmed to disrupt power in response to more complex patterns or conditions sensed in the system. For example a smart power module may have inputs for motor current sensing, motion sensing, voltage sensing, temperature sensing, and safety switch sensing (although less or more conditions can be sensed without departing from the teachings of the present invention). The conditions being sensed can be dependent on one another, engaged when a condition is detected a given number of times, and so forth. Utilizing the smart power module the designer can build the device or system, test failure conditions and dangerous conditions, and THEN program a set of conditions and patterns under which power disruption is to occur.

Additionally, the smart power modules are preferably configured to generate power diagnostic information. The information is generated in response to a triggering of power disruption, and may preferably be generated for other sensed conditions that although not dangerous are indicative of conditions to which parties should be alerted. For example, motor current and heat for a shredder is getting high indicating that the unit needs to be lubricated. Of course the system can indicate very complex sets of conditions, such as may be found on an MRI (magnetic Resonance Imaging) system in which a large number of aspects of the machine may be monitored by the smart power module.

Additionally, the smart power module can be optionally configured to store information about device operation which may be utilized by the smart power module itself for detecting trends in operation, or the information may be communicated to service personnel, such as over a network link or during diagnostics, or the information may be utilized in a similar manner to a black box wherein historical information aids in determining failure causes.

Additionally, the invention comprises a method of programming the smart power module without the need of writing and assembling code. One method utilizes an emulator type unit that connects into the device in similar manner to the smart power module but with settable parameters and trigger conditions, for example sets of conditions of the inputs in relation to historical conditions. It is preferable that the emulator unit be hosted on a PC wherein the conditions may be established on the screen. The emulator can display waveforms and other information about the monitored conditions and aid the user in defining conditions for disconnecting power, and/or for performing other power related activities such as generating warnings, changing operating modes, and so forth. The “emulator” device, in response to the conditions established by the user, generates a file that may be utilized for programming the smart power modules (SPMs). The SPMs may be programmed utilizing any convenient programming method, such as mask programming, one-time programmable (OTP), rewritable programmed (i.e. FLASH), and so forth.

The rewritable SPMs may be reprogrammed based on new information about the conditions that arise in a given device. This is an important safeguard as dangerous conditions, or those that may damage the device or impair its functionality, are often only detected after a number of units have been sold, wherein a very expensive recall is often required because altering the power system or adding other devices for detecting the conditions is not an easy change with current system designs. This is particularly problematic on industrial and medical systems in which the designs are both more complex and subject to lower volume sale and thus are rarely subjected to the extensive forms of testing that consumer devices are subject to. The SPMs may be reprogrammed in-situ utilizing any form of communication link, wired, wireless, etc. For example the SPM may be reprogrammed over a wired connection on the device, such as may be utilized for communicating other information to the system. Another preferred form of reprogramming requires disconnecting the power to the unit and connecting a communication/power to the device. In this way the device receives a low level of power—typically insufficient to operate the device—but sufficient for communicating with and reprogramming the SPM. The SPM does not connect device power in response to a low operating voltage but can communicate information it has stored, communicate current programming or conditions, or be reprogrammed. By way of example, this form of connection could be implemented as a USB to three-prong 110VAC outlet connection. The USB power provides sufficient power and the module communicates serially over one or more of the three input lines to the SPM device.

The invention may be generally embodied as a power control module connecting external power to internal system power for a device. The smart power module may include a power supply to convert one power form to another, such as 110VAC to 12 VDC, or similar, although it may simply allow monitoring and disruption of a power transfer without the conversion. An embedded microcontroller is connected for modulating power control devices, such as a power cutout, in response to input conditions to the microcontroller matching preprogrammed conditions. The embedded controller, power control, and optional other circuits are configured to receive their own operating power despite power being disconnected by the smart power module into the device.

### Twin-Tip Spark Plug for Dual Ignition Systems

### (Category: Transportation Subcategory: TwinTipPlug)

34.1 Background

One common failure point of internal combustion engines is the electrical system. For this reason aircraft relying on internal combustion engines for flight power continue to utilize a dual ignition system in which two separate ignition systems are configured for created a generally simultaneous spark on two separate spark plugs within each piston.

Although a number of high reliability situations exist beside those in aircraft, these areas have been ignored due to the high cost of configuring the engine with a special head configured for receiving a second spark plug. Examples of other high reliability applications include snow mobiles, outboard engines, motorcycles, law enforcement vehicles, and any situation in which reducing the probability of engine failure would outweigh the additional cost factor.

Unfortunately, manufacturing a specialty engine head to provide high reliability is very expensive and requires a great deal of testing. Furthermore, newer engine designs now may have five valves per cylinder, leaving no room for introducing a second spark plug.

In particular, these drawbacks cause difficulties for manufacturers and builders of light aircraft. Aircraft engine designs are outdated, providing a low power to weight ratio while often not having a desired form factor. Newer engines, such as available in motorcycles (up to over 150 hp) and automobile engines (up to about 300 hp), can not be readily adapted for use in aircraft, or other high reliability situations.

The present invention overcomes these limitations and provides a simple mechanism by which redundant sparks may be created within the combustion chamber.

34.2 Description

Separate spark elements on a spark plug which are driven by different ignition pulses, so as provide redundancy as particularly well suited for aircraft installations, or other high reliability situations, such as desired in boats, snowmobiles, personal water craft (i.e. Jet Skis), power tools (chain saws, lawn mowers, trimmers, etc.), motorcycles, vehicles, and any other combustion device in which higher reliability is desired. A single spark plug with multiple separate sets of electrodes which may be independently driven by separate ignitions systems. Although typically a pair of electrodes is incorporated, the invention may be practiced by incorporating three or more electrodes.

The invention incorporates an additional ignition connection which connects through the body of the spark plug to one contact of a second electrode. A first electrode (conventional spark plugs have a single connection to a single contact gap or a single gap split in various ways) receives power from a different connection connected to a different ignition system, or an ignition system that is otherwise configured for providing a dual output.

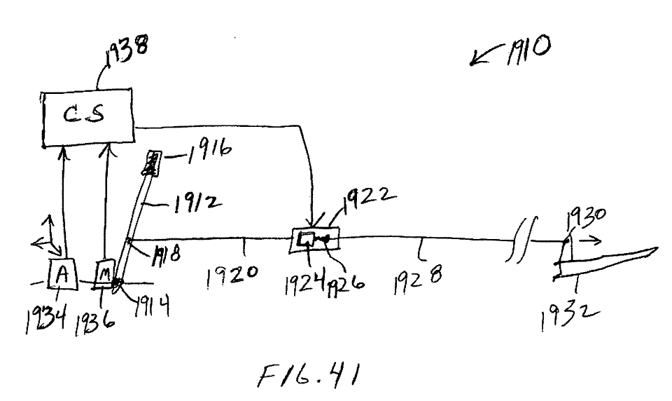

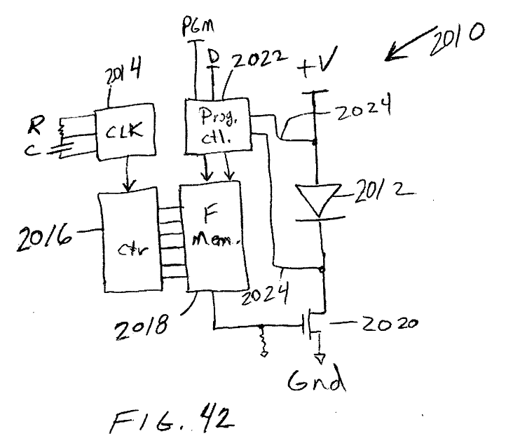

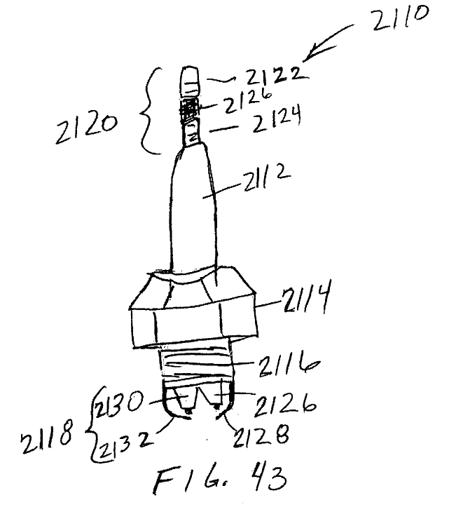

FIG. 43 illustrates an example of a twin-tip spark plug 2110. An insulating elongated portion 2112 extends from a base 2114 having a threaded portion 2116 configured for sealed insertion within the top of a cylinder and making electrical contact with the engine block, typically ground potential. Extending from threaded portion 2116 of base 2114 is an electrode assembly 2118 that extends for igniting fuel/air mixture. The opposing end of the spark plug has a contact region 2120 for connecting the opposing polarity from the engine block (typically positive).

The plug of the present invention is designed for providing redundant sparks are generally required for use in aircraft installations, and viable in other high reliability environments as well. A set of two contacts 2122, 2124 are located at the connector end of the plug and separated by an insulator 2126. Contacts 2122, 2124 pass through the body of the spark plug and extend out 2126, 2130, past the insulating material of the base which has been formed in two mounds to maximize surface distance of insulator between the extending contact points. The corresponding ground electrodes 2128, 2132 are shown in proximity to each of the contacts 2126, 2130 for making a spark therebetween.

It should be appreciated that the dual element plug may be manufactured in a number of alternative ways without departing from the teachings of the present invention.

It should also be noted that the coaxial connector to the spark plug must be configured with an extra conductor and contact for operating the second tip. Furthermore, the ignition system may operate the second contact at a different timing than the first, at the discretion of the manufacturer.

Aspects of Invention:

Sensing efficiency of plug gaps. This aspect of the invention provides a method of indicating the relative condition of each electrode and/or electrical ignition system. In this way the user can determine when service should be performed to maintain a redundant system.

A voltage sensor registers the pulses for driving the sparks on the spark plugs. The sensor may be connected to the ignition system, wiring leading to the sparkplugs, the spark plug wires themselves, or the sparkplug. The sensor may comprise a current sensing device is electrically isolated from the high voltages generated by the ignition system. A circuit, such as a microprocessor, compares the registered waveforms and generates a signal in response to any detected shortcomings or inconsistencies within the ignition. It will be appreciated that even the beginning stages of plug fouling are detectable due to the change in discharge profile that begins to arise. With a dual ignition system connected the circuit also compares the firing of each as a way to determine if either one is failing or running at reduced efficiency. The signal is preferably conveyed to an annunciator, such as a so-called “idiot light”, status screen or other form of visual, audio, or tactile annunciator.

Phase driving —in some instances it may be desirable to generate the second spark after a slight time delay from the first spark. This can for example assure a more consistent fuel burn.

Aspects of the invention may be described as follows,

1. A sparkplug for use on an internal combustion engine, comprising:

a body configured for retaining a proximal tip portion within sealed contact with the combustion chamber and a distal portion retained external to said combustion chamber;

at least two electrode pairs within said tip portion of said sparkplug; and

at least two electrical contacts configured for establishing electrical contact with each of the at least two electrode pairs.

2. In a sparkplug having for an internal combustion engine,

said sparkplug configured for having its tip retained within a combustion chamber,

said sparkplug having an external electrical connection configured for receiving an electromagnetic potential from an ignition system,

said sparkplug having an electrode pair tip with a spark gap between which a spark is created in response to voltage applied to said external electrical connection in reference to the body of the sparkplug which is in electrical contact with said engine,

wherein the improvement comprises:

a second electrical connection configured for connecting to an ignition system; and

a second electrode pair tip proximal to said electrode pair tip with an electrode of said second electrode pair tip being connected to said second electrical connection and configured for generating a spark in response to voltage applied between said second electrical connection and the electrical potential of the engine to which the body of said sparkplug is in contact.

3. A method of increasing internal combustion reliability, comprising:

incorporating a second electrical connection to the exterior of a sparkplug configured for electrically connecting to a second ignition signal; and

incorporating a second electrode pair whose halves connect to said second electrical connection and to a common electrical potential.

wherein said second ignition signal is received from an independent electrical system.

wherein said common electrical potential comprises a ground signal.

wherein said common electrical potential is received through a conductive housing of said sparkplug.

### StableServe —Stabilized serving trays

### (Category: Physical Assistance Subcategory: StableServe)

35.1 Description

To increase the stability of serving trays so that fewer accidents occur. (1) Weight shifting tray —One or more weights are moved in response to tilt sensing to stabilize the tray platform. Simplifies the loading of the tray and the handling thereof.

FIG. 44 exemplifies tray 2210 with the top portion removed showing multiple weight shifting elements, herein three are shown 2214a, 2214b, 2214c, whose position is driven by actuators in the hub in response to tilting of the tray. The tray is completely sealed with a planar top and planar bottom between which are sandwiched the weights and control electronics. Indicators 16 about the periphery indicate the relative tilt and direction, which can be enough to aid the individual to regain balance.

FIG. 45 depicts a circuit with batteries 2220 power the unit through a power switch 2222. A controller 2224 registers changes in attitude of the tray via accelerometer 2226, in response to which three motor control circuits 2228a, 2228b, 2228c, modulate the position of the three arms 2214a, 2214b, 2214c, using three actuators 2230a, 2230b, 2230c.

It will be appreciated that by shifting the large masses on the ends of the extending arms that the tray can be readily stabilized. The arms and weight can be made to stack vertically wherein the arms could pass one another in transition, which could in some situations provide smoother weight shifting although the amount of mass available would generally be reduced.

Indicators 2216 are shown configured as dual-color LEDs (Red/Green) providing a range of indications from level (yellow) (alternating polarity of power input) to tilted up green, or tilted down red, when controlled controller 2224.

(2) Gyroscopic tray —at least one horizontally spinning element that stabilizes the tray to prevent tipping. The arrangement of FIG. 44 may also be made to operate as a gyroscope by rotating, while the arms could still be moved for correcting errant motion.

(3) Load indicators —indicators to annunciate the extent and preferably direction that the tray is out of balance. By way of example, an LED on each of four quadrants on the tray wherein the color emitted corresponds with the relative amount of weight offset that exists. This is useful as well so that a tray using weight shifting won't be loaded to the full extend of the weight in a given direction, wherein it could no longer compensate for weight shifts.

### Chameleon Liquid Soap

### (Category: Consumables Subcategory: ChameleonSoap)

36.1 Description

To aid children in learning to wash their hands thoroughly. A color changing liquid soap that when applied to the hands is a first color and changes to a second color (or optical property) after sufficient heat and rubbing have been performed. Children will enjoy watching the color changes, which will stimulates them to wash their hands thoroughly and to achieve the color change uniformly over the hands. Depending on the chemistry, the material can be made to undergo multiple color or optical property changes.

FIG. 46 depicts the use of the product 2310 with hands 2312a, 2312b being rubbed together with soap 2314, shown in a lather.

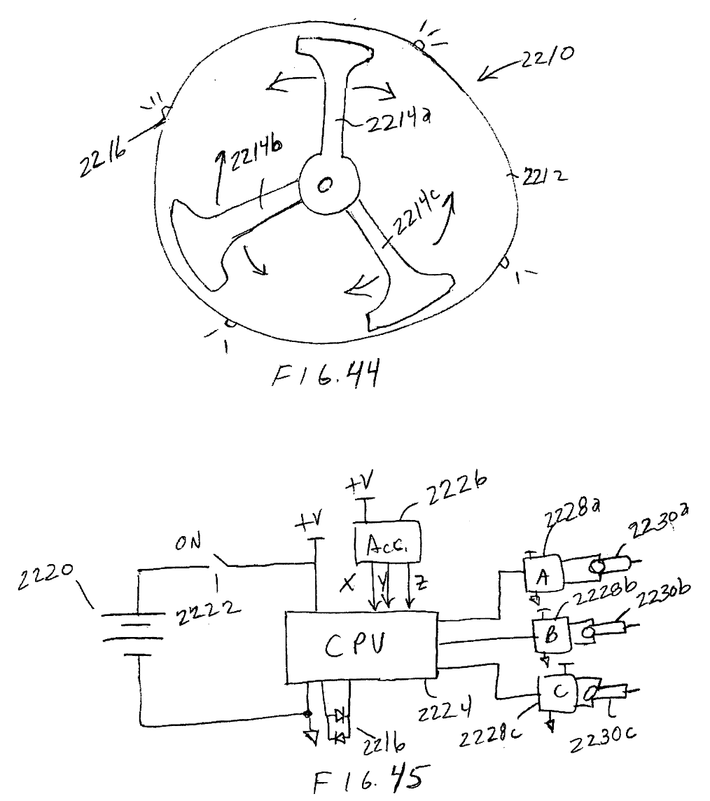

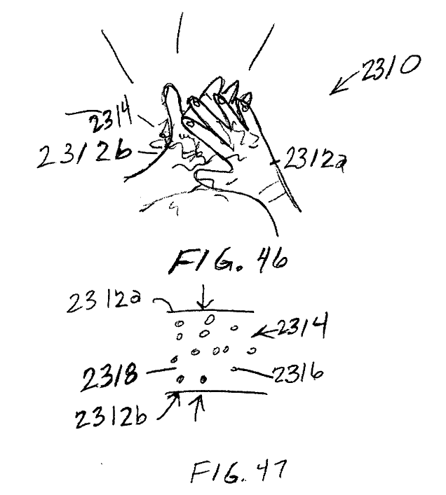

FIG. 47 depicts a first embodiment of the soap which responds to the combination of heat and pressure by changing its color, or optical properties, in a dramatic manner. The surfaces of hand 2312a and hand 2312b are shown with some soap 2314 pressed between them. The soap of this embodiment comprises microencapsulated beads 2316 (i.e. gelatinous shells) containing a washable colored material within a substantially clear soap liquid 2318. As heat and pressure are applied the gel capsules disintegrate allowing the colored material to exit out onto the hands of the user.

Alternatively, the soap can be colored to a first tint, wherein upon rupturing beads 2316 the material therein reacts with the tinted soap to neutralize the color. In this way the hands appear dirty with color and “come clean” in response to washing.

It should be appreciated a number of forms of reaction may be utilized to change the optical properties of the soap with proper rubbing. Beads need not be utilized for separating the two elements to prevent premature color changing, as one or more chemicals may be utilized that in combination result in a color change when subjected to the friction associated with hand washing. These additional reactions for beaded and non-beaded soap being generally known to one of ordinary skill in the art, wherein their use does not depart from the teachings of the present invention.

### High Heat Capacity Water Heater

### (Category: Appliances Subcategory: HiHtCapH2OHtr)

37.1 Background

Water heaters retain a volume of heated water for our showers, baths, handwashing and so forth. However, it never seems to be enough!! Constraints on size, energy use, and cost limit the available hot water. Most people know the feeling of a shower that keeps cooling down. As the hot water is dispensed, cold water is received into the heater to replace the hot water which drops the temperature of the water. The heater element having only limited surface contact with the water reservoir is unable to maintain the hot water temperature in response to the inrushing cold water.

The present invention allows the water heater to more readily heat the incoming water while increasing heat efficiency.

37.2 Description

To increase the available heat capacity provided by a water heater or similar device for retaining a liquid at a constant temperature for being dispensed. A layer of non-combustible material is configured to surround or be immersed within heated water reservoir of the heater. The material is configured for either one specific temperature transition or a range of temperatures that spans the desired heat settings for the heater. The transition temperature can be set just below the nominal temperature to the water is to be raised, then when the water is depleted and cold water enters the thermal energy from the material is released into the water at the transition temperature is reached.

The transition material may be joined within a plastic blanket that attaches to the exterior of the reservoir, such as in pockets. It need not be contained within microspheres, which the traditional method of deploying microspheres for thermal protection in clothing. Preferably a housing with added insulation surrounds the layer of transition material.

The transition material acts as an insulator and a heat reservoir for keeping the water at a given temperature.

FIG. 48 exemplifies an embodiment of a water heater 2410 incorporating the transition material. Water heater 2410 has exterior containment layer 2412 and interior containment layer 2413. Traditionally the interior is filled with a fiberglass material. The top of the water heater is depicted with a conventional vent 2416 along with a cold water inlet 2418 and hot water outlet 2420. The cold water inlet 2418 is shown extending into the base of the tank. A skirt 2414 and temperature controller 2424 are retained near the base.

A phase change material 2426 is retained between the first containment layer 2412 and second containment layer 2413, and optionally segmented into layers of phase change material 2426 based on transition temperature in relation to the water heater, and separated by separator baffles 2428. Alternatively the phase change material may be contained in bags about the water heater.

It will be appreciated that phase change materials are selected for the regions of the water heater, so that when the water temperature is reaching toward it set temperature, (i.e. within 5 to 10%) the material is transitioning to a liquid and is absorbing large quantities of energy per unit of volume. When the water heater is being used for a long period of time and cold water is cooling off the tank volume, then the liquid material releases large quantities of heat as it solidifies, the heat given off aid in keeping the water at an elevated temperature.

Additional area of phase change material may be incorporated, such as with rods 2430, or coils (not shown) to increase the stability of the temperature.

These phase change materials typically have a molecular structure similar to wax and their properties can be adjusted to transition at any temperature within a wide range.

It should be appreciated that the fluid heating system described may be utilized within high end applications requiring good thermal retention in a small form factor, as well as within conventional water heating systems.

### Nanotech On Demand Heating and Filtering

### (Category: Appliances Subcategory: HtdH2Oon Demand)

38.1 Description

Heat water on demand at the faucet while filtering it. A nano configured heater element within a replaceable cartridge for on-demand heating. The nano-configured heater can be configured with crossing resistive element that leave small passageways sufficient for water molecules to pass, but which block bacteria and other undesirable items. The nanostructured heating elements may be fabricated from a number of material such as metallic elements, or a combination of ceramic with metallic resistive elements. As little distance exists between the heating element and the water molecules as they pass by, the water is heated very quickly and efficiently.

FIG. 49 depicts a mounting configuration 2510 for the combination heating and filtering element 2512. Water is received from the cold water supply 2514 and routed to the top 2516 of heater-filter 2512, where it enters the outer sealed input 2518 passes through the nano structured heater which also filters the water, and exit the central hole 2520 that is directed up through the faucet for use.

Electrical control wiring is shown 2522 which preferably is activated in response to moving of the hot water handle, for example by incorporating a piezoelectric sensor that generates a voltage to a power controller on the control unit 2524 to which the heater-filter 2512 threadably attaches. Moving the hot water handle flexes the piezo electric material and generates a trigger voltage wherein control unit 2524 activates a switch to draw AC power to activate the heater. The amount of heating can also be modulated in response to the position of the hot water control.

The heater-filter element is preferably configured with two concentric fluid couplings 2518, 2520, between which are located ring seals 2526, 2528 preventing leakage or intermixing. The fluid must pass through the nanoporous heating element toward reaching the hot water faucet. This concentric design with both connections on a single end allow replacing the heater-filter unit by simply threading off the old heater-filter and threading on a new one.

Conductive paths on the exterior of the heater-filter can be utilized for sensing water leakage, in particular if the exterior contains a dry electrolyte. Alternatively a cage, or housing can surround the unit, or a small reservoir placed beneath it, to collect and sense any leakage, such as if the heater/filter is not properly tightened. This unit can also collect water that leaks out when the unit is replaced.

A circumferential row of structures is preferably integrated on the unit whereby the user may replace the filter by inserting a common screwdriver into the apertures and applying breakaway torque. It will be appreciated that other mechanisms may be employed for mounting as well as the tightening and loosening of the heater-filter, without departing from the teachings of the present invention.

Advantages:

Instant, Unlimited hot water.

NO time wasted waiting for hot water.

NO water wasted waiting for hot water.

NO intrinsic limit to the amount of available hot water.

NO variation in water temperature once set —remains at desired temp.

NO wasted energy, as it provides higher efficiency than hot water heaters.

NO wasted plumbing —Cuts required plumbing in half (only a single water line need be run to each water outlet, instead of a Cold and Hot water pipe.

Lower installed system cost, compared to hot water heaters.

Healthier and better tasting water because its filtered.

Filters both cold and hot water as part of its operation.

Calcium carbonate buildup problems eliminated with each filter change.

Easily replaceable heater/filter assembly.

Safe operation.

Unit indicates when the heater/filter element needs replacement.

Provides an ongoing heater/filter revenue stream for manufacturers.

The nanostructuring utilized for the heating element may be similarly structured to those being considered for making high-efficiency incandescent lighting using nano structures. Alternatively, nanostructure conductors (i.e. nanotubes) may form the thermally conductive matrix and/or be the base for the heating elements. It should be appreciated that since transistors can be created using nanotubes a heating element is also practical, such as by replace the two semiconductive layers (N and P) with conductive material and putting the semiconductive (resistive) material therebetween.

The present invention can be controlled by a single control stalk for water pressure control and heater activation, or using more conventional dual controls. The water flow is controlled into the unit by the hot water faucet, while the controller adjust the amount of heating to maintain the desired temperature.

The system preferably includes a sensor at the inlet and outlet to sense pressure differential, to determine if the heater/filter is getting clogged up, at which time an indicator is activated so users are alerted to change the element.

Control unit may be configured to limit the amount of hot water that may be made available during a given period of time, to enforce any desired conservation measures. For example, limiting the length of hot showers within commercial installations or homes in which children, or other persons residing therein may tend to overuse heated water. Preferably, the unit annunciates a given time period and slowly changes water temp back toward cold, such as over a period of five minutes, so that users can complete necessary actions subject to increasing levels of “discomfort”.

Safety monitor —a separate power watchdog circuit can be optionally incorporated that monitors temperature output of the unit and optionally any leakage (i.e. sensor beneath unit) wherein it cuts off the power and annunciates an error if a problem is detected.

It will be appreciated that aspects of the invention describe an apparatus for heating and filtering fluids and a method of installing a combination heater-filter element near the point of use.

### UV Sterilized Lighted Shoe Trees

### (Category: Home Subcategory: SterileShoes)

39.1 Description

An apparatus for storing shoes that kills microorganisms, molds, and fungi without harmful chemicals as described herein. To eliminate shoe odor, kill mold and fungus, and promote healthy feet. A fan within a shoe tree along with UV sterilizing lights. It can kill the mold growing within the shoes without harmful chemicals or damage to shoes.

Ultrasonics may be utilized to move the stuff around. Ultrasonics are 20 kHz to 52 kHz following a sawtooth pattern with a cycle time of 800 mS per sweep.

It can be mounted to a wall with the shoe units facing upward, just slide the shoes over then foot pads. The unit automatically turns off after a period of time. It can turn on and off automatically to keep killing the mold.

The fan helps move the mold around and keep down the smell. An ionizer ionizes the air coming into the shoes so that the air going out is less smelly and sterilized.

Certain wavelengths of light are better at killing microorganisms and mold. The amount of time for sterilization depend on the power output of the UV and the ability to move the mold around. High porous material are more difficult to sterilize. Frequency range of the light source is such as generally using a ballast device. UV light is typically between 180 nm and 325 nm.

A high frequency switching power supply can be utilized with an EMI filter, a rectifier, a power factor controller, a feedback ballast control circuit, an RCL series-parallel lamp resonant output circuit. Optionally fault detection circuits can prevent problems.

UV light has been used for sterilizing light that is circulated past the light source.

Different microorganisms require from 3,200 microwatts for common bacteria up to 400,000 microwatts. Molds and fungi require additional exposure time.

### Simplified Serial Lighting

### (Category: Lighting Subcategory: SerialLighting)

40.1 Background

Current lighting requires that wiring be brought back to an outlet or extension cord from each of the lighting elements, this requires a multiplicity of wires for most installations and appears untidy.

40.2 Description

To simplify installation and reduce the amount of wiring require for hidden series lighting, such as under cabinets and such. These underside lights can be strung along a single appliance cord, thus simplifying the task of installation and producing a clean look.

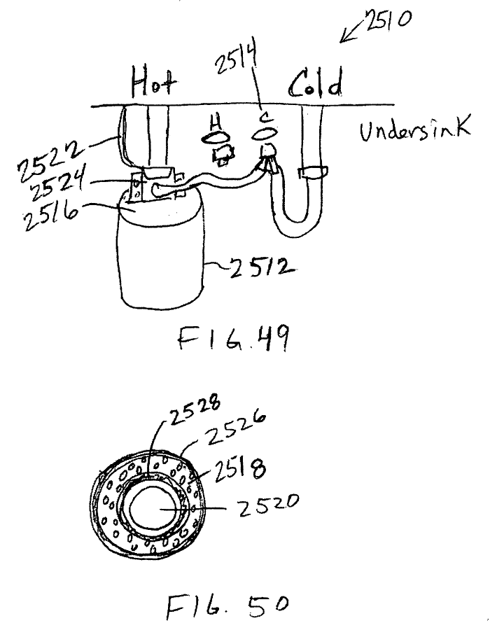

FIG. 51 and FIG. 52 depict a light fixture 2610, such as containing a halogen bulb, or more recently an LED based element. A housing 2612 surrounds the area of a bulb 2614 and a portion 2616 of housing 2612 is configured for attachment to appliance cord wiring. A channel is formed 2618 having means for fastening (i.e. screws 2630 into threaded holes 2620) a retaining plate 2628 to press appliance cord 2626 against spikes 2622, 2624 for making contact with the neutral and hot conductors in the appliance cord.

The supplied appliance cord upon which the units are to be connected should be configured with a fuse, circuit breaker, or similar current limiting device to prevent a user from connecting too many of the light elements to the appliance cord.

A proprietary cord may also be sold with the units if it is deemed necessary to prevent consumer from utilizing their own sections of cord (without the protection device).

### Jam Proof Paper Shredder

### (Category: Office Subcategory: ShredderJamNot)

41.1 Background

Paper shredders even when used in controlled environments, such as offices and the like, are subject to jamming and overloading. It would not be prudent to allow untrained personnel to use the machine, or the general public.

41.2 Description

To prevent overloading and jamming of paper shredders and allow their use for the general public. A system and method of shredding paper that may be utilized by the public. The system provides a shredder that senses the amount and character of its input. The character including the sensing of metallic objects or other hard objects that should not be shredded. If the character is not suitable then the material is returned in a similar manner that bent coins fall through to a return slot. Sensing may be performed using flexible wheels that forces the paper to conform to a curving path, and compression. Items that are incompressible are unable to conform or create lumps and bumps. Additionally metallic contacts can be sensed using various techniques, such as sensing shorting contact, inductive sensing, capacitive sensing.

The present paper shredder that won't jam because is senses material attributes being input prior to them reaching the shredding blades, wherein the material may be returned from the intake loop if too thick or is otherwise inappropriate.

Fill sensing. The shredders are preferably configured with fill level detectors, and problem detectors, that are connected to a circuit for communicating the conditions automatically to service personnel for emptying or servicing the machines. By way of example, the fill level and any maintenance information, may be communicated over a modem, phone line, intranet connection which has access to the Internet, or other communication medium for communicating needs of the machine, or problems encountered.

Smart Receipt Bin. As an alternative to shredding at the point of receipt, a smart bin according to the invention can be configured which checks and optionally measures the items being received into a secure retention container.

A business method wherein shredders or smart receipt bins are installed within grocery, or drug stores, and a fee is charged for providing the shredding service. The charges can be based on the weight of material, the size and thickness of material, the time over which the machine is used, the load×time, or other metrics of use that preferably take into account the wear on the machine the resultant volume of shredded material to be carried away.

Shred charging mechanism. The user would be expected to deposit a certain amount of money to allow operating the machine up to a certain limit of weight or material volume. The system would check the material prior to it hitting the shredder to assure that no binder clips, paper clips, or other foreign materials were being retained with the material. Alternatively, a shred card having a magnetic stripe could be purchased at the counter for operating the machine. Other alternative mechanisms may be utilized for charging for the service.

The machine may be coupled to a change conversion machine, wherein the user can convert coins at the same time as performing shredding. The amounts registered by the coin machine may be utilized to cover shredding charges.

As part of the business method, the store installing the system can be provided with a key that allows the manager, owner, or whatever to freely use the shredder, wherein they need not contract with a shredding company for their own materials being shredded.

It should be appreciated that aspects of the invention describe an apparatus for shredding paper and a method of shredding papers for customers as described herein.

### WarmFinger Keyboard

### (Category: Computer Subcategory: WarmFingerKB)

42.1 Background

The fingers of a large number of individuals are prone to becoming cold when typing on winter days. The invention safely keeps their fingers toasty warm while using only small amounts of energy.

42.2 Description

Keep typing fingers warm —can't type with gloves on. The keyboard may be heating in a number of ways according to the present invention. For example, the keycaps may be heated, but this requires major connection and design changes to the keyboard while it can only heat the fingertips. It will be appreciated that it is generally the mid-fingers that are most noticeably subject to the cold.

Therefore, the present invention preferably utilizes blown air heating to warm the fingers and hands of a typist. The heated air flows out between the keycaps. The hot air source may be implemented within the keyboard or received from a separate source of hot air.

A preferred embodiment utilizes a separate heated air pump which connects via a hose to a coupling on the keyboard. The keyboard may be formed with a chamber into which the air is received which directs the heated air from the top of the keyboard. More preferably the invention directs air from about the home position on the keyboard (i.e. keys: “A”, “S”, “D”, “F”, “J”, “K”, “L”, “;”). It should be appreciated that the heated air may be distributed from other locations on the keyboard, such as from other key positions, and apertures configured for distributing the air, for example toward the palms or wrists of the individual. The persons fingers then can remain comfortably warm while typing. The airflow also adds feedback for being in the home position. In this way the keyboard may be configured at negligible cost for the heating option and a separate heater module sold for those wanting additional finger heating.

The heated air module may be configured in a separate housing placed near the keyboard and powered externally, or from a unit that is placed remotely from the keyboard (i.e. that inserts into an A.C. power receptacle) from which a heated steam of air is directed through one or more hoses to the keyboard. The heater module may be incorporated within the keyboard as well. For example a heater element may be included over which air from a fan is directed to create heated air that can flow from the keyboard.

Another embodiment of the invention utilizes a rechargeable heat module that after charging attaches to or in close proximity to the keyboard, wherein it generates a stream of heated air into the keyboard that exits at the finger locations. The unit may be manufactured to a small size, such as occupying from approximately one to four square inches. A small unit may be designed to connect directly to the heat input connection of the keyboard.

The unit may utilize any desired rechargeable/renewable energy source, such as batteries, capacitors, fuel cells, and so forth. Alternatively, the unit may utilize a chemical source of heat, such as combining of two reactants, or a reactant being exposed to air or moisture.

A means for driving air through the heat source is utilized to drive the heated air into a keyboard which may be attached with a small hose section, or to which the unit may directly connect. The means for driving the heated air may comprise a fan or pump device of sufficient capacity to drive sufficient air through the keyboard to heat the fingers of the user.

The unit preferably operates quietly, so as not to annoy the individual. Furthermore, the unit may incorporate a source of moisture and/or scent wherein the moisture and/or scent is passed through the air stream to further increase comfort.

One preferred embodiment comprises a dual-layer capacitor that is charged through AC charge system. The unit is plugged into AC power for a brief time (2-30 Seconds) and can then be removed for use. The AC plug preferably extends from the unit for charging, such as extending or swinging out from the housing. The AC plug may incorporate a switch wherein upon disconnecting from AC and storing the extended plug the heater unit begins operating. Alternatively a switch or other heating controls may be incorporated to regulate the activity, speed of air, and/or amount of heat contained within the air.

The keyboard or heated air source may be additionally configured with means for disbursing a fragrance and/or moisture into the heated air stream. Optionally, the heater of the heated air source may be switched off, or otherwise disabled, to allow distributing an unheated air flow for cooling the hands of the operator.

Further aspects of invention—

Cool headphones

Utilize the following air blowing device for cooling sealed headphone earcups. Again, a coupling is provided at one or both earcups (or at another location with air routed to the earcup), wherein air is driven past the earcup to cool the ear and in some cases normalize humidity.

It should be appreciated that aspects of the invention describe (1) a heated keyboard; (2) a keyboard configured for receiving and distributing heated air received from a source of heated air; (3) a heated air source configured for coupling to a keyboard that distributes the heated air; (4) an air-cooled set of headphones; (5) headphones equipped to receive cooling air; (6) a source of pressurized air configured for coupling to a set of headphones configured for receiving a source of pressurized cooling air.

### Personal Navigation System and Method

Included herein by reference, application entitled ‘Eceptor’ within docket RAST070102 Ser. No. 10/612,777 filed Jul. 1, 2003; and associated provisional application No. 60/394,160 as filed Jul. 1, 2002.

43.1 Background

Navigating around a cityscape, or other area having a high density of possible items of interest, is often difficult. This is especially true for those with physical disabilities, such as the blind. Additionally, a person traversing such as cityscape would often enjoy finding out more about the sites and such as they travel by walking or by car, however this presently requires getting out to inquire about it or hiring a guide that hopefully knows the sites.

43.2 Description

To provide personal navigation and information from landmarks, retail and service establishments, services, bathrooms, pathways, and so forth.

Personal Navigation Device (PND) for sensing position & direction (i.e. on a PDA)—RF trigger of an (ultrasonic) acoustic ID from multiple sources, the relative time of arrival of these signals generated simultaneously allows detection of direction relative to the multiple sources.

For example, if units convey a position coordinate, and perhaps information about nearby units, then the direction sensing device can determine a position relative to these coordinates as based on the acoustic responses. It should be appreciated that data can be encoded within the ultrasonics generated, which eliminates the necessity of adding an RF transmission facility to the transponder for communicating data back to the unit issuing the challenge, however, units requiring the transmission of large amounts of data may preferably use RF generation or a combination of RF and acoustic transmissions. It should also be appreciated that a given transponder may be configured to provide information only over a corridor or angular span and need not span the entire 360° degrees, for example from the side of a building, within a corridor, and so forth.

Having the units transmit an acoustic signal which varies depending on transmission direction (note: ultrasonic sound is very directional in nature) allows the direction and location to be determined. For a first example, a first transponder unit generates ultrasonics centered about frequency A, with ultrasonics generated toward the north 355° to 5° at A−y, then progressing around the compass rose til 350° to 355° is at frequency A+y, wherein y is equal to an offset frequency. Alternatively, a second example may be implemented using phase shift detection between carriers, which provides a natural 360° cycle and thus lacks ambiguity as no angular junction exists between adding and subtracting frequency. A third alternative can be implemented by using a multiple acoustic pulse method, wherein upon being triggered the unit generates a first acoustic wave in all directions, and then performs a circular sweep sequentially activating acoustic generators in different directions. For instance broadcasting a first acoustic signal over 360° then after short time x elapses, generating an acoustic signal directed at 0° to 10°, then after another short interval generating an acoustic signal directed at 10° to 20°, and so forth until the full circular range has been covered.

Receiving units can register the time between the first response and the subsequent response to determined their angular relation to the transmitter, and may triangulate position based on multiple transmitters. Each transponder may be coded to operate at a different frequency or range, wherein multiple responses may be simultaneously processed. An allocation scheme for example may require that transponders be set to frequencies during deployment which are based on the least significant bits of the transponder coordinates. In this way no collision of transponder outputs can occur despite adding additional transponders to a matrix of transponders at a later time. It is preferred in this mode that the first signal generated convey the angular range over which the second signal is generated, wherein the receiver should it not receive the second signal can know it is out of the angular range of that signal. Also the purpose (type of) signal should be transmitted along with an identifier (i.e. coordinates) in that first transmission.

The ultrasonic transmitters utilized in the above situation may also be utilized in combination to provide audible sounds (music, speech, sound effects).

### Autoform Wizard

44.1 Background

Presently filling out a paper form requires either the use of typewriter and a great deal of time, specialized software for converting paper forms to computer forms, or the use of an arcane and step laden procedure.

44.2 Description

To simplify filling out paper forms. Autoform wizard —well suited for implementation on Microsoft® Word —creates a form capable of being immediately filled out as a word document. The template is created with tabs lining up with each box on the form, and the spacing of each line is correctly set. This eliminates the need for manually creating the forms.

An embodiment of the present method may be performed on a typical word processor application executing over an operating system as follows:

(a) selecting autoform wizard by user;

(b) asking user for source of form image;

(c) scanning a new form as necessary;

(d) inquiring if the user wants the scan cleaned up;

(e) adjusting the tone curve to drop marks and blemishes from form;

(f) creating a new document template;

(g) inserting form as picture behind text attached to page;

(h) finding a text entry box on the form;

(i) insert a field at appropriate line height, spacing, and tabs space for the entry box; and

(j) continue steps (h) through (i) until all form fields are represented on the template, and returning to user control.

### ScanToSList

45.1 Description

To generate shopping lists based on the UPC codes of discarded goods. A system for recording/executing replacement ordering of equipment or goods, such as for the household, without the need to write a list. An item to be purchased is scanned with the system which records the Universal Product Code into a shopping list format. The user can then utilize the retained UPC codes and associated descriptions to facilitate fulfilling their order.

Typically, the item would be scanned into the list when its contents have been consumed, or sufficiently consumed to necessitate purchasing additional quantities. A list of bulk type items containing descriptions and/or graphic along with corresponding bar code is preferably provided by a retailer such as a grocery retailer on items such as fruits, vegetables, and meats. The unit has a communication interface allowing the collected product information to be communicated, such as to a retail computer, an internet application program.

List processing application program on a user interface on the unit itself or when the unit is connected to a device having a user interface, such as a PDA, PC, retailer system, or similar. The list processing application allows the user to view, order, notate, edit, and add list items. The scanning unit need not have a user interface, although it preferably is configured with an activation control to select when scanning is to be performed and an audio or visual output to indicate that the scan has been completed.

List processing application program can connect with external data, such as over the internet to gather UPC data and/or retail data, which facilitate order creation and fulfillment. Examples: (1) data from retailer based on location of goods used with collected UPC to order the list following the store layout, printed out by user; (2) list data can be communicated through a retailer interface, such as over the internet, to place full or partial orders on-line; (3) data may be used for comparison shopping wherein list is submitted to different retailers to arrive at a total cost of goods; (4)

Elements of invention: (−=optional)

portable system with UPC recognition means & memory

conventional line scanner, or image based recognition

memory storage for UPC codes

*storage for translated UPC descriptions

*database of UPC codes

(within unit, or accessed when connected to a PC or other networked device)

power source

*solar power (to maintain capacitor/battery power)

user interface —(through system display or via PC, PDA, etc.)

list processing application accessed through user interface

List Actions: (review, deleting items, editing, or commenting on items)

*voice annotation or speech to text

*application with retailer supplied data

data communications interface

temporary wired connection or wireless connection

*PC compatible—amending list or printing from PC

*select items (i.e. specials) from internet advertisements, etc.

*retail compatible—connect at supermarket or other retailer

Method of generating a shopping list, comprising the steps:

1. triggering activation of scan function (may be automatic)

2. scanning items into system memory

3. querying database for descriptions in response to each UPC code

4. interfacing with user to review list of items

5. entering non-scanned list items

6. organizing list in response to data from a given retailer

7. printing or communicating list

Alternate embodiments & other aspects:

Bar code recognition software operating on a PDA, or cellular phone, which when in bar code mode does feature extraction on a bar code in view of the imager (i.e. CCD imager) to generate data on the associated UPC. Preferably, upon executing a valid pattern matching algorithm the unit generates a beep and displays a description of the item as validation of the operation.

Price code recognition software operating on a PDA. Character recognition application for an integrated imager (CCD imager) for interpreting price tags on items or self tags. One embodiment uses this in combination with the above UPC code registration within a PDA application for capturing item description (look up the UPC) and associated pricing, such as for studying competitive pricing within an industry, tracking individual purchases, populating a shopping list template.

Closed loop automated ordering—UPC is scanned on phone/PDA which registers items selected and transmits list to vending machine or other associated automated system which executes the purchase transaction following standard charge protocols for vending machines (i.e. as utilized in Europe). In this way the vending machines needs less interface while the customer has more control over what is ordered and put through their charge.

It should be appreciated that aspects of the present invention describe an apparatus for generating shopping lists and a method registering bar codes as described herein.

### Quick Release Water Control Valve and/or Solenoid

46.1 Description

Provide a sprinkler valve that may be readily removed for repair or replacement, without the need to cut the pipes. Conventional valves being attached at a first and second pipe are generally require cutting the attachment pipes to replace the valve. Even if the stems extending from the sprinkler are threaded, the attaching pipe must still be cut prior to unthreading the pipe from the valve. Replacing a valve becomes an expensive and complicated process, while these problems are particular onerous when the valve has already been replaced and the pipe can not be cut again to fit on another valve unit.

The present invention recognizes these failings and provides valve embodiments that may be readily removed without the need to alter the existing pipes.

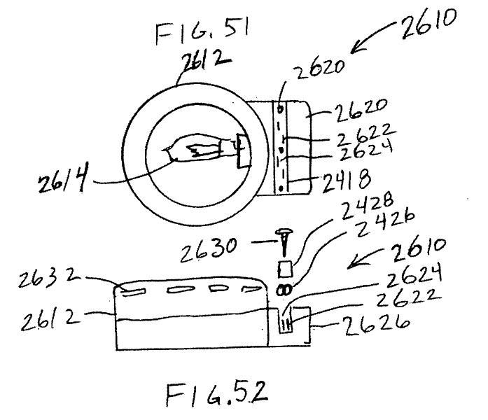

FIG. 53 is a preferred embodiment 2710 of a valve housing according to the invention having threaded concentric rings 2712, 2714 for coupling the valve unit attaches. Housing has a first opening 2716 and a second opening 2718, each of which are preferably threaded for threadable attachment to a desired pipe diameter, for example ½″, ¾″, or 1″. First opening 2716 is shown for conducting fluid through pipe 2720 to the smaller ring 2714 which couples to a first opening of a valve or other control, the output of which is conducted from the valve back through between inner ring 2714 and outer ring 2712 and out of second opening 2718. Concentric rings 2712, 2714 are threaded for attaching a valve unit. It is preferred that the exterior of outer ring 2712 is threaded and the interior of inner ring 2714, which allows a sufficient thread coupling depth without loss of support and alignment for the interior ring.

Optional support webs 2722 are shown for supporting central pipe 2714 so that it stays in alignment with the outer pipe when attaching a valve. The top of inner ring 2714 preferably is chamfered at least slightly to more readily mate with a the inner ring of a valve which may not align exactly due to warpage, heat induced changes and so forth. The chamfering guides the inner ring 2714 into the central ring of a valve assembly as the outer portion of the valve engages the outer ring of the valve housing. It is preferred that the outer and inner ring do not engage the associated outer or inner ring of the valve assembly simultaneously, it is contemplated that separate engagement should generally simplify threadably engaging the valve to the housing since only a single ring is being aligned on the initial threads at a given time.

It should be appreciated that the fluid may be made to flow in either direction, although it is preferred that all the units be standardized with markings for flow direction, wherein the associated valves can be standardized and will fit any of the designs.

FIG. 54 illustrates an example of a cross-section of the valve housing of FIG. 53, shown in preparation of threaded attachment of a valve unit 2730, or similar fluid flow control device. The valve being shown as largely conventional except that it receives and discharges fluid through the concentric rings 12′, 14′ instead of through separate pipes. The control valve is shown with a electric solenoid 2732, removable valve chamber 2734, and anti-siphon features 2736.

These inventive aspects may be described as follows.

1A fluid flow housing for receiving a flow control valve, comprising:

fluid exchange apertures through which fluid flows into and out of the fluid flow housing which is configured for receiving a fluid control device;

a first threaded aperture in fluid communication with one of said fluid exchange apertures;

a second threaded aperture in fluid communication with the other of said fluid exchange apertures;

wherein said second aperture is disposed concentrically in the middle of said first threaded aperture;

wherein threading on said first and said second apertures is configured for threadably receiving a fluid control unit having concentrically threaded input and output fluid connections;

wherein said first and said second apertures are configured to keep the flow separated that enters the fluid exchange apertures enroute to threadably engaged flow control unit.

2. A fluid flow housing as recited in claim 1, further comprising:

a valve configured with concentric input and output fluid connections;

wherein said fluid connections are configured for threadably engaging said first and said second threaded apertures.

### SkimBoard—Enhanced slider action

47.1 Description

Enhancing the sliding action of skim boards (wave slider boards) while increasing comfort and control.

The weight of the rider displaces air and/or water from the board which reduces the sliding friction leading to a longer ride. The unit may be constructed with a bellows-like compressive element on top and flow apertures underneath for letting out the air and water. A drain may be optionally provided, and one way valves may be incorporate to prevent water from entering when the rider steps from the board.

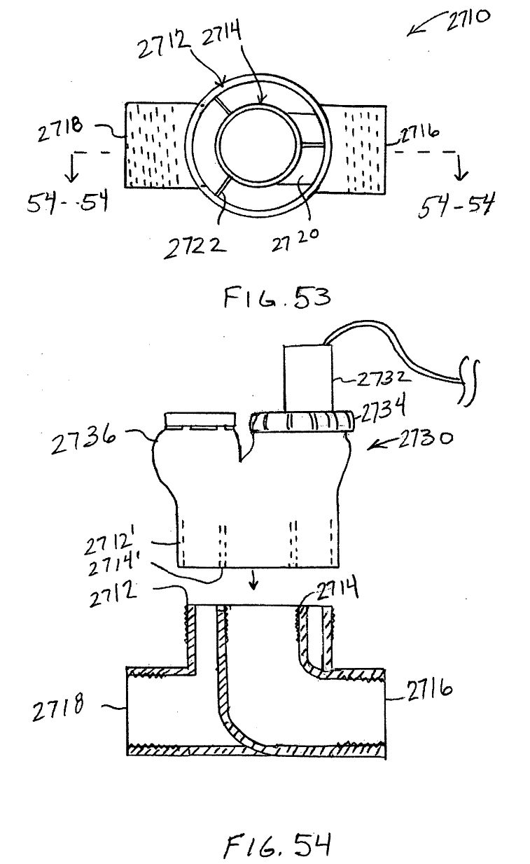

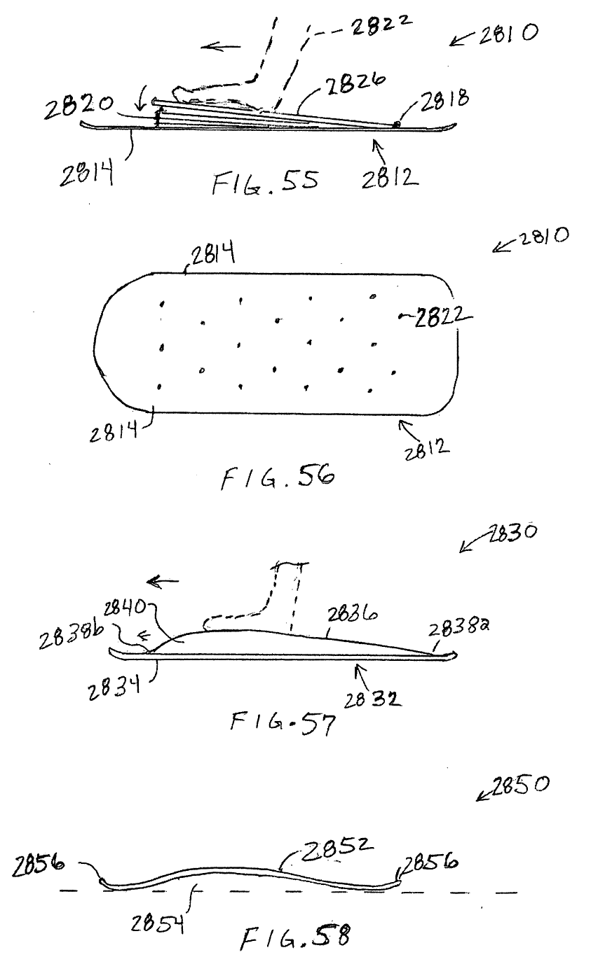

FIG. 55 and FIG. 56 depict a skimboard 2810 with a base 2812 having a generally planar underside 2814, a top element 2816 upon which the user is to step is compliantly attached to the top surface of base 2812, herein illustrated with a hinge 2818 and a compressible bellows-like arrangement 2820 near on the opposite end of top element 2816. Apertures 2822 are shown through base 2814 into the bellows region. The top surface 2816 is preferably of a resilient plastic material with a rubberized coating or similarly compliant material to prevent the user from slipping when landing on the board, while the stiffer underlying layer allow the top of the bellows to move in one piece.

Upon stepping onto the skimboard, a cushion of air is forced through the holes to increase the cushion under the skimboard to improve the skim distance. The device may be alternatively fabricated with a water drain, one-way water release valves or other alterations without departing from the teachings of the present invention.

FIG. 57 depicts a skimboard 2830 with a compressible container 2840 configured with a top 2836 upon which a rider can jump. The top 2836 is not hinged, but is attached compliantly about it periphery 2838a, 2838b. The underside 2834 of board 2832 is shown flat.

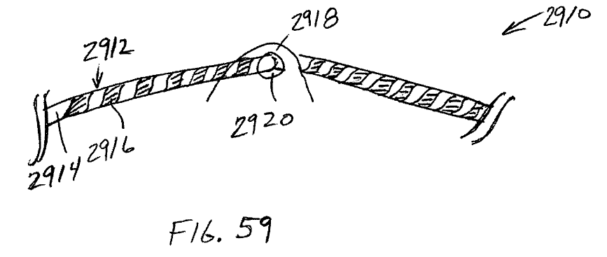

FIG. 58 depicts an alternative curved board that compressed under load but has no bellows effect to increase ride length.

### Sheathed Polymeric Muscle Fiber for Controlling Motion stage

The following application are incorporated by reference:

Regular utility patent application serial number docket “TipTracker_{—}02” application Ser. No. 10/245,909 filed Sep. 15, 2002;

Provisional patent application docket “PPA_RAST071403” application No. 60/487,295 filed Jul. 14, 2003;

Regular utility patent application serial number docket “KeyboardRAST070103” application Ser. No. 10/612,777 filed Jul. 1, 2003, and associated provisional patent application 60/394,160 as filed Jul. 1, 2002;

Regular patent application docket “Display_RAST092303” No. 10/670,432 filed Sep. 23, 2003; and associated provisional patent application 60/413,199 filed Sep. 23, 2002;

Regular utility patent application Ser. No. 09/854,028 filed 05/11/01, which was issued as patent serial number 6,486,798 on Nov. 26, 2002.

48.1 Description

These aspects provide additional details for the muscle wire driven motion stages in the related parent applications. The present recites the utilizing polymer-based “muscle” fibers as these provide up to 50× the length response. It will be appreciated that traditionally muscle wire fibers were a metallic construction, such as Nitinol material.

Newer fibers, however, have been demonstrated which are made from polymers and which provide much higher levels of contraction, or even expansion, in response to the activating voltage. They also require less restorative force.

One problem that arise with these polymer muscle wires in practical, non-lab, use is that the material is not as abrasion resistant, nor as slippery, as the traditional wire. In some application the result being that the polymer muscle wires can fail prematurely, or bind during their movement, this is particularly true when the muscle wire must slide over or through a structure, such as an eyelet, pulley or so forth.

Therefore, the present invention provides a new polymer muscle wire fiber that overcomes these difficulties. The polymer muscle wire is encased in a compliant sheath that decreases friction and increased abrasion tolerance. In one embodiment the sheath incorporates a spiral pattern that does not substantially limit the expansion and contraction of the muscle wire fiber. The case can be formed from UHMWPE ultra-high molecular weight polyethylene, or other material to overcome the drawbacks with the polymer, such as sticking to surfaces, or being abraded on contact with surfaces. For example the UHMWPE provides an abrasion resistant surface allowing the force of the muscle wire to be redirected about one or more points of contact.

FIG. 59 depicts a device 2910 which redirects the tensioning in the muscle wire. A muscle wire 2912 is shown having a core comprising one or more fibers. If the muscle wire is a polymer based muscle wire (of one or more strands) it will be preferably encased in a stretchably compliant sheath 2916, such as a helical pattern of thin UHMWPE. The sheath can be employed to reduce the friction between the fiber and other objects while reducing abrasion on the fiber. This is particularly important when redirecting the force of the muscle wire, such depicted in the figure, where a redirection member 2918 is shown with an aperture through which the muscle wire passes, the force applied by the muscle wire being redirected by member 2918 wherein a resultant force is applied between the muscle wire and the interior of aperture 2920. These forms of force redirection on a sheathed muscle wire may be utilized in a number of applications.

### Packaging Preventing Material Use

Incorporated herein by reference:

Regular utility patent application docket “KeyboardRAST070103” application Ser. No. 10/612,777 filed Jul. 1, 2003; and associated provisional patent application 60/394,160 filed Jul. 1, 2002.

49.1 Description

Add to the parent application which described identifying Express or priority Mail boxes being used illegally. Stamp the boxes from cardboard which has been preprinted on at least one side (generally the uncovered side) with a use warning. “USPS Packaging —Unlawful to use for other than intended packaging”.

### Suspension Visor—Enhancements

Incorporated herein by reference:

Regular utility patent application docket “TransportRAST070103” application Ser. No. 10/612,225 filed Jul. 1, 2003; and associated provisional patent application No. 60/394,160 filed Jul. 1, 2002.

50.1 Description

The suspension visor of the parent application allows the user to adjust the tension from a single control in a continuous manner (i.e. no steps), the following adds additional embodiment for the invention.

(1) At least one tension adjuster can also be used for retaining a shield, such as in a medical visor. Can have it hold visor on and allow adjusting. Note that it is the depth of the head more than the width needing adjustment.

(2) Slidable supports (one or more) so locations of flexure may be varied by user.

### CONCLUSION

Throughout the specification numerous values and type designations are provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

The present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed.

Since many of the embodiments are shown as merely examples of practicing the invention, construction of which would be apparent to one of ordinary skill in the art based on the teachings herein, therein more detailed illustration and description are omitted.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes for certain applications.

Moreover, implementations according to the various embodiments of the invention may be provided with all of features described herein, or only portions thereof, which combinations may be practiced and/or sold together or separately. For example, a device may be manufactured and sold without certain desired equipment for later assembly; In this regard, such devices may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. A method of scheduling a means of transport, comprising:
(a) registering a source location within an electronic device of a user configured for remote communication;
(b) communicating said source location and a time coordinate by said electronic device of said user to a remote transport service indicating pickup position and time; and
(c) dispatching a vehicle to pickup said user.

2. A method as recited in claim 1:
further comprising a locating system within said electronic device for generating a standardized set of position coordinates;
wherein said locating system comprises a GPS system.

3. A method as recited in claim 1, wherein said registering a source destination is performed by taking and storing a position fix at a desired pickup position.

4. A method as recited in claim 1, further comprising communicating a destination location along with said source location.

5. A method as recited in claim 1:
wherein said communicating is performed using a formatted email message; or
wherein said communicating is performed over the internet; or
wherein said communicating is performed over the wireless telephone network.

6. A method as recited in claim 1, further comprising executing a charge transaction in association with said transport service.

7. A method as recited in claim 6, wherein said charge transaction comprises a minimum charge to be registered even if the user does not arrive to for being transported.

8. A method as recited in claim 1:
further comprising registering arrival at the location and time of arrival of said vehicle at said location;
wherein said location and time are communicated to a remote station configured for logging the information;
wherein said location and time are registered within an electronic system within said vehicle that is not subject to being altered by the driver or passengers of said vehicle.

9. A method as recited in claim 8:
further comprising registering time of leaving the location if the user has not arrived within a desired period of time;
wherein said location and time are communicated to a remote station configured for logging the information;
wherein said location and time are registered within an electronic system within said vehicle that is not subject to being altered by the driver or passengers of said vehicle.

10. An apparatus for registering a vehicle identifier at the time of fueling a vehicle, comprising:
a transponder tag configured for being coupled to a vehicle within readable range of the fuel filling intake;
a memory within said transponder tag containing an identifier which can be generally identified with the vehicle; and
means for challenging said transponder tag at the time of fueling the vehicle to which said transponder is attached, and registering the identifier returned by said transponder tag for communication to a transaction processing interface wherein it may be recorded as part of the transaction.

11. An apparatus as recited in claim 10, wherein said identifier comprises a vehicle identification number, license plate number, or a user selected identifier.

12. An apparatus as recited in claim 10, wherein said transponder tag comprises a passive or active RFID electronic device.

13. An apparatus as recited in claim 10, further comprising a means within said transaction processing interface for printing said identifier on a receipt, and/or within transaction information that is printed with a credit card statement or bank statement in response to the fuel purchase transaction during which the identifier was recorded as part of the transaction.

14. An apparatus for illuminated areas after the light switch is turned off, comprising:
a first switching element configured for controlling the light output from a first light; and
means for temporarily generating light from said first light or from another light source in response to setting said first switching element into the off position.

15. An apparatus as recited in claim 14, wherein said first light is AC powered.

16. An apparatus as recited in claim 14, wherein said means for temporarily generating light is configured to generate light from another light source which comprises lighting integrated with the housing of first switching element, or a remote light whose activity is controlled by the transmission of a control signal.

17. An apparatus as recited in claim 14, wherein said means is configured with a timer element for establishing the time over which the light is temporarily generated by said first light, or from said another light source in response to being turned off.

18. A light switch for controlling AC lighting, comprising:
a slave light switch configured for controlling the light output from a first AC lighting element;
a transmitter which receives operating power from the connection of said slave light switch;
a first switch coupled to said transmitter for activating said transmitter;
a master light switching element configured for controlling a second AC lighting element;
a second switch;
a control circuit configured to control the state of said master light switching element in response to input from said second switch; and
a receiver circuit coupled to said control circuit and configured to receive transmissions from said transmitter which change the state of said second AC lighting element.

19. A light switch as recited in claim 18, wherein said transmissions are communicated as selected from the group of communications mechanisms consisting essentially of: AC signal superposition, radio frequency signals, optical signals, and audio signals.

20. A light switch as recited in claim 18, wherein slave light switch and said master light switch are housed according to a form factor associated with conventional AC lighting switches.
